(19) United States
(12) Patent Application Publication
(10) Pub. No.: US 2025/0182411 A1
(43) Pub. Date: Jun. 5, 2025

(54) IMAGING SYSTEM, VIDEO PROCESSING METHOD, AND PROGRAM

(71) Applicant: SONY SEMICONDUCTOR SOLUTIONS CORPORATION, KANAGAWA (JP)

(72) Inventors: MASAO KANDA, KANAGAWA (JP); NOBUE MAEKAWA, KANAGAWA (JP); KAZUYA FURUMOTO, KANAGAWA (JP); TATSUYA OKAWA, KANAGAWA (JP)

(21) Appl. No.: 18/843,546

(22) PCT Filed: Feb. 21, 2023
(86) PCT No.: PCT/JP2023/006123

§ 371 Date: Sep. 3, 2024

(30) Foreign Application Priority Data
Mar. 7, 2022 (JP) 2022-034347

(51) Int. Cl. G06T 19/00; G06T 13/40; G06T 19/20; G06V 10/25

(52) U.S. Cl. CPC G06T 19/006; G06T 13/40; G06T 19/20; G06V 10/25; G06T 2219/2016

(57) ABSTRACT

The present technology relates to an imaging system, a video processing method, and a program capable of suppressing occurrence of appearance. The imaging system includes a subject motion detector that performs motion capture of a subject predetermined on the basis of a captured video including the subject and distance information, and a data control unit that performs transparency processing of making the subject on the captured video invisible, and generates a composite video by compositing an avatar corresponding to the subject that performs a movement detected by the motion capture on the video obtained by the transparency processing on the captured video or compositing the avatar obtained by the transparency processing on the captured video. The present technology can be applied to the imaging system.

### TECHNICAL FIELD

The present technology relates to an imaging system, a video processing method, and a program, and particularly, to an imaging system, a video processing method, and a program capable of suppressing occurrence of appearance.

### BACKGROUND ART

For example, in augmented reality (AR), motion capture is performed on a subject on a video obtained by imaging a real space, and a composite video obtained by superimposing an avatar or the like that moves in accordance with a movement of the subject on a subject on the video obtained by imaging is presented.

In this case, when the region of the subject on the composite video does not completely match a region of the avatar or the like, appearance in which the subject protrudes from the avatar or the like occurs.

In addition, as a technology related to protrusion of a subject, a technology of concealing an unnecessary subject with a complementary computer graphics (CG) video and generating a composite video has been proposed (see, for example, Patent Document 1).

In Patent Document 1, the position and posture of the real camera are estimated by a motion sensor provided in a real camera, and a CG video of a virtual space when there is no unnecessary subject is generated in which spatial conditions of the real space and the virtual space are matched on the basis of the estimation result. Then, the complementary CG extracted from the CG video is composited with the portion of the unnecessary subject on the video obtained by the real camera. In this case, the CG video of the virtual space is generated on the basis of virtual model data prepared in advance.

### CITATION LIST

### Patent Document

Patent Document 1: Japanese Patent Application Laid-Open No. 2020-96267

### SUMMARY OF THE INVENTION

### Problems to be Solved by the Invention

However, in the above-described technology, there is a case where occurrence of appearance of a subject cannot be suppressed.

For example, in Patent Document 1 described above, since it is necessary to prepare the virtual model data of the virtual space corresponding to the real space in which imaging is performed in advance, an imaging place is limited. That is, it is not possible to suppress the occurrence of appearance in an imaging place without corresponding virtual model data.

The present technology has been made in view of such a situation, and is intended to suppress occurrence of appearance.

### Solutions to Problems

An imaging system according to one aspect of the present technology includes a subject motion detector that performs motion capture of a subject predetermined on the basis of a captured video including the subject and distance information, and a data control unit that performs transparency processing of making the subject on the captured video invisible, and generates a composite video by compositing an avatar corresponding to the subject that performs a movement detected by the motion capture on the video obtained by the transparency processing on the captured video or compositing the avatar obtained by the transparency processing on the captured video.

A video processing method or a program according to one aspect of the present technology includes steps of performing motion capture of a subject predetermined on the basis of a captured video including the subject and distance information, and performing transparency processing of making the subject on the captured video invisible, and generating a composite video by compositing an avatar corresponding to the subject that performs a movement detected by the motion capture on the video obtained by the transparency processing on the captured video or compositing the avatar obtained by the transparency processing on the captured video.

In one aspect of the present technology, performing motion capture of a subject predetermined is performed on the basis of a captured video including a subject and distance information, and transparency processing of making the subject on the captured video invisible is performed, and a composite video is generated by compositing an avatar corresponding to the subject that performs a movement detected by the motion capture on the video obtained by the transparency processing on the captured video or compositing the avatar obtained by the transparency processing on the captured video.

### BRIEF DESCRIPTION OF DRAWINGS

FIG. 1 is a diagram for describing appearance of a subject.

FIG. 2 is a diagram for describing the present technology.

FIG. 3 is a diagram illustrating a configuration example of an imaging system.

FIG. 4 is a diagram for describing generation of a composite video using 3D mapping data.

FIG. 5 is a flowchart for describing composite video generation processing.

FIG. 6 is a diagram for describing complementation with a video imaged in advance.

FIG. 7 is a diagram illustrating a configuration example of an imaging system.

FIG. 8 is a flowchart for describing preliminary imaging processing.

FIG. 9 is a flowchart for describing composite video generation processing.

FIG. 10 is a diagram for describing imaging by a sub-imaging unit.

FIG. 11 is a diagram for describing complementation with a video imaged by the sub-imaging unit.

FIG. 12 is a diagram illustrating a configuration example of an imaging system.

FIG. 13 is a flowchart for describing composite video generation processing.

FIG. 14 is a diagram for describing complementation with a video of a background generated by estimation.

FIG. 15 is a diagram illustrating a configuration example of an imaging system.

FIG. 16 is a flowchart for describing composite video generation processing.

FIG. 17 is a diagram for describing complementation with a video based on application data.

FIG. 18 is a diagram illustrating a configuration example of an imaging system.

FIG. 19 is a flowchart for describing composite video generation processing.

FIG. 20 is a diagram for describing transparentization by adjusting the size of an avatar or the like.

FIG. 21 is a diagram illustrating a configuration example of an imaging system.

FIG. 22 is a flowchart for describing composite video generation processing.

FIG. 23 is a diagram for describing detection of a subject utilizing 3D mapping data.

FIG. 24 is a flowchart for describing composite video generation processing.

FIG. 25 is a diagram for describing complementation based on a past background video.

FIG. 26 is a diagram illustrating a configuration example of an imaging system.

FIG. 27 is a flowchart for describing composite video generation processing.

FIG. 28 is a diagram illustrating processing according to a distance to a target subject.

FIG. 29 is a diagram illustrating a configuration example of an imaging system.

FIG. 30 is a flowchart for describing composite video generation processing.

FIG. 31 is a diagram for describing continuation and temporary stop of imaging.

FIG. 32 is a diagram illustrating a configuration example of an imaging system.

FIG. 33 is a flowchart for illustrating determination processing.

FIG. 34 is a diagram illustrating a captured video and an imaging visual field of 3D mapping.

FIG. 35 is a diagram for describing generation of a composite video.

FIG. 36 is a diagram illustrating a configuration example of an imaging system.

FIG. 37 is a flowchart for describing composite video generation processing.

FIG. 38 is a diagram for describing reflection of a front-back positional relationship between subjects.

FIG. 39 is a diagram illustrating a configuration example of an imaging system.

FIG. 40 is a flowchart for describing composite video generation processing.

FIG. 41 is a diagram for describing reflection of a front-back positional relationship between target subjects.

FIG. 42 is a diagram illustrating a configuration example of an imaging system.

FIG. 43 is a flowchart for describing composite video generation processing.

FIG. 44 is a diagram for describing reflection of a front-back positional relationship between subjects.

FIG. 45 is a diagram illustrating a configuration example of an imaging system.

FIG. 46 is a flowchart for describing composite video generation processing.

FIG. 47 is a diagram for describing a change of size of an avatar.

FIG. 48 is a diagram illustrating a configuration example of an imaging system.

FIG. 49 is a flowchart for describing composite video generation processing.

FIG. 50 is a diagram illustrating adjustment of a display size of an avatar according to a distance.

FIG. 51 is a diagram illustrating a configuration example of an imaging system.

FIG. 52 is a flowchart for describing composite video generation processing.

FIG. 53 is a diagram for describing avatar display with a contact point of a subject as a starting point.

FIG. 54 is a diagram illustrating a configuration example of an imaging system.

FIG. 55 is a flowchart for describing composite video generation processing.

FIG. 56 is a diagram for describing composite of an arbitrary separate video.

FIG. 57 is a diagram illustrating a configuration example of an imaging system.

FIG. 58 is a flowchart for describing composite video generation processing.

FIG. 59 is a diagram illustrating a configuration example of a computer.

### MODE FOR CARRYING OUT THE INVENTION

Hereinafter, embodiments to which the present technology is applied will be described with reference to the drawings.

### Present Technology

The present technology relates to an AR video imaging method by motion capture capable of suppressing occurrence of appearance of a subject.

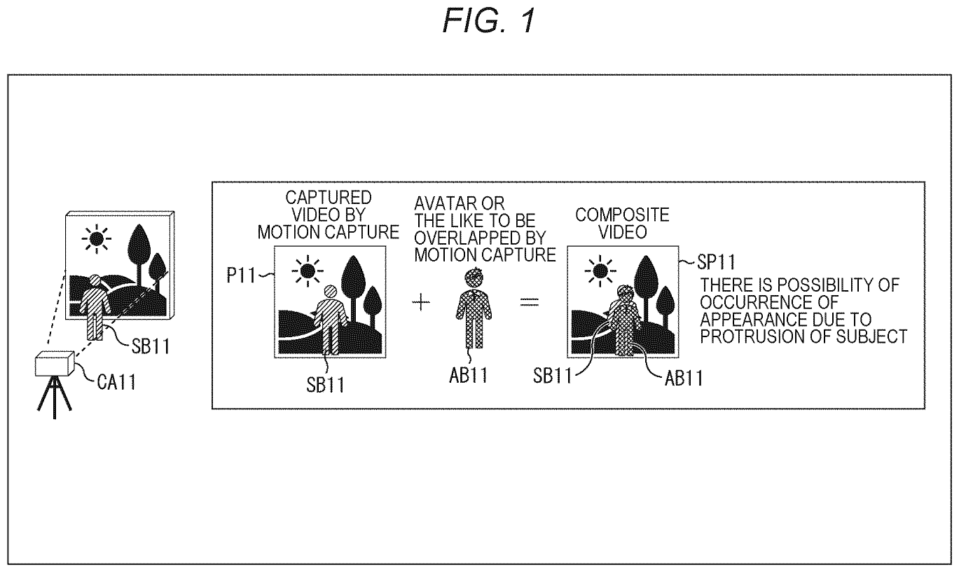

In general presentation of an AR video, for example, as illustrated on the left side in FIG. 1, a specific subject SB11 such as a person and other subjects such as a background are imaged by a camera CA11.

Then, on the basis of a captured video P11 obtained by imaging by the camera CA11, motion capture that detects a movement of the subject SB11 is performed, and avatar motion data that is a video of an avatar AB11 that moves in accordance with the movement (motion) obtained as a result of the motion capture is generated.

Furthermore, the avatar motion data (avatar AB11) is composited (superimposed) on the portion of the subject SB11 on the captured video P11, and a composite video SP11 to be presented to a user or the like is generated.

However, in this method, since the avatar AB11 is directly superimposed on the portion of the subject SB11 and composited (displayed), if the shapes of the subject SB11 and the avatar AB11 do not completely match, the subject SB11 protrudes from the portion of the avatar AB11 on the composite video SP11. That is, appearance of the subject SB11 occurs.

Therefore, in the present technology, occurrence of appearance can be suppressed by performing processing of making a specific subject on a captured video invisible, that is, by performing transparency processing of the specific subject.

In particular, in the present technology, by using 3D mapping which is distance information indicating a distance from an imaging position to a specific subject or another subject such as a background, occurrence of appearance can be suppressed more easily and reliably regardless of an imaging place.

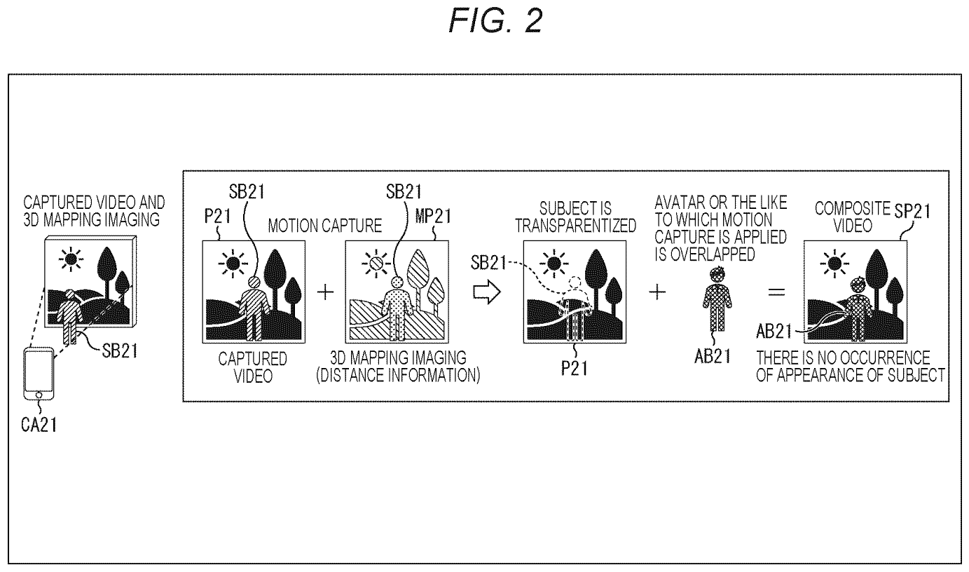

Specifically, in the present technology, for example, as illustrated on the left side in FIG. 2, a specific subject SB21 such as a person and other subjects such as a background are set as targets (subjects), and a captured video that is a normal moving picture (video) and 3D mapping are imaged by the camera CA21.

As a result, the captured video P21 including the subject SB21 and the like as the subject and 3D mapping MP21 that is the distance information indicating a distance from the camera CA21 to each subject such as the subject SB21 or another subject in the background are obtained. By using the captured video P21 and the 3D mapping MP21, the region and movement of the subject SB21 can be detected more accurately.

In the present technology, for example, complementary processing (replacement) is performed on the region of the subject SB21 on the captured video P21 by a captured video imaged in advance, another video prepared in advance, or the like, so that the transparency processing of making the subject SB21 on the captured video P21 invisible is implemented.

Furthermore, motion capture of the subject SB21 is performed on the basis of the captured video P21 or the 3D mapping MP21 obtained by imaging. That is, the movement of the subject SB21 is detected. Then, the video of the avatar AB21 corresponding to the subject SB21 that moves in accordance with the movement of the subject SB21 is generated as the avatar motion data.

Furthermore, the avatar AB21 is composited with the region of the subject SB21 on the captured video P21 on which the transparency processing has been performed, and a composite video SP21 to be presented to the user or the like is generated.

As described above, since the present technology eliminates the need for preparing virtual model data of a virtual space in advance, the subject SB21 can be transparentized regardless of the imaging place, and the composite video SP21 in which the subject SB21 does not appear can be obtained. That is, the avatar AB21 can be composited without causing discomfort to the real background. Therefore, the composite video SP21 can be presented without losing a world view as a video.

Furthermore, in the present technology, by utilizing not only the captured video P21 but also the 3D mapping MP21, it is possible to more easily and accurately detect the region and movement of the subject SB21 and naturally integrate the avatar AB21 and the like into a real space on the composite video SP21.

### <Schematic Configuration Example of Imaging System>

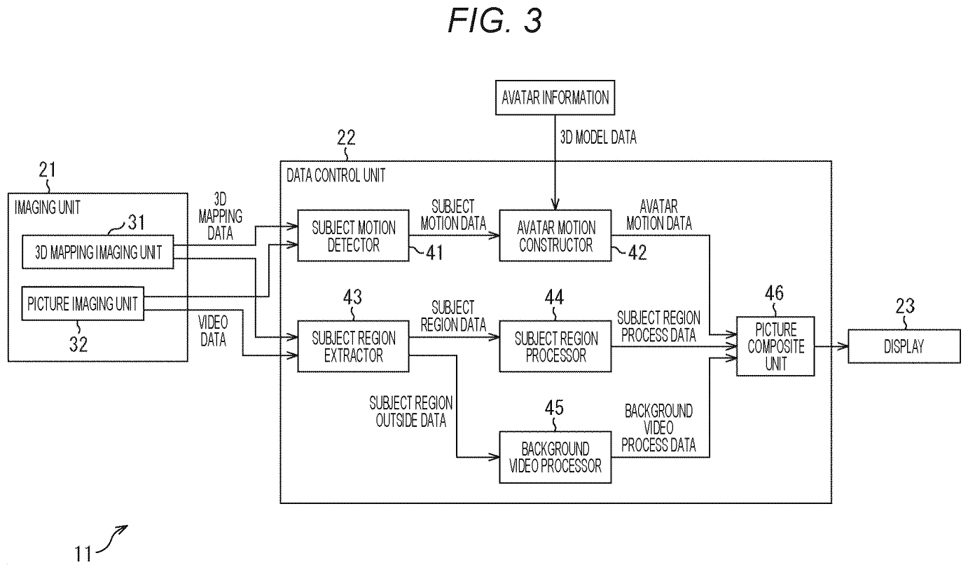

FIG. 3 is a diagram illustrating a schematic configuration of an imaging system to which the present technology is applied.

An imaging system 11 illustrated in FIG. 3 includes an imaging unit 21, a data control unit 22, and a display 23.

The imaging unit 21 includes, for example, a camera or the like, and images (acquires) a captured video and 3D mapping using a specific person (user), a background, or the like as a subject. The imaging unit 21 includes a 3D mapping imaging unit 31 and a picture imaging unit 32.

The 3D mapping imaging unit 31 includes, for example, a distance measuring sensor such as a time of flight (ToF) sensor, a stereo camera, or a structured light system. The 3D mapping imaging unit 31 performs 3D mapping imaging on a specific person (user), a background, or the like as a target, and supplies the data control unit 22 with 3D mapping data indicating an imaging position, that is, a distance from the 3D mapping imaging unit 31 to a subject (target), obtained as a result.

The picture imaging unit 32 includes, for example, an image sensor or the like, captures a moving picture (captured video) by using a specific person (user), a background, or the like as a subject, and supplies video data of the captured video obtained as a result to the data control unit 22.

Note that the 3D mapping imaging unit 31 and the picture imaging unit 32 may be individually provided, or may be formed on one sensor substrate.

The data control unit 22 includes an information processing device such as, for example, a personal computer, a smartphone, or the like. Note that the imaging unit 21 and the display 23 may be provided in the information processing device including the data control unit 22, or the imaging unit 21 and the display 23 may be devices different from the information processing device including the data control unit 22.

The data control unit 22 generates video data of the composite video on the basis of the 3D mapping data and the video data including the same subject supplied from the imaging unit 21 and avatar information supplied from the outside, and supplies the video data to the display 23.

The avatar information is 3D model data representing a 3D model of an avatar such as another character or a person image corresponding to a specific subject such as a person on the captured video.

In the following description, it is assumed that a specific person on a captured video is transparentized, and a composite video in which an avatar corresponding to the specific person is composited is generated. In addition, a specific person to be transparentized is also referred to as a target subject.

The data control unit 22 includes a subject motion detector 41, an avatar motion constructor 42, a subject region extractor 43, a subject region processor 44, a background video processor 45, and a picture composite unit 46.

On the basis of the 3D mapping data supplied from the 3D mapping imaging unit 31 and the video data supplied from the picture imaging unit 32, the subject motion detector 41 performs motion capture that is processing of detecting the movement of the target subject on the captured video.

The subject motion detector 41 supplies subject motion data indicating the movement of the target subject detected (captured) by the motion capture to the avatar motion constructor 42.

Note that the subject motion detector 41 performs motion capture of the target subject on the basis of at least one of the 3D mapping data or the video data of the captured video.

For example, depending on the distance from the 3D mapping imaging unit 31 to the target subject, accurate movement of the target subject may not be detectable with the 3D mapping data. Furthermore, depending on an imaging environment such as brightness around the imaging unit 21, accurate movement of the target subject may not be detectable with the video data of the captured video.

Therefore, the subject motion detector 41 adopts any one of a detection result of the movement of the target subject based on the 3D mapping data or a detection result of the movement of the target subject based on the video data as a final detection result or detects the movement of the target subject based on only one of the 3D mapping data or the video data in accordance with the imaging environment such as, for example, the distance to the target subject and the brightness.

Note that, in the motion capture, the region of the target subject may be detected from the 3D mapping data or the video data, and the movement of the target subject may be detected on the basis of the detection result, or the movement of the target subject may be detected directly from the 3D mapping data or the video data without detecting the region of the target subject.

On the basis of the subject motion data supplied from the subject motion detector 41 and the avatar information supplied from the outside, the avatar motion constructor 42 generates (constructs) avatar motion data that is a video of an avatar that moves in the same manner as the target subject, and supplies the avatar motion data to the picture composite unit 46.

The subject region extractor 43 detects a region (hereinafter, also referred to as a subject region) of the target subject on the captured video on the basis of at least one of the 3D mapping data supplied from the 3D mapping imaging unit 31 or the video data supplied from the picture imaging unit 32.

The subject region extractor 43 extracts the region of the target subject from the captured video, and supplies data of a picture (video) of the extracted target subject to the subject region processor 44 as subject region data. In addition, the subject region extractor 43 supplies data of a picture (video) obtained by removing the region of the target subject from the captured video to the background video processor 45 as subject region outside data that is video data of a subject other than the target subject, that is, the background.

In addition, the subject region extractor 43 supplies the 3D mapping data to the subject region processor 44 and the background video processor 45 as necessary.

The subject region processor 44 performs, on the subject region data supplied from the subject region extractor 43, processing of performing a predetermined process or the like, such as processing of transparentize the target subject, as subject region process treatment, and supplies subject region process data obtained as a result to the picture composite unit 46.

The background video processor 45 performs, as a background video process treatment, picture processing (process treatment) or the like of superimposing a picture of a predetermined object on the subject region outside data supplied from the subject region extractor 43, and supplies background video process data obtained as a result to the picture composite unit 46.

The picture composite unit 46 composites the avatar motion data supplied from the avatar motion constructor 42, the subject region process data supplied from the subject region processor 44, and the background video process data supplied from the background video processor 45, and supplies video data of the composite video obtained as a result to the display 23.

The display 23 displays the composite video on the basis of the video data supplied from the picture composite unit 46.

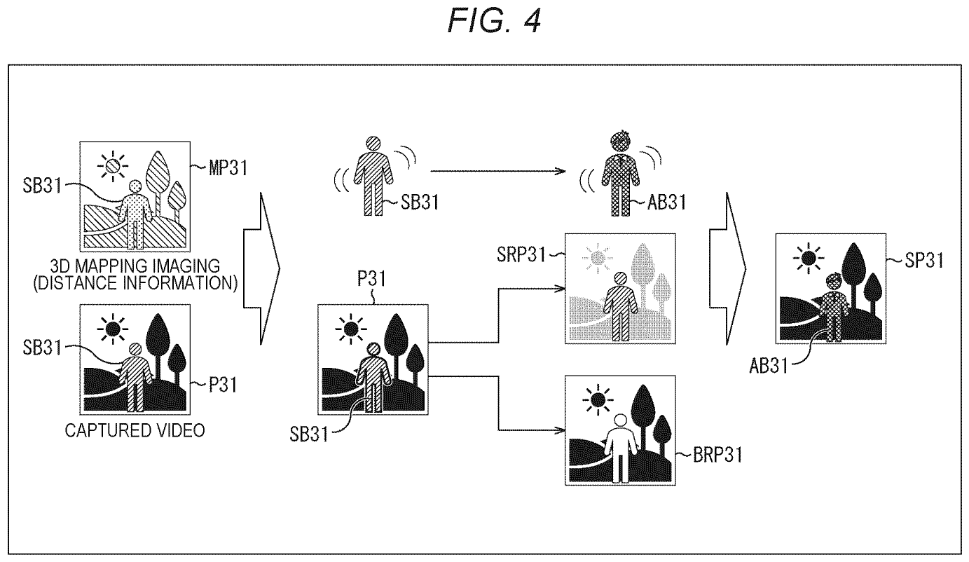

In the imaging system 11 illustrated in FIG. 3, a composite video is generated as illustrated in FIG. 4, for example.

That is, in the example illustrated in FIG. 4, first, 3D mapping MP31 and a captured video P31 including a target subject SB31 as a target are acquired by imaging by the imaging unit 21.

Thereafter, motion capture of the target subject SB31 is performed in the subject motion detector 41, and the avatar motion constructor 42 generates avatar motion data of the avatar AB31 corresponding to the target subject SB31 on the basis of a result of the motion capture. This avatar motion data is video data of the avatar AB31 that moves in the same manner as the target subject SB31.

In addition, the subject region extractor 43 extracts the region of the target subject SB31 from the captured video P31. Then, the subject region processor 44 generates a video SRP31 corresponding to the region of the target subject SB31, and the background video processor 45 generates a background video BRP31. Here, the video SRP31 is a video based on the subject region process data, and the background video BRP31 is a video based on the background video process data.

Finally, the picture composite unit 46 composites the avatar motion data of the avatar AB31, the video SRP31 (subject region process data), and the background video BRP31 (background video process data) to generate one composite video SP31.

In this case, the video obtained by compositing the video SRP31 and the background video BRP31 is a video of the background obtained by performing the transparency processing of transparentizing the target subject SB31 on the captured video P31.

In the data control unit 22, the transparency processing is achieved by processing performed by at least one or more blocks among a plurality of blocks including the avatar motion constructor 42 to the picture composite unit 46, such as extraction of the target subject by the subject region extractor 43 and generation of a video by the subject region processor 44.

As an example, in the transparency processing, for example, a subject region that is a region of a target subject on a captured video is extracted, and a background video is composited with the extracted subject region to make the target subject invisible. In addition, as another example, in the transparency processing, for example, the subject region on the captured video is extracted, the size of the avatar to be composited with the extracted subject region is adjusted, or the video of the avatar with the background to be composited with the extracted subject region is generated to make the target subject invisible.

Therefore, for example, the data control unit 22 generates a composite video by compositing an avatar that corresponds to the target subject and makes a movement detected by motion capture on the video obtained by the transparency processing on the captured video or compositing an avatar obtained by the transparency processing on the captured video.

### <Description of Composite Video Generation Processing>

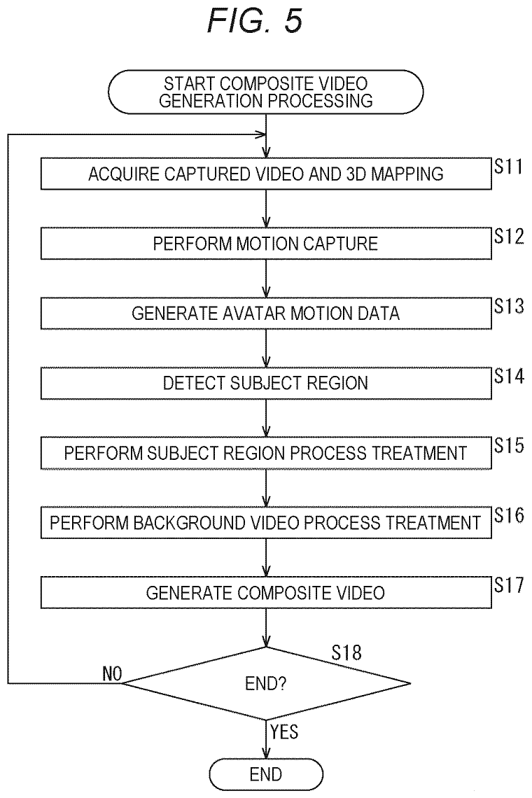

Next, composite video generation processing performed by the imaging system 11 will be described. That is, the composite video generation processing by the imaging system 11 will be described below with reference to the flowchart in FIG. 5.

In step S11, the imaging unit 21 acquires the captured video and the 3D mapping.

That is, the 3D mapping imaging unit 31 performs 3D mapping imaging on a region including the target subject, and supplies 3D mapping data obtained as a result to the subject motion detector 41 and the subject region extractor 43. In addition, the picture imaging unit 32 images a moving picture (captured video) of a region including the target subject as a target, and supplies video data of the captured video obtained as a result to the subject motion detector 41 and the subject region extractor 43. For example, the angle of view (range to be captured) at the time of imaging the captured video is substantially the same as the angle of view at the time of imaging the 3D mapping.

In step S12, the subject motion detector 41 performs motion capture on the basis of the 3D mapping data supplied from the 3D mapping imaging unit 31 and the video data supplied from the picture imaging unit 32, and supplies the subject motion data obtained as a result of the motion capture to the avatar motion constructor 42.

For example, the subject motion detector 41 performs motion capture by using not only 3D mapping data and video data of a frame to be processed but also 3D mapping data and video data of a frame temporally before the frame to be processed.

In step S13, the avatar motion constructor 42 generates avatar motion data on the basis of the subject motion data supplied from the subject motion detector 41 and the avatar information supplied from the outside, and supplies the avatar motion data to the picture composite unit 46.

In step S14, the subject region extractor 43 detects the subject region on the basis of the 3D mapping data supplied from the 3D mapping imaging unit 31 and the video data supplied from the picture imaging unit 32. For example, the subject region is detected by image recognition or the like.

The subject region extractor 43 generates subject region data and subject region outside data on the basis of the detection result of the subject region, supplies the subject region data to the subject region processor 44, and supplies the subject region outside data to the background video processor 45.

In step S15, the subject region processor 44 performs processing of performing a subject region process treatment on the subject region data supplied from the subject region extractor 43, and supplies subject region process data obtained as a result to the picture composite unit 46.

Note that the subject region process treatment is only required to be performed as necessary, and in a case where the subject region process treatment is not performed, for example, the subject region data may be directly supplied to the picture composite unit 46 as the subject region process data.

In step S16, the background video processor 45 performs a background video process treatment on the subject region outside data supplied from the subject region extractor 43, and supplies background video process data obtained as a result to the picture composite unit 46.

Note that the background video process treatment is only required to be performed as necessary, and in a case where the background video process treatment is not performed, for example, the subject region outside data may be directly supplied to the picture composite unit 46 as the background video process data.

In step S17, the picture composite unit 46 composites the avatar motion data supplied from the avatar motion constructor 42, the subject region process data supplied from the subject region processor 44, and the background video process data supplied from the background video processor 45 to generate the composite video. The picture composite unit 46 supplies the obtained video data of the composite video to the display 23, and the display 23 displays the composite video on the basis of the video data supplied from the picture composite unit 46.

For example, the picture composite unit 46 composite the video based on the subject region process data with the portion of the subject region on the video based on the background video process data, and further composite the video of the avatar based on the avatar motion data with the portion of the subject region on the video obtained as a result. In the composite video thus obtained, since the target subject is transparentized, the occurrence of appearance of the target subject is suppressed.

Note that, in the data control unit 22, the transparency processing is achieved by at least a part of the processing performed in steps S13 to S17. In other words, the data control unit 22 performs a part of the processing of steps S13 to S17 as the transparency processing. A specific example of transparentization of the target subject will be described later.

In step S18, the data control unit 22 determines whether or not to end the processing. For example, in a case where the user or the like instructs to end imaging, it is determined that the processing is to be ended.

In a case where it is determined in step S18 that the processing is not to end yet, the processing returns to step S11, and the processing described above is repeatedly performed.

On the other hand, in a case where it is determined that the processing is to end in step S18, each unit of the imaging system 11 temporarily stops the ongoing processing, and the composite video generation processing ends.

As described above, the imaging system 11 acquires the captured video and the 3D mapping, and generates the composite video.

In particular, in the imaging system 11, by using the video data of the captured video and the 3D mapping data, recognition accuracy of the position and shape of the region of the subject can be improved, the subject region can be more accurately extracted, and the movement of the target subject can be more accurately detected. Furthermore, in the imaging system 11, in order to suppress the occurrence of appearance, it is unnecessary to perform processing of delaying the video to generate a CG video of the virtual space, estimate the position and orientation of the imaging unit 21, and composite the avatar.

As described above, the imaging system 11 can suppress the occurrence of appearance of the target subject more easily and reliably regardless of the imaging place.

### First Embodiment

### <Configuration Example of Imaging System>

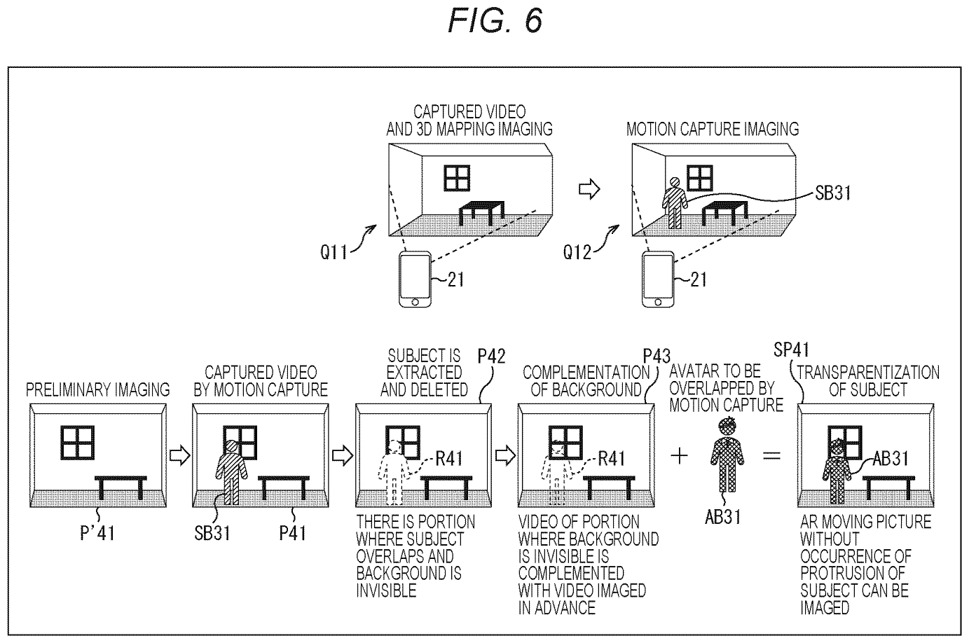

Next, more specific embodiments to which the present technology is applied will be described with reference to FIGS. 6 to 58. Any of the embodiments described below may be combined to generate a composite video.

Note that, in the drawings to be referred to below (FIGS. 6 to 58), portions corresponding to those in the case of FIG. 3 or 4 are denoted by the same reference signs, and a description thereof will be omitted as appropriate. In addition, in FIGS. 6 to 58, the same reference signs are assigned to portions corresponding to each other, and a description thereof will be omitted as appropriate.

First, an example will be described in which a video and 3D mapping of an object around a background or a target subject are imaged in advance, and a background portion that is invisible as the target subject at the time of actual imaging is complemented with the video imaged in advance to transparentize the target subject.

In such a case, for example, as indicated by an arrow Q11 in FIG. 6, in a state where there is no target subject SB31, imaging is performed in advance by the imaging unit 21, and the captured video and the 3D mapping are acquired.

Note that, hereinafter, the reference (complementing) captured video and the 3D mapping obtained by the preliminary imaging are also referred to as a reference captured video and a reference 3D mapping, respectively. In addition, the video data of the reference captured video is also referred to as reference video data.

After preliminary imaging, as indicated by an arrow Q12, in a state where the target subject SB31 is present, imaging is performed by imaging unit 21, the captured video and the 3D mapping are acquired, and the composite video is generated.

In this case, a reference captured video P′41 in which the target subject SB31 does not appear is acquired by the preliminary imaging indicated by the arrow Q11, and a captured video P41 in which the target subject SB31 appears is acquired by the subsequent imaging indicated by the arrow Q12.

In particular, in this example, in the reference captured video P′41 and the captured video P41, the same region on the real space is targeted, and imaging is performed at the same angle of view. Therefore, the reference captured video P′41 and the captured video P41 are different only in whether or not the target subject SB31 appears on the captured video.

The region (subject region) of the target subject SB31 is removed from the captured video P41, and the subject region outside data of a background video P42 that is the video of only the background, that is, the background video process data is generated. However, in the background video P42, there is a region R41 (subject region) where the background is invisible because the target subject SB31 overlaps.

Therefore, the subject region process data corresponding to the region R41 is generated on the basis of the reference captured video P′41. In particular, in this example, in the reference captured video P′41, the same region as the subject region (region R41) on the captured video P41 is extracted and set as the subject region process data. The video based on the subject region process data is a background video of a region (background) corresponding to the region R41, which is hidden by target subject SB31 and is invisible in the captured video P41.

Thus, by compositing the subject region process data and the background video process data, a portion in the subject region (region R41) is complemented, and a video P43 of the background in which the target subject SB31 is transparentized can be obtained.

When the avatar motion data of the avatar AB31 is composited with the video P43 thus obtained, a composite video SP41 without appearance (protrusion) of the target subject SB31 can be obtained as an AR video (moving picture).

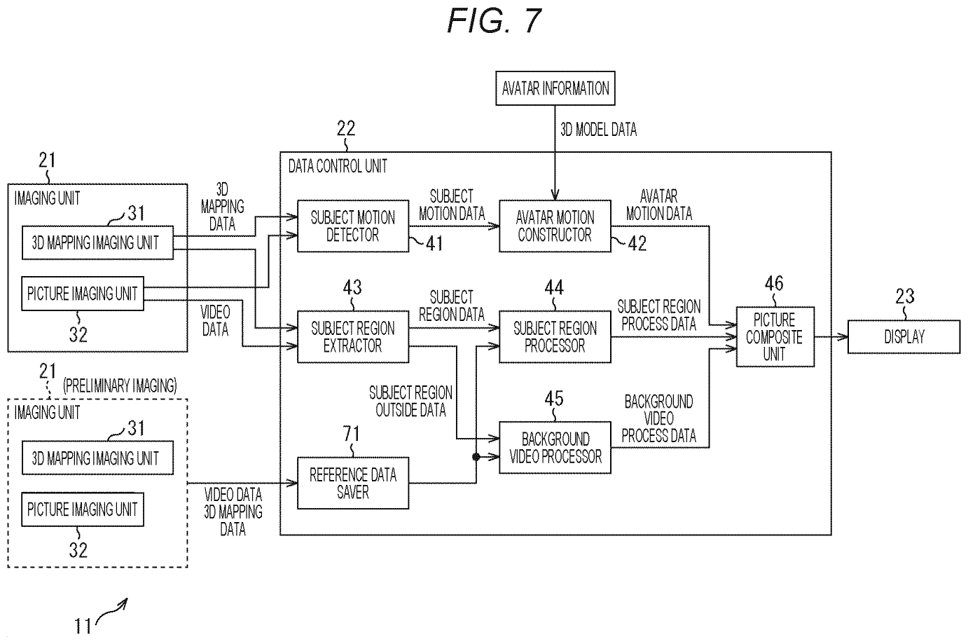

In a case where the reference captured video and the 3D mapping are imaged in advance, the imaging system 11 is configured as illustrated in FIG. 7, for example.

The configuration of the imaging system 11 illustrated in FIG. 7 is a configuration in which a reference data saver 71 is newly provided in the configuration of the imaging system 11 illustrated in FIG. 3. Note that, in FIG. 7, in order to make the drawing easily viewable, two imaging units 21 are actually provided.

The reference data saver 71 stores, as reference video data and reference 3D mapping data, video data and 3D mapping of a reference (complementary) captured video obtained by preliminary imaging by the imaging unit 21. In addition, the reference data saver 71 supplies the stored reference video data and reference 3D mapping data to the subject region processor 44 and the background video processor 45 as necessary.

The subject region processor 44 generates subject region process data on the basis of the subject region data and the 3D mapping data supplied from the subject region extractor 43 and the reference video data and the reference 3D mapping data supplied from the reference data saver 71.

The background video processor 45 generates background video process data on the basis of the subject region outside data and the 3D mapping data supplied from the subject region extractor 43 and the reference video data and the reference 3D mapping data supplied from the reference data saver 71.

### <Description of Preliminary Imaging Processing>

Next, the motion of the imaging system 11 illustrated in FIG. 7 will be described.

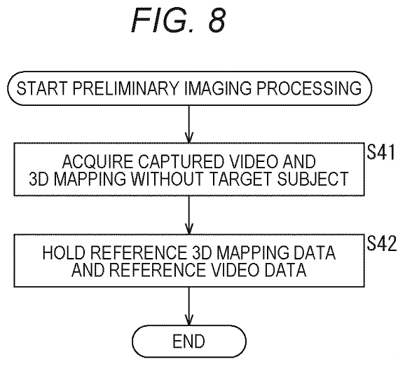

First, the preliminary imaging processing performed by the imaging system 11 will be described with reference to a flowchart in FIG. 8.

In step S41, the imaging unit 21 acquires the captured video and the 3D mapping without the target subject.

That is, the 3D mapping imaging unit 31 performs preliminary imaging of 3D mapping in a state where there is no target subject, and supplies the 3D mapping data obtained as a result to the reference data saver 71 as reference 3D mapping data. In addition, the picture imaging unit 32 images a captured video in advance in a state where there is no target subject, and supplies video data of the captured video obtained as a result to the reference data saver 71 as reference video data.

In step S42, the reference data saver 71 holds the reference 3D mapping data supplied from the 3D mapping imaging unit 31 and the reference video data supplied from the picture imaging unit 32, and the preliminary imaging processing ends.

Note that, hereinafter, a data set including the reference 3D mapping data and the reference video data is also referred to as reference data.

As described above, the imaging system 11 acquires and holds the reference data. In this way, in the imaging system 11, the target subject can be easily transparentized by using the reference data.

### <Description of Composite Video Generation Processing>

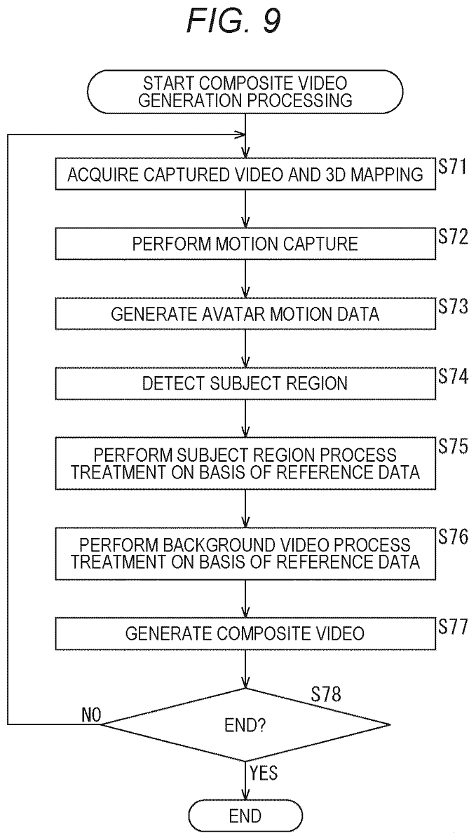

When the preliminary imaging processing is performed to obtain the reference 3D mapping data and the reference video data, thereafter, the imaging system 11 performs composite video generation processing of imaging in a state where the target subject is present at an arbitrary timing and generating a composite video. Hereinafter, the composite video generation processing by the imaging system 11 will be described below with reference to the flowchart in FIG. 9.

Note that the processing of step S71 to step S74 is similar to the processing of step S11 to step S14 in FIG. 5, and thus the description thereof will be omitted.

In step S75, the subject region processor 44 performs the subject region process treatment on the basis of the subject region data and the 3D mapping data supplied from the subject region extractor 43 and the reference data supplied from the reference data saver 71.

For example, the subject region processor 44 specifies a region on the reference captured video corresponding to the subject region on the basis of the subject region data, the 3D mapping data, and the reference data, extracts a picture of the specified region on the reference captured video, and sets the picture as the subject region process data.

In this case, the subject region process treatment is processing in which the subject region data is replaced with picture data of a region on the reference captured video corresponding to the subject region to be subject region process data, and the target subject is transparentized by this processing. The subject region processor 44 supplies the subject region process data obtained by the subject region process treatment to the picture composite unit 46.

In step S76, the background video processor 45 performs the background video process treatment on the basis of the subject region outside data and the 3D mapping data supplied from the subject region extractor 43 and the reference data supplied from the reference data saver 71.

For example, the background video processor 45 specifies a region on the reference captured video corresponding to the subject region on the basis of the subject region outside data, the 3D mapping data, and the reference data, and generates the background video process data by performing blending processing on the basis of the specification result.

The blending processing is performed on a region near a boundary with the subject region in the background video (hereinafter, also referred to as a target region). That is, in the target region, the background video based on the subject region outside data and the reference captured video are subjected to a weighted addition, and the video based on the background video process data is generated. Furthermore, outside the target region, the background video based on the subject region outside data is directly used as the video based on the background video process data.

The background video processor 45 supplies the background video process data obtained by the background video process treatment to the picture composite unit 46.

When the processing of step S76 is performed, thereafter, the processing of steps S77 and S78 is performed and the composite video generation processing ends, but since the processing of these steps is similar to the processing of steps S17 and S18 in FIG. 5, the description thereof will be omitted.

As described above, the imaging system 11 performs processing of transparentizing the target subject on the basis of the reference data, and generates a composite video. In this case, it is also possible to suppress the occurrence of appearance of the target subject more easily and reliably regardless of the imaging place.

### Second Embodiment

### <Configuration Example of Imaging System>

An example will be described in which captured videos are simultaneously imaged by a plurality of picture imaging units for a target subject, and a background portion invisible from the target subject is complemented by using the obtained plurality of captured videos to transparentize the target subject.

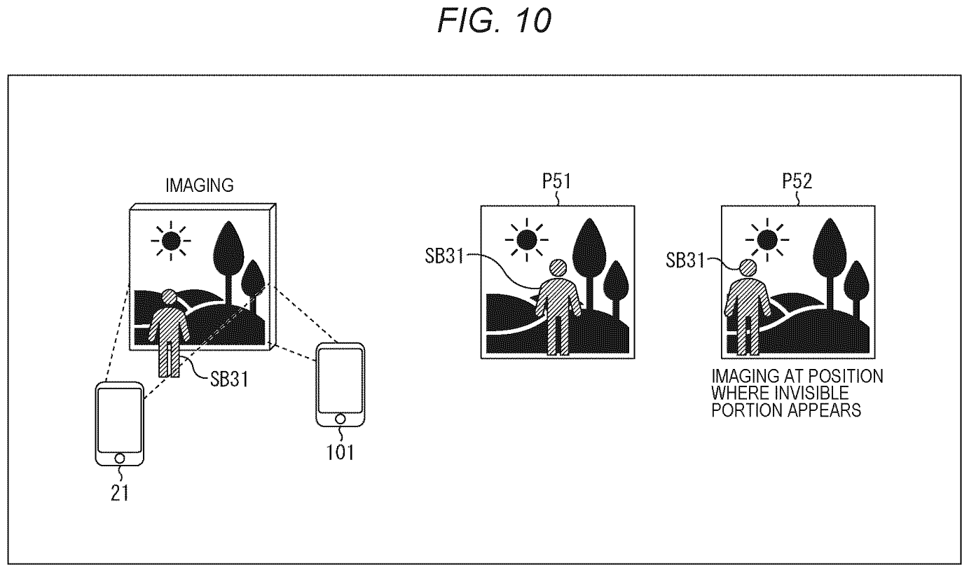

In such a case, for example, as illustrated in FIG. 10, imaging is performed by the imaging unit 21 serving as a main camera, and at the same time, imaging is also performed by a sub-imaging unit 101 serving as a sub-camera. At this time, the imaging unit 21 and the sub-imaging unit 101 are disposed at different positions so that a background portion that is hidden by the target subject and invisible when imaged by the imaging unit 21 (picture imaging unit 32) is imaged by imaging by the sub-imaging unit 101.

In this example, a captured video P51 including the target subject SB31 is imaged by the imaging unit 21, and a captured video P52 including the target subject SB31 is imaged by the sub-imaging unit 101.

In the captured video P52, a background portion that is hidden by the target subject SB31 and is invisible on the captured video P51 is included (appears) as a subject.

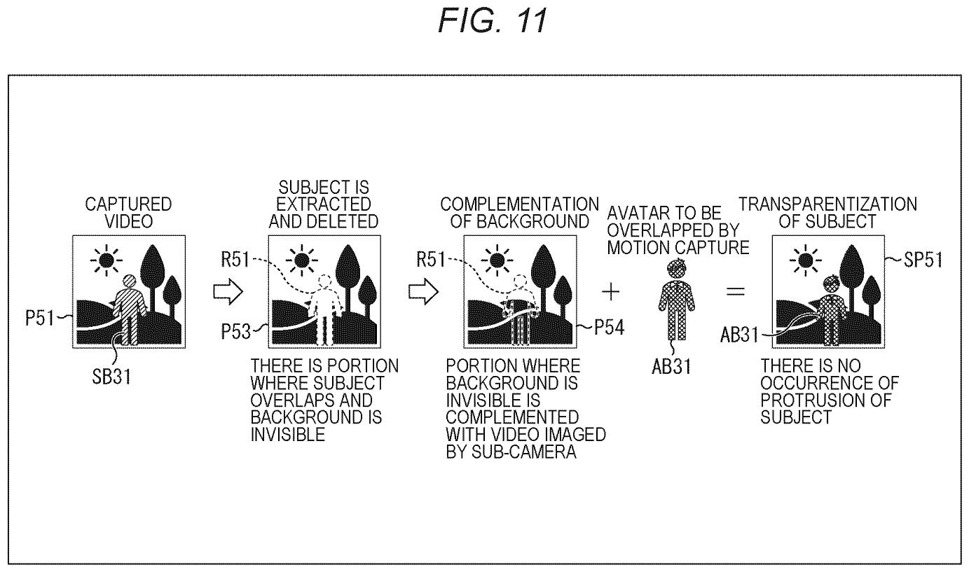

Therefore, as illustrated in FIG. 11, a composite video SP51 in which the target subject SB31 does not appear can be obtained by using the captured video P51 and the captured video P52.

In FIG. 11, a region R51 of the target subject SB31 is extracted and deleted (removed) from the captured video P51 imaged by the imaging unit 21 serving as the main camera, and video data of a video P53 of the background obtained as a result is set as background video process data.

Furthermore, a region corresponding to the region R51 of the target subject SB31 on the captured video P52 is extracted from the captured video P51 imaged by the sub-imaging unit 101 serving as the sub-camera, and the video data of the extracted region is set as the subject region process data. The video based on the subject region process data is a background video of a region (background) corresponding to the region R51, which is hidden by target subject SB31 and is invisible in the captured video P51.

Then, the video P54 is generated by compositing the video of the background portion based on the subject region process data and the background video P53. This video P54 is a video in which the target subject SB31 is transparentized, the video being obtained by complementing the portion of the region R51 of the target subject SB31 in the captured video P51 with the captured video P52.

When the avatar motion data of the avatar AB31 is composited with the video P54 thus obtained, the composite video SP51 without appearance (protrusion) of the target subject SB31 can be obtained.

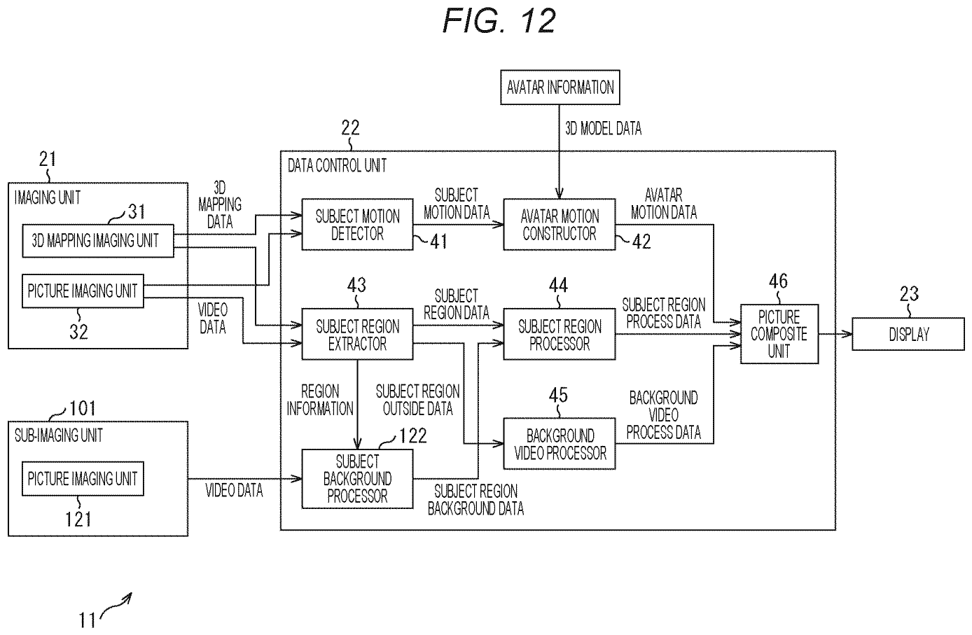

In a case where complementation is performed on the basis of the captured video obtained by the sub-imaging unit 101, the imaging system 11 has a configuration illustrated in FIG. 12, for example.

The configuration of the imaging system 11 illustrated in FIG. 12 is a configuration in which the sub-imaging unit 101, that is, the picture imaging unit 121 and the subject background processor 122 are newly provided in the configuration of the imaging system 11 illustrated in FIG. 3.

The sub-imaging unit 101 is a sub-camera (another imaging unit) at a position different from the position of the imaging unit 21 that is the main camera, and includes the picture imaging unit 121.

The picture imaging unit 121 includes, for example, an image sensor or the like, images a moving picture (captured video) by using a target subject, a background, and the like as a subject from an imaging position different from the imaging position of the picture imaging unit 32, and supplies video data of the captured video obtained as a result to the subject background processor 122. Note that, hereinafter, the captured video imaged by the picture imaging unit 121 is also particularly referred to as a complementary captured video. Furthermore, the sub-imaging unit 101 may be provided with a 3D mapping imaging unit that performs 3D mapping imaging from an imaging position different from the 3D mapping imaging unit 31.

The subject background processor 122 generates subject region background data on the basis of region information and the 3D mapping data supplied from the subject region extractor 43 and the video data of the complementary captured video supplied from the picture imaging unit 121, and supplies the subject region background data to the subject region processor 44.

The region information is information indicating a region of the target subject in the captured video obtained by imaging by the picture imaging unit 32, that is, the subject region. In other words, the region information is information indicating the position and range of the region in which the target subject appears on the captured video.

The subject region background data is data of a video of a region (hereinafter, also referred to as an occlusion region) on the complementary captured video corresponding to the region information, that is, a video of a background portion invisible hidden by the target subject on the captured video obtained by the picture imaging unit 32.

### <Description of Composite Video Generation Processing>

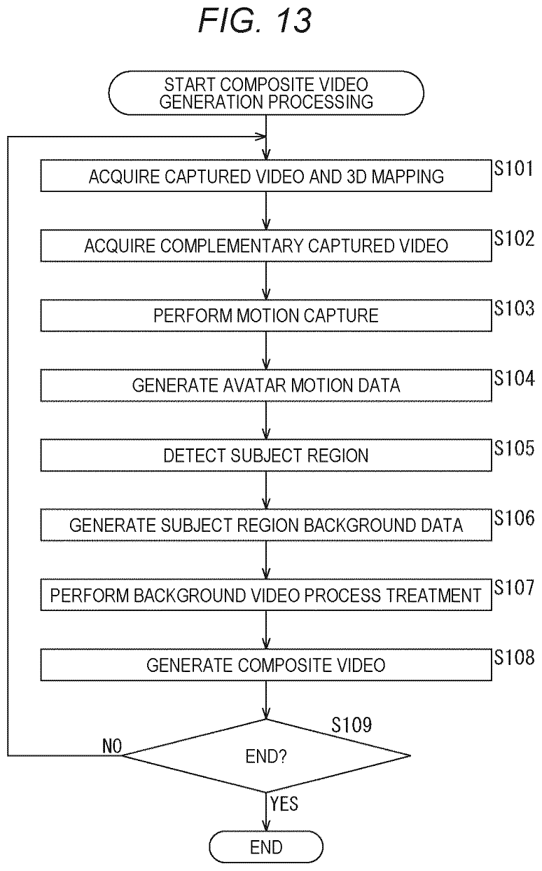

Next, the composite video generation processing performed by the imaging system 11 illustrated in FIG. 12 will be described with reference to a flowchart in FIG. 13.

Note that the processing of step S101 is similar to the processing in step S11 in FIG. 5, and thus the description thereof will be omitted.

In step S102, the sub-imaging unit 101 acquires the complementary captured video. That is, the picture imaging unit 121 images a moving picture (captured video) targeting a region including the target subject, and supplies video data of the complementary captured video obtained as a result to the subject background processor 122.

In a case where the complementary captured video is obtained, thereafter, the processing of step S103 to step S105 is performed, but the processing is similar to the processing of step S12 to step S14 in FIG. 5, and thus the description thereof will be omitted.

However, in step S105, the subject region extractor 43 generates region information indicating the region of the target subject on the captured video, and supplies the region information and the 3D mapping data to the subject background processor 122.

In step S106, the subject background processor 122 generates subject region background data on the basis of region information and the 3D mapping data supplied from the subject region extractor 43 and the video data of the complementary captured video supplied from the picture imaging unit 121.

For example, the subject background processor 122 extracts an occlusion region on the complementary captured video corresponding to the subject region indicated by the region information on the basis of positional relationship information indicating a known positional relationship between the picture imaging unit 32 and the picture imaging unit 121, the region information, and the 3D mapping data.

The subject background processor 122 generates subject region background data by performing, on the video (picture) of the extracted occlusion region, processing of aligning the positional relationship of the subject between the captured videos, for example, deformation processing on the occlusion region on the basis of the positional relationship information, the region information, and the 3D mapping data.

In this embodiment, the target subject is transparentized by processing of generating the subject region background data. The subject background processor 122 supplies the generated subject region background data to the subject region processor 44.

The subject region background data is video data of an occlusion region (background portion) that is hidden by the target subject and invisible on the captured video obtained by the picture imaging unit 32 and is formed in the same shape as the subject region indicated by the region information. In other words, the subject region background data is video data of an occlusion region when the position of the picture imaging unit 32 is viewed as a viewpoint position.

Furthermore, the subject region processor 44 generates subject region process data on the basis of the subject region data supplied from the subject region extractor 43 and the subject region background data supplied from the subject background processor 122, and supplies the subject region process data to the picture composite unit 46.

Note that the subject region processor 44 may perform some process treatment on the subject region background data to obtain the subject region process data, or may directly use the subject region background data as the subject region process data.

When the processing of step S106 is performed, thereafter, the processing of steps S107 to S109 is performed and the composite video generation processing ends, but since the processing of these steps is similar to the processing of steps S116 to S18 in FIG. 5, the description thereof will be omitted.

As described above, the imaging system 11 performs processing of transparentizing the target subject on the basis of the complementary captured video, and generates a composite video. In this case, it is also possible to suppress the occurrence of appearance of the target subject more easily and reliably regardless of the imaging place.

### Third Embodiment

### <Configuration Example of Imaging System>

An example will be described in which a target subject is transparentized by generating and complementing a video of a background portion invisible to the target subject on a captured video by estimation.

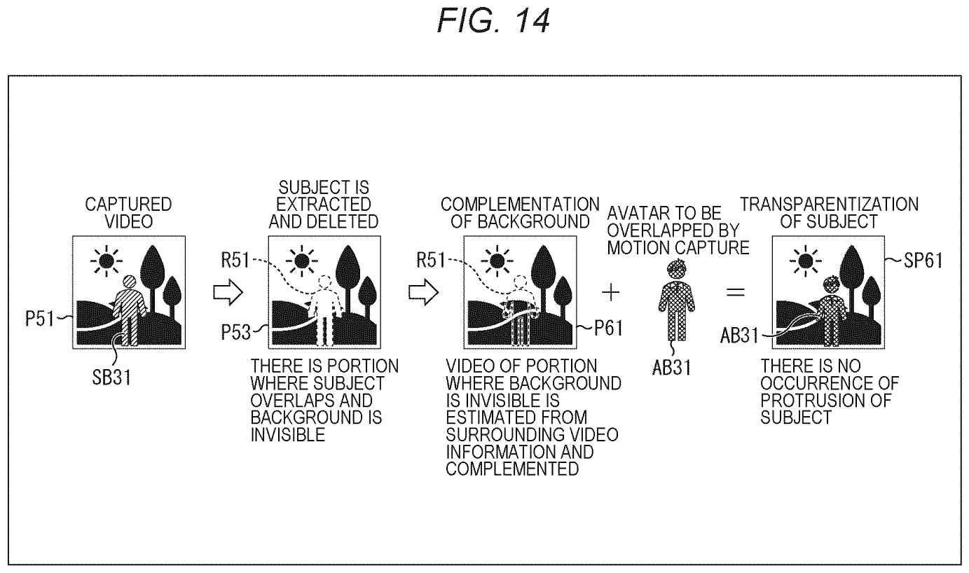

In such a case, for example, as illustrated in FIG. 14, the captured video P51 including the target subject SB31 is imaged by the imaging unit 21. In addition, the region R51 of the target subject SB31 is extracted and deleted (removed) from the captured video P51, and video data of the video P53 of the background obtained as a result is set as background video process data.

On the other hand, on the basis of the video of the region around the region R51 of the captured video P51, the video of the background portion hidden by the target subject SB31 and invisible, that is, the background of the region R51 is estimated, and the video data of a video having the same shape as the region R51 obtained as a result of the estimation is set as the subject region process data.

At this time, the color and shape of the subject serving as the background in the portion of the region R51 are estimated from the color and shape of the subject serving as the background around (near) the region R51 in the captured video P51.

The video P61 is generated by compositing the video of the background portion based on the subject region process data thus obtained and the video P53 of the background. This video P61 is a video in which the target subject SB31 is transparentized, the video being obtained by complementing the portion of the region R51 of the target subject SB31 in the captured video P51 with a video of the background generated by estimation.

When the avatar motion data of the avatar AB31 is composited with the video P61, a composite video SP61 without appearance (protrusion) of the target subject SB31 can be obtained.

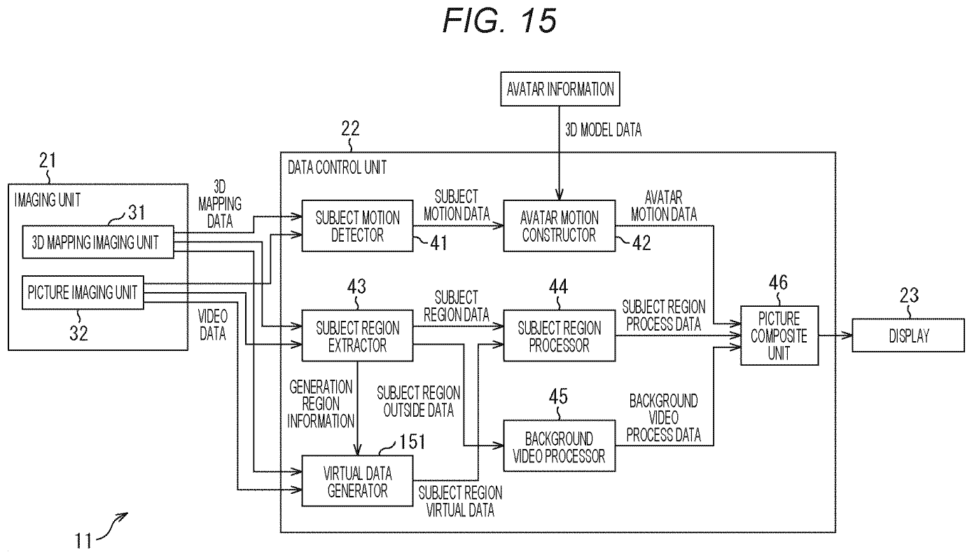

In a case where complementation is performed on the basis of the video of the background generated by estimation, the imaging system 11 has a configuration illustrated in FIG. 15, for example.

The configuration of the imaging system 11 illustrated in FIG. 15 is a configuration in which a virtual data generator 151 is newly provided in the configuration of the imaging system 11 illustrated in FIG. 3.

In this example, the subject region extractor 43 generates generation region information indicating the region of the target subject on the captured video, and supplies the generation region information to the virtual data generator 151. The generation region information is information indicating the region of the target subject on the captured video, but can be also said to be information indicating the region of the background generated by estimation.

The virtual data generator 151 performs estimation processing on the basis of the generation region information supplied from the subject region extractor 43, the 3D mapping data supplied from the 3D mapping imaging unit 31, and the video data of the captured video supplied from the picture imaging unit 32, and generates subject region virtual data.

The subject region virtual data is video data of the background portion that is hidden by the target subject in the region (subject region) indicated by the generation region information on the captured video and is invisible, the video data of a video having the same shape as the region indicated by the generation region information, the video data being generated by the estimation processing.

The virtual data generator 151 supplies the generated subject region virtual data to the subject region processor 44.

### <Description of Composite Video Generation Processing>

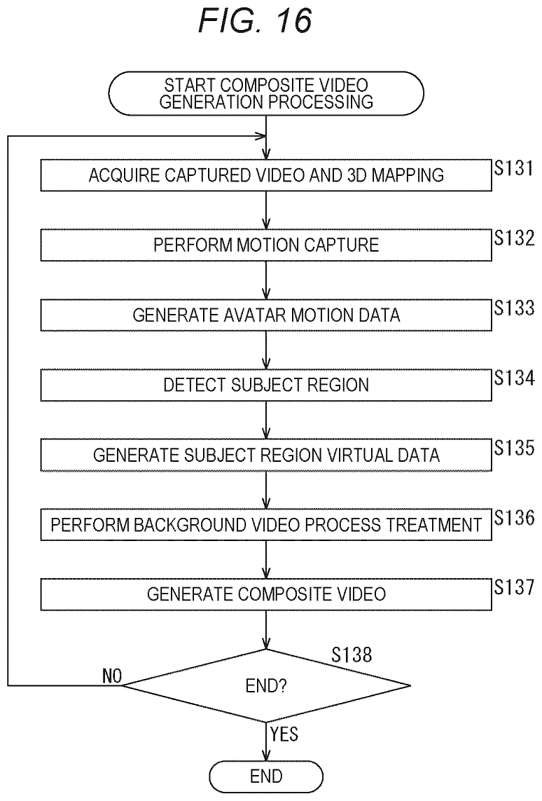

Next, the composite video generation processing performed by the imaging system 11 illustrated in FIG. 15 will be described with reference to a flowchart in FIG. 16.

Note that the processing of step S131 to step S134 is similar to the processing of step S11 to step S14 in FIG. 5, and thus the description thereof will be omitted.

However, in step S134, the subject region extractor 43 generates generation region information indicating a region of the target subject on the captured video, that is, a region where the background is to be generated by estimation, and supplies the generation region information to the virtual data generator 151.

In step S135, the virtual data generator 151 generates subject region virtual data on the basis of the generation region information supplied from the subject region extractor 43, the 3D mapping data supplied from the 3D mapping imaging unit 31, and the video data supplied from the picture imaging unit 32.

For example, the virtual data generator 151 generates the subject region virtual data by estimating the color and the shape of the subject to be the background in the region indicated by the generation region information from the color and the shape of the subject (background) near the region indicated by the generation region information in the captured video by inpainting (picture interpolation). At this time, by using the 3D mapping data, the position and shape of the region of each subject can be recognized with higher accuracy, and a more probable background can be estimated. That is, accuracy of estimation of the background can be improved.

In this embodiment, the target subject is transparentized by generating the subject region virtual data. The virtual data generator 151 supplies the generated subject region virtual data to the subject region processor 44.

Furthermore, the subject region processor 44 generates subject region process data on the basis of the subject region data supplied from the subject region extractor 43 and the subject region virtual data supplied from the virtual data generator 151, and supplies the subject region process data to the picture composite unit 46.

Note that the subject region processor 44 may perform some process treatment on the subject region virtual data to obtain the subject region process data, or may directly use the subject region virtual data as the subject region process data.

When the processing of step S135 is performed, thereafter, the processing of steps S136 to S138 is performed and the composite video generation processing ends, but since the processing of these steps is similar to the processing of steps S16 to S18 in FIG. 5, the description thereof will be omitted.

As described above, the imaging system 11 performs processing of transparentizing the target subject on the basis of the video of the background generated by estimation, and generates a composite video. In this case, it is also possible to suppress the occurrence of appearance of the target subject more easily and reliably regardless of the imaging place.

### Fourth Embodiment

### <Configuration Example of Imaging System>

An example will be described in which an arbitrary separate video (another picture) different from the subject, such as a single-color still picture or an effect picture (effect video), is composited with a subject region extracted from a captured video to transparentize the target subject.

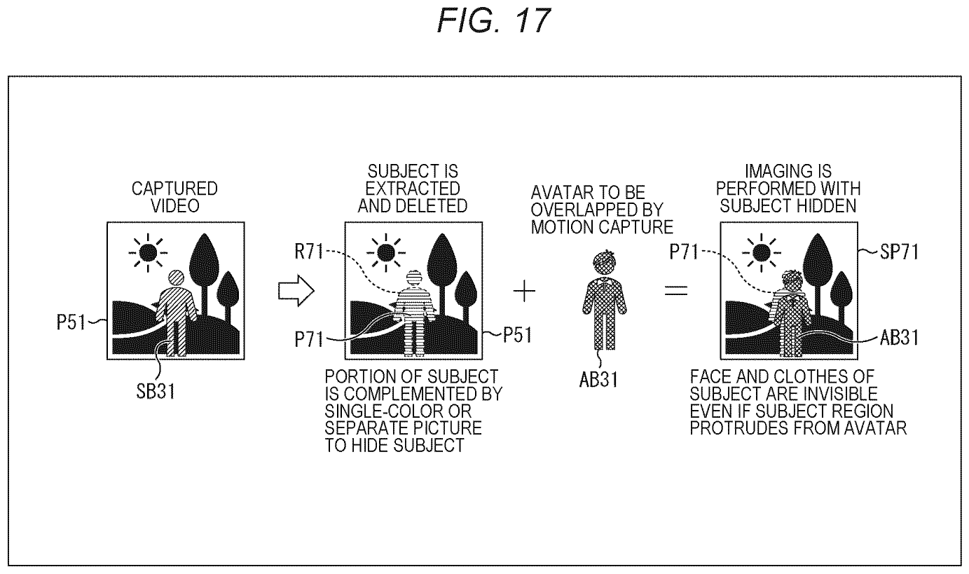

In such a case, for example, as illustrated in FIG. 17, the captured video P51 including the target subject SB31 is imaged by the imaging unit 21.

In addition, a region R71 of the target subject SB31 is extracted from the captured video P51, and video data of the video P51 having the same shape as the region R71 of a captured video P71 is generated as the subject region process data. The video P71 is generated on the basis of application data that is video data of a separate video different from the video of the target subject, such as a single-color still picture, an effect video, or a graphic video prepared in advance, for example.

Note that the application data may be information specifying a color, a pattern, or the like. Even in such a case, the subject region process data of a single color, a predetermined pattern, or the like can be obtained from the color, pattern, or the like specified by the application data.

By compositing the video P71 of the background portion based on the subject region process data and the captured video P51, a video in which the target subject SB31 is transparentized can be obtained.

Then, by further compositing the avatar motion data of the avatar AB31 with the video obtained by compositing the captured video P51 and the video P71, a composite video SP71 without appearance (protrusion) of the target subject SB31 can be obtained. In the composite video SP71, it can be seen that the target subject SB31 is replaced with the video P71 based on the application data and transparentized.

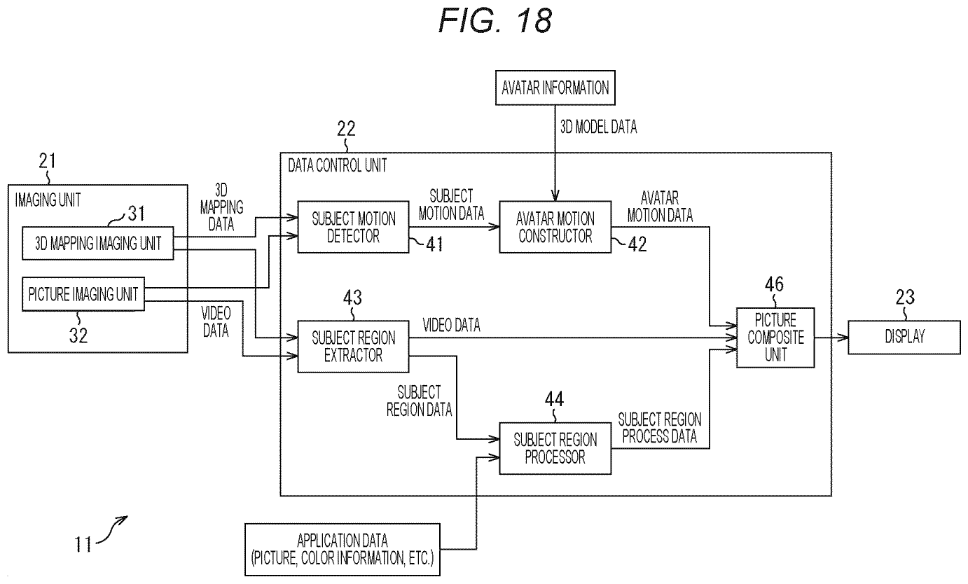

In a case where complementation is performed by the video based on the application data, the imaging system 11 has a configuration illustrated in FIG. 18, for example.

The configuration of the imaging system 11 illustrated in FIG. 18 is different from the configuration of the imaging system 11 illustrated in FIG. 3 in that the background video processor 45 is not provided.

In this example, the subject region extractor 43 supplies the subject region data to the subject region processor 44, and directly supplies the video data of the captured video to the picture composite unit 46.

The subject region processor 44 generates subject region process data on the basis of the subject region data supplied from the subject region extractor 43 and the application data supplied from the outside, and supplies the subject region process data to the picture composite unit 46.

In addition, the picture composite unit 46 composites the avatar motion data from the avatar motion constructor 42, the subject region process data from the subject region processor 44, and the video data of the captured video from the subject region extractor 43 to generate video data of the composite video.

Note that the subject region outside data may be supplied as the background video process data from the subject region extractor 43 to the picture composite unit 46. In such a case, the avatar motion data, the subject region process data, and the background video process data (subject region outside data) are composited and set as the video data of the composite video.

### <Description of Composite Video Generation Processing>

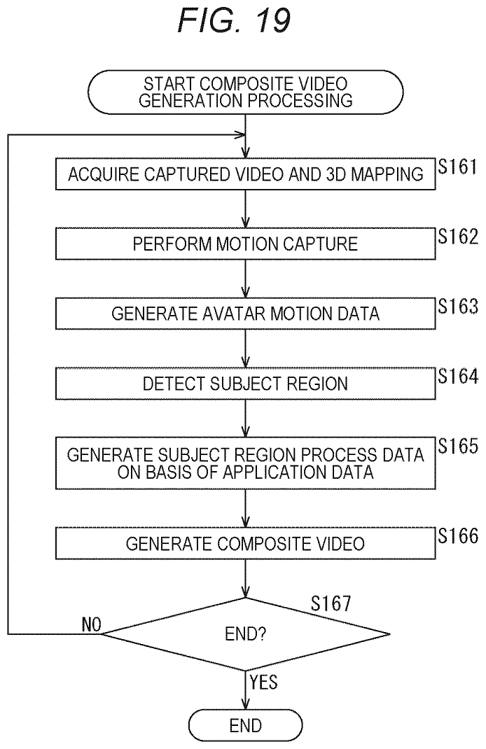

Next, the composite video generation processing performed by the imaging system 11 illustrated in FIG. 18 will be described with reference to a flowchart in FIG. 19.

Note that the processing of step S161 to step S164 is similar to the processing of step S11 to step S14 in FIG. 5, and thus the description thereof will be omitted.

In step S164, however, the subject region extractor 43 supplies the subject region data to the subject region processor 44, and supplies the video data of the captured video to the picture composite unit 46.

In step S165, the subject region processor 44 generates subject region process data on the basis of the subject region data supplied from the subject region extractor 43 and the application data supplied from the outside, and supplies the subject region process data to the picture composite unit 46.

For example, the subject region processor 44 generates the subject region process data by replacing the entire video based on the subject region data with a video based on the application data such as a single-color video, an effect video, or a graphic video.

When the processing of step S165 is performed, thereafter, the processing of steps S166 and S167 is performed and the composite video generation processing ends, but since the processing of these steps is similar to the processing of steps S17 and S18 in FIG. 5, the description thereof will be omitted.

In step S166, however, the avatar motion data, the subject region process data, and the video data of the captured video are composited to generate video data of the composite video.

As described above, the imaging system 11 generates the subject region process data on the basis of the application data, and generates the video data of the composite video by using the subject region process data. In this case, it is also possible to suppress the occurrence of appearance of the target subject more easily and reliably regardless of the imaging place.

### Fifth Embodiment

### <Configuration Example of Imaging System>

An example will be described in which a target subject on a captured video is transparentized by adjusting a size or the like of an avatar to be composited (superimposed) so that the target subject is completely covered and hidden.

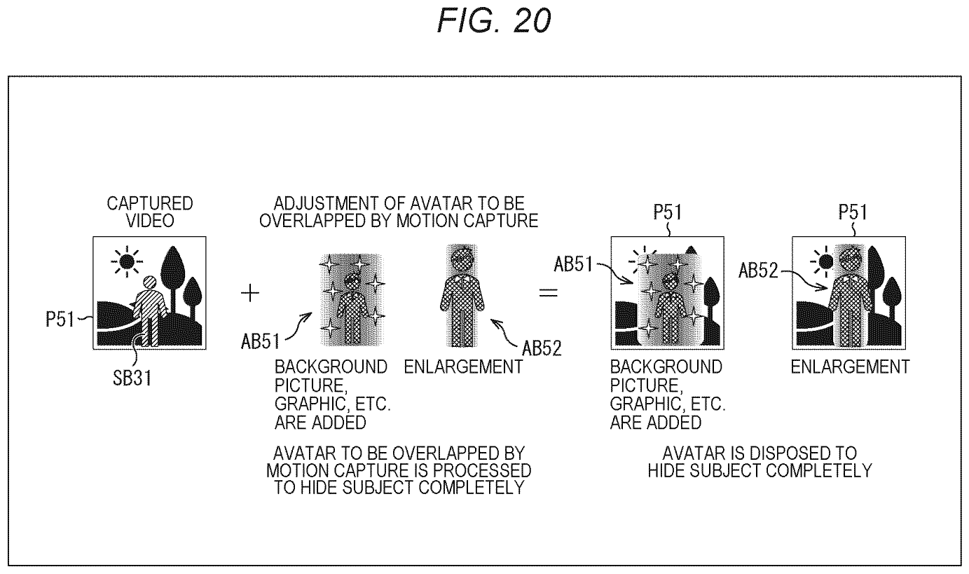

In such a case, for example, as illustrated in FIG. 20, the captured video P51 including the target subject SB31 is imaged by the imaging unit 21.

Furthermore, the avatar motion data of an avatar AB51 to which a background picture, a graphic, or the like is added or the avatar motion data of an enlarged avatar AB52 is generated in accordance with the size (magnitude) of the region of the target subject SB31 in the captured video P51.

At this time, the avatar AB51 and the avatar AB52 are sized and shaped such that, in a case where the avatar AB51 and the avatar AB52 are superimposed on the region of the target subject SB31, the region of the target subject SB31 is completely invisible (hidden) by the avatar AB51 and the avatar AB52.

Note that, in the following description, the background, graphic, or the like given to the avatar in the avatar AB51 is also referred to as an avatar background, and data of the avatar background is also referred to as avatar background data.

Furthermore, as illustrated on the right side in the drawing, the avatar AB51 to which the avatar background is added or the enlarged avatar AB52 is composited with the captured video P51, and a composite video without appearance (protrusion) of the target subject SB31 is generated.

In the composite video thus obtained, the target subject SB31 is completely covered by the avatar AB51 or the avatar AB52 and invisible, and it can be seen that the target subject SB31 is transparentized.

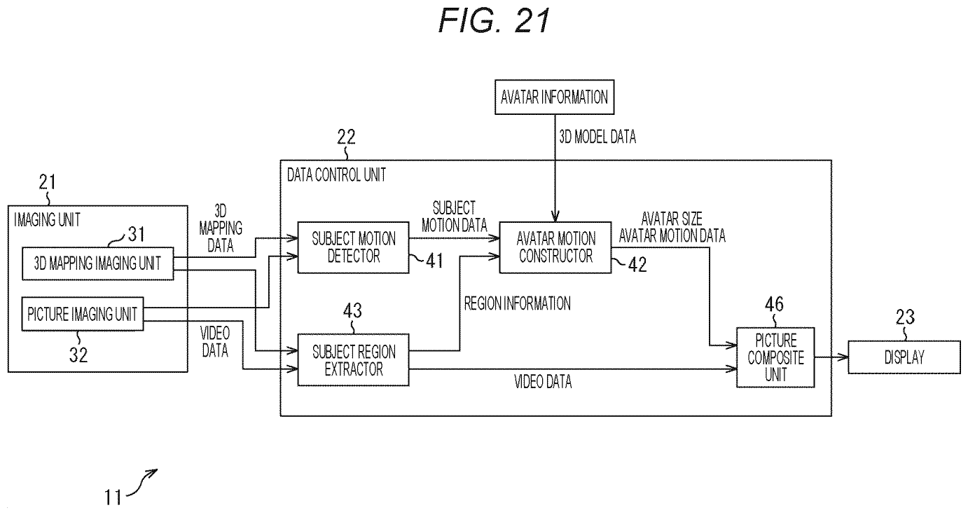

In a case where transparentization is achieved by adjusting the size of the avatar or the like, the imaging system 11 has a configuration illustrated in FIG. 21, for example.

The configuration of the imaging system 11 illustrated in FIG. 21 is different from the configuration of the imaging system 11 illustrated in FIG. 3 in that the subject region processor 44 and the background video processor 45 are not provided.

In this example, the subject region extractor 43 supplies region information indicating a region (subject region) of the target subject to the avatar motion constructor 42, and directly supplies the video data of the captured video to the picture composite unit 46.

Furthermore, in this example, the avatar information supplied to the avatar motion constructor 42 includes not only 3D model data of the avatar but also avatar background data.

The avatar motion constructor 42 generates avatar motion data on the basis of the subject motion data supplied from the subject motion detector 41, the avatar information supplied from the outside, and the region information supplied from the subject region extractor 43 and supplies the avatar motion data to the picture composite unit 46.

At this time, the avatar motion constructor 42 also generates avatar size information indicating the size of the avatar at the time of compositing as necessary, and supplies the avatar size information to the picture composite unit 46.

The picture composite unit 46 composites the avatar motion data from the avatar motion constructor 42 and the video data of the captured video from the subject region extractor 43 to generate video data of the composite video.

### <Description of Composite Video Generation Processing>

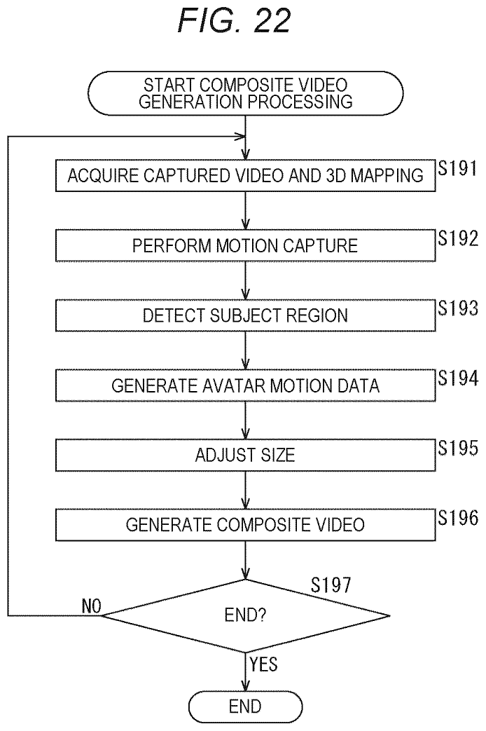

Next, the composite video generation processing performed by the imaging system 11 illustrated in FIG. 21 will be described with reference to a flowchart in FIG. 22.

Note that, since processing of steps S191 to S193 is similar to the processing of steps S11, S12, and S14 in FIG. 5, description thereof is omitted.

In step S193, however, the subject region extractor 43 generates region information in accordance with a detection result of the target subject, supplies the region information to the avatar motion constructor 42, and directly supplies the video data of the captured video to the picture composite unit 46.

In step S194, the avatar motion constructor 42 generates avatar motion data and avatar size information on the basis of the subject motion data supplied from the subject motion detector 41, the avatar information supplied from the outside, and the region information supplied from the subject region extractor 43 and supplies the avatar motion data and the avatar size information to the picture composite unit 46.

For example, the avatar motion constructor 42 performs processing similar to the processing of step S13 in FIG. 5 on the basis of the subject motion data and the avatar information, and generates avatar motion data for displaying only avatars without an avatar background.

Furthermore, on the basis of the avatar motion data and the region information, the avatar motion constructor 42 determines the size of the video of the avatar on the basis of the avatar motion data so that the target subject is completely covered and hidden by the avatar at the time of compositing of the avatar motion data, and generates avatar size information indicating the determination result.

In addition, for example, the avatar motion data of the avatar with the avatar background composited at the position of the subject region may be generated by using the avatar background data.

In such a case, the avatar motion constructor 42 determines the size of the avatar background such that the target subject is completely covered and hidden by the avatar at the time of compositing of the avatar motion data on the basis of the avatar information including the avatar background data and the region information.

Then, the avatar motion constructor 42 generates avatar motion data in which an avatar background of the determined size is added to the avatar on the basis of the subject motion data and the avatar information. In this case, since the size of the avatar background has already been adjusted, even if the avatar motion data is directly composited with the video data of the captured video, the target subject does not appear in the composite video.

Note that, similarly to the case without the avatar background, the avatar motion data of the avatar to which the avatar background is added may be generated without considering the size, and the avatar size information may be generated on the basis of the avatar motion data and the region information.

In step S195, the picture composite unit 46 performs size adjustment on the basis of the avatar size information and the avatar motion data supplied from the avatar motion constructor 42.

In other words, the picture composite unit 46 appropriately performs size adjustment to enlarge (enlarge) the avatar so that the size of the avatar based on the avatar motion data composited at the position of the subject region becomes the size indicated by the avatar size information to generate avatar motion data after size adjustment. Note that the size adjustment of the avatar may be performed by the avatar motion constructor 42 instead of the picture composite unit 46.

In step S196, the picture composite unit 46 composites the video data of the captured video supplied from the subject region extractor 43 with the avatar motion data after the size adjustment in step S195 to generate video data of the composite video, and supplies the video data to the display 23.

When the processing of step S196 is performed, thereafter, the processing of step S197 is performed, and the composite video generation processing ends. However, since the processing of step S197 is similar to the processing of step S18 in FIG. 5, description of the processing of step S197 will be omitted.

As described above, the imaging system 11 transparentizes the target subject by performing size adjustment on the avatar motion data, and generates a composite video. In this case, it is also possible to suppress the occurrence of appearance of the target subject more easily and reliably regardless of the imaging place.

### Sixth Embodiment

### <Utilization of 3D Mapping Data>

An example will be described in which, in a case where the target subject to be transparentized cannot be discriminated only by the captured video, when the target subject can be discriminated on the basis of the 3D mapping data, the target subject is transparentized by using a discrimination result based on the 3D mapping data. In the present embodiment, the configuration of the imaging system 11 is, for example, the configuration illustrated in FIG. 3.

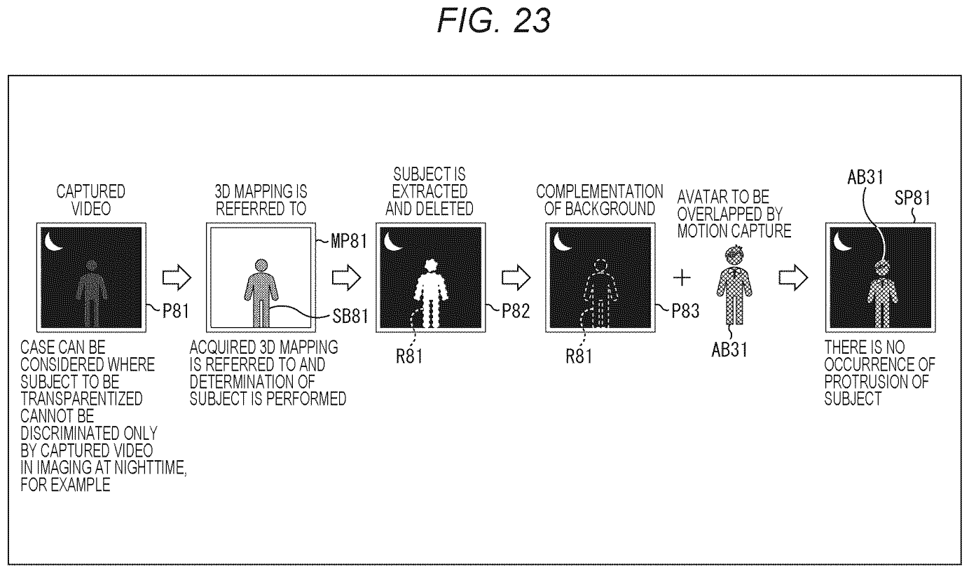

For example, as illustrated in FIG. 23, it is assumed that a target subject SB81 cannot be detected from a captured video P81 obtained by imaging by the imaging unit 21 because of imaging in a dark environment such as nighttime. That is, it is assumed that the subject to be the target subject SB81 cannot be determined on the captured video P81.

In this way, a case where the target subject SB81 cannot be detected from the captured video P81 may occur not only during imaging in a dark environment but also in a background situation such as a scene where the target subject SB81 is difficult to recognize.

On the other hand, it is assumed that the target subject SB81 can be detected from 3D mapping MP81 obtained by imaging by 3D mapping imaging unit 31. That is, it is assumed that whether or not the subject is the target subject SB81 can be determined. In such a case, a region R81 of the target subject SB81 detected on the basis of the 3D mapping MP81 is extracted and deleted (removed) from the captured video P81, and video data of a video P82 of a background obtained as a result is set as background video process data.

In addition, the video data of the background in the portion of the region R81 is generated as the subject region process data by an arbitrary method. Then, by compositing the avatar motion data of the avatar AB31 with a video P83 obtained by compositing the video based on the subject region process data and the video P82 based on the background video process data, a composite video SP81 without appearance of the target subject SB81 can be obtained.

### <Description of Composite Video Generation Processing>

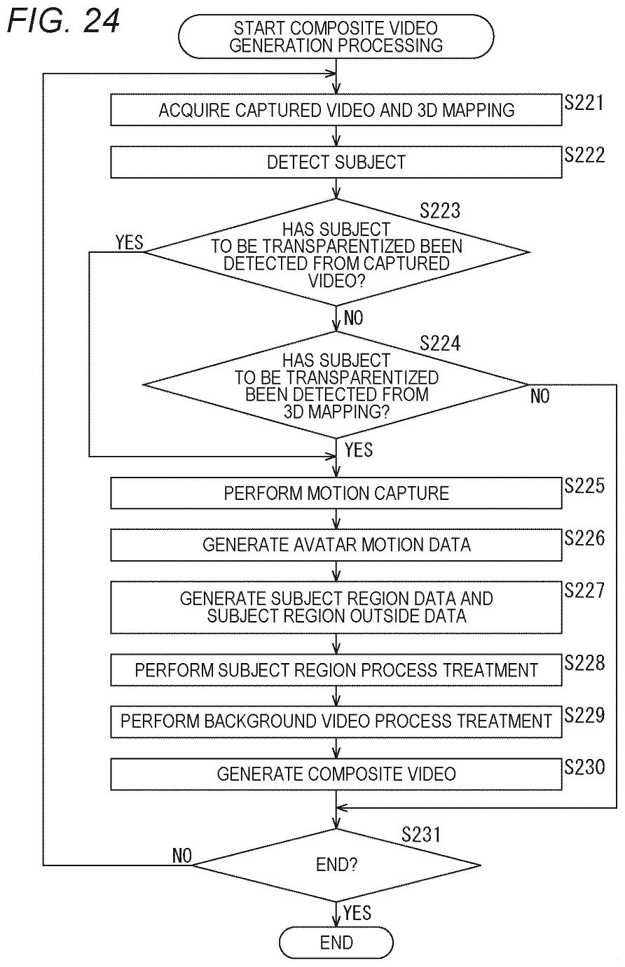

Next, the composite video generation processing performed by the imaging system 11 will be described with reference to a flowchart in FIG. 24.

Note that the processing in step S221 is similar to the processing in step S11 in FIG. 5, and thus the description thereof will be omitted.

In step S222, the subject motion detector 41 and the subject region extractor 43 detect a subject to be transparentized (target subject) from each of the 3D mapping data supplied from the 3D mapping imaging unit 31 and the video data of the captured video supplied from the picture imaging unit 32.

In step S223, the subject motion detector 41 and the subject region extractor 43 determine whether or not a subject to be transparentized has been detected from the video data of the captured video.

For example, the detection result of the target subject may be shared between the subject motion detector 41 and the subject region extractor 43, and in a case where the target subject has been detected from the captured video in both the subject motion detector 41 and the subject region extractor 43, it may be determined that the subject to be transparentized has been detected.

In a case where it is determined in step S223 that the subject has been detected, thereafter, the processing proceeds to step S225.

On the other hand, in a case where it is determined in step S223 that the subject has not been detected, the subject motion detector 41 and the subject region extractor 43 determine in step S224 whether or not a subject to be transparentized has been detected from the 3D mapping data.

In this case, similarly to the case in step S223, for example, in a case where the target subject has been detected from the 3D mapping data in both the subject motion detector 41 and the subject region extractor 43, it may be determined that the subject to be transparentized has been detected.

In a case where it is determined in step S224 that the subject has not been detected, the target subject cannot be transparentized. Therefore, the subsequent processing of steps S225 to S230 is skipped, and the processing proceeds to step S231. In this case, for example, the display of the composite video is not updated, and the frame of the most recently displayed composite video remains displayed on the display 23.

Furthermore, in a case where it is determined in step S224 that the subject has been detected, thereafter, the processing proceeds to step S225.

In a case where it is determined that the subject has been detected in step S223 or step S224, thereafter, the processing of steps S225 and S226 is performed, but since the processing of these steps is similar to the processing of steps S12 and S13 in FIG. 5, the description thereof will be omitted.

Note that, in a case where it is determined in step S223 that the subject has been detected, in step S225, the subject motion detector 41 performs motion capture on the basis of at least one of the video data of the captured video or the 3D mapping data. That is, for example, the movement of the target subject is detected by appropriately using the detection result of the target subject from the video data of the captured video or the 3D mapping data in step S222.

On the other hand, in a case where it is determined in step S224 that the subject has been detected, since the target subject has not been detected from the captured video, the video data of the captured video cannot be used for motion capture. Therefore, in a case where it is determined in step S224 that the subject has been detected, the subject motion detector 41 performs motion capture on the basis of only the 3D mapping data in step S225.

In step S227, the subject region extractor 43 generates subject region data and subject region outside data on the basis of the detection result of the target subject in step S222, supplies the subject region data to the subject region processor 44, and supplies the subject region outside data to the background video processor 45.

In particular, in a case where it is determined in step S223 that the subject has been detected, the subject region extractor 43 extracts the subject region on the basis of at least one of the video data of the captured video or the 3D mapping data, and generates the subject region data and the subject region outside data.

On the other hand, in a case where it is determined in step S224 that the subject has been detected, the subject region extractor 43 extracts the subject region from the captured video on the basis of only the detection result of the target subject from the 3D mapping data, and generates the subject region data and the subject region outside data.

When the processing of step S227 is performed, thereafter, the processing of steps S228 to S231 is performed and the composite video generation processing ends, but since the processing of these steps is similar to the processing of steps S15 to S18 in FIG. 5, the description thereof will be omitted.

In this case, for example, in step S228, similarly to step S165 in FIG. 19, the subject region process data is generated on the basis of the subject region data and the application data supplied from the outside, and the target subject is transparentized. Note that, in this embodiment, the target subject may be transparentized by any method such as the method described in any embodiment described above or any method described later, not limited to the example of using the application data.

As described above, the imaging system 11 detects the target subject from the captured video and the 3D mapping, performs motion capture and extracts the subject region in accordance with the detection result, and generates a composite video. In this case, it is also possible to suppress the occurrence of appearance of the target subject more easily and reliably regardless of the imaging place.

### Seventh Embodiment

### <Configuration Example of Imaging System>

An example will be described in which the target subject is transparentized by complementing the background portion invisible for the target subject in the frame to be processed of the captured video by using the captured video of the past frame, that is, the frame temporally before the frame to be processed.

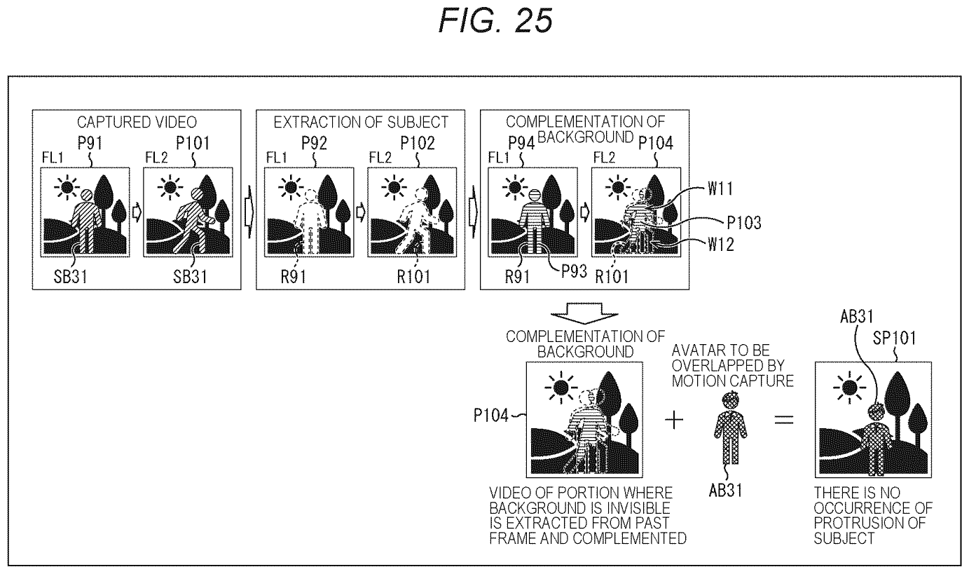

For example, as illustrated in FIG. 25, it is assumed that the imaging unit 21 images a captured video P91 of a predetermined frame FL1 including the target subject SB31.

In addition, it is assumed that a region R91 of the target subject SB31 is extracted and deleted from the captured video P91, video data of a video P92 of the background obtained as a result is set as background video process data, and video data of a video P93 of a single color or the like generated from the application data described above is set as subject region process data.

In this case, a video P94 obtained by compositing the video P92 and the video P93 is a captured video in which the target subject SB31 is transparentized in the frame FL1 to be processed.

In this example, the video data of the video P92 of the background of the frame FL1, specifically, the subject region outside data is held as past background data which is video data of past background video.

In addition, in a frame FL2 following the frame FL1, it is assumed that a captured video P101 including the target subject SB31 is imaged, a region R101 of the target subject SB31 is extracted and deleted from the captured video P101, and video data of a video P102 of the background is set as the background video process data.

In this case, in the frame FL2, the video data of the video P103 set as the subject region process data is generated from the application data and the past background data that is the video data of the background video of the past frame.

Here, in the region of the video P103, for example, as indicated by an arrow W11, a video is generated on the basis of the application data for a region having no corresponding past background video, that is, a region of the background not appearing in the past background video.

On the other hand, in the region of the video P103, for example, as indicated by an arrow W12, a video is generated on the basis of the past background data for a region having a corresponding past background video, that is, a region of the background appearing in the past background video.

When the subject region process data of each frame is generated by using the past background video in such a manner, as the held past background data increases, the region that can be complemented by the past background video, that is, the region that can be generated by the past background video increases, and a more natural composite video is obtained.

Furthermore, a video P104 obtained by compositing the video P103 and the video P102 of the background is a captured video in which the target subject SB31 is transparentized in the frame FL2. When the avatar motion data of the avatar AB31 is composited with the video P104, a composite video SP101 without appearance of the target subject SB31 can be obtained.

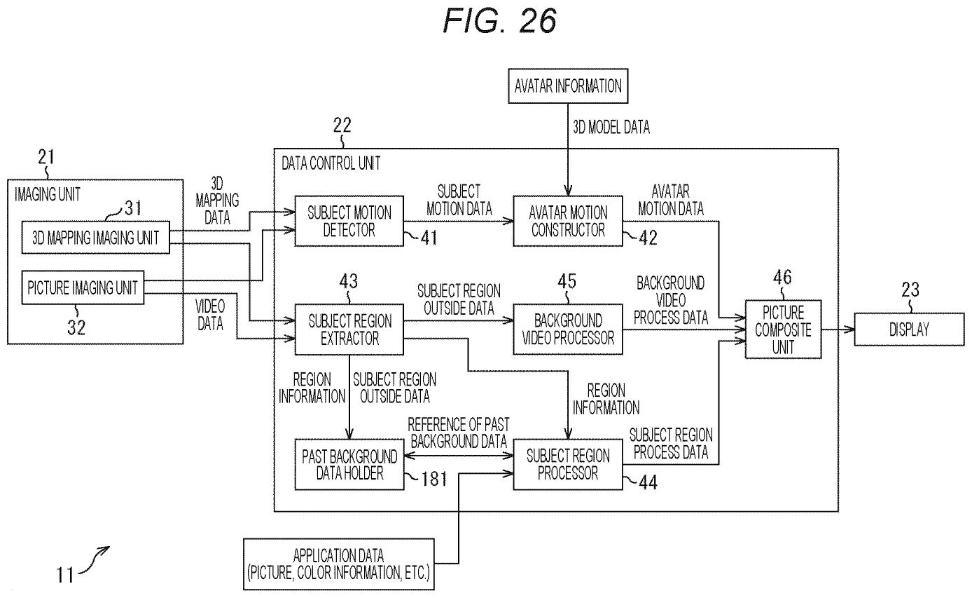

In a case where complementation is performed on the basis of the video of the background generated by using the past background video, the imaging system 11 has a configuration illustrated in FIG. 26, for example.

The configuration of the imaging system 11 illustrated in FIG. 26 is a configuration in which a past background data holder 181 is newly provided in the configuration of the imaging system 11 illustrated in FIG. 3.

In this example, the subject region extractor 43 generates region information indicating a region of the target subject on the captured video, supplies the region information and the subject region outside data to the past background data holder 181, and supplies the region information to the subject region processor 44.

The past background data holder 181 holds the subject region outside data supplied from the subject region extractor 43 as past background data for the next and subsequent frames in association with the region information supplied from the subject region extractor 43.

The subject region processor 44 generates subject region process data on the basis of the region information supplied from the subject region extractor 43, the application data supplied from the outside, and the past background data held (recorded) in the past background data holder 181.

### <Description of Composite Video Generation Processing>

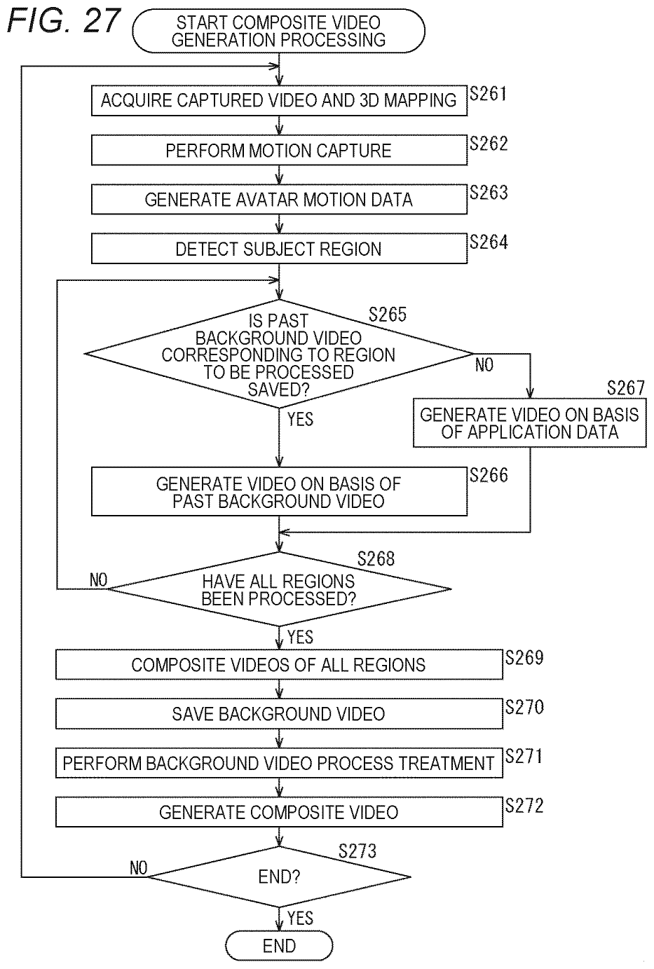

Next, the composite video generation processing performed by the imaging system 11 illustrated in FIG. 26 will be described with reference to a flowchart in FIG. 27.

Note that the processing of step S261 to step S264 is similar to the processing of step S11 to step S14 in FIG. 5, and thus the description thereof will be omitted.

In step S264, however, the subject region extractor 43 generates region information indicating a region of the target subject on the captured video, supplies the region information and the subject region outside data to the past background data holder 181, and supplies the region information to the subject region processor 44.

In step S265, the subject region processor 44 determines whether or not the past background video corresponding to the region to be processed on the subject region is saved. In other words, it is determined whether or not the past frame of the captured video includes the video of the background corresponding to the region to be processed in the subject region of the current frame.

For example, the subject region processor 44 sets a partial region of the subject region indicated by the region information supplied from the subject region extractor 43 as a region to be processed.

Then, the subject region processor 44 determines whether or not there is past background data of the past background video including the region corresponding to the region to be processed by referring to the region information associated with one or all a plurality of pieces of past background data held (saved) in the past background data holder 181.

In a case where it is determined in step S265 that the corresponding past background video is saved, the subject region processor 44 reads the past background data including the region corresponding to the region to be processed from the past background data holder 181, and thereafter, the processing proceeds to step S266.

In step S266, the subject region processor 44 generates a video of a background on the basis of the read past background video. That is, the subject region processor 44 extracts a region corresponding to the region to be processed from the past background video based on the read past background data, and sets the extracted region as a part of the video of the background in the current frame to be processed.

On the other hand, in a case where it is determined in step S265 that the corresponding past background video is not saved, the subject region processor 44 generates the video of the background corresponding to the region to be processed on the basis of the application data supplied from the outside in step S267. In this case, for example, an arbitrary separate video of a single color, a predetermined pattern, or the like is the video of the background corresponding to the region to be processed.

In a case where the processing of step S266 or step S267 is performed, thereafter, the processing of step S268 is performed. In step S268, the subject region processor 44 determines whether or not all the region on the subject region indicated by the region information has been processed as the region to be processed.

In a case where it is determined in step S268 that all the region has not been processed yet, the processing returns to step S265, and the above processing is repeated.

On the other hand, in a case where it is determined in step S268 that all the region has been processed, the video of the background corresponding to the entire subject region has been obtained, and thus the processing proceeds to step S269.

In step S269, the subject region processor 44 arranges and composites the videos of the background generated for all the target region obtained by performing the above steps S266 and S267, and sets the video data of the video of the background obtained as a result as subject region process data. The subject region processor 44 supplies the obtained subject region process data to the picture composite unit 46.

For example, in a case where the processing of step S266 is performed on all the target region, the background video corresponding to the entire subject region is generated from one or a plurality of past background videos.

Furthermore, for example, in a case where the processing of step S266 and the processing of step S267 are performed, the background video corresponding to a partial region of the subject region is generated from one or a plurality of past background videos, and the background video corresponding to the remaining region is generated from the application data. In this embodiment, the target subject is transparentized by generating the subject region process data on the basis of the past background data and the application data.

In step S270, the past background data holder 181 saves (holds) the subject region outside data supplied from the subject region extractor 43 as the background video, that is, the past background data. At this time, the past background data holder 181 saves the region information supplied from the subject region extractor 43 and the past background data in association with each other. By performing the processing of step S270 for every frame of the captured video, the subject region outside data of a plurality of past frames is saved as the past background data.

When the processing of step S270 is performed, thereafter, the processing of steps S271 to S273 is performed and the composite video generation processing ends, but since the processing of these steps is similar to the processing of steps S16 to S18 in FIG. 5, the description thereof will be omitted.

As described above, the imaging system 11 saves the subject region outside data as the past background data, performs processing of transparentizing the target subject on the basis of the past background data, and generates a composite video. In this case, it is also possible to suppress the occurrence of appearance of the target subject more easily and reliably regardless of the imaging place.

### Eighth Embodiment

### <Configuration Example of Imaging System>

Description will be made of an example of determining a method (processing) of suppressing appearance of the target subject in accordance with the distance to the target subject in a case where extraction accuracy of the region of the target subject is deteriorated because the distance from the imaging unit 21 to the target subject is too far or too close.

By utilizing, for example, the 3D mapping data, the distance from the imaging unit 21 to the target subject can be obtained. Furthermore, there are cases where the target subject is far away and the target subject cannot be sufficiently recognized on the captured video, and where the target subject is too close to an extent that the entire target subject does not appear on the captured video and the target subject cannot be sufficiently recognized on the captured video.

The imaging system 11 has a function of making the target subject invisible on the composite video, and can switch (change) the function in accordance with the distance to the target subject. In other words, the data control unit 22 can perform different types of the transparency processing in accordance with the distance from the imaging unit 21 (imaging position) to the target subject.

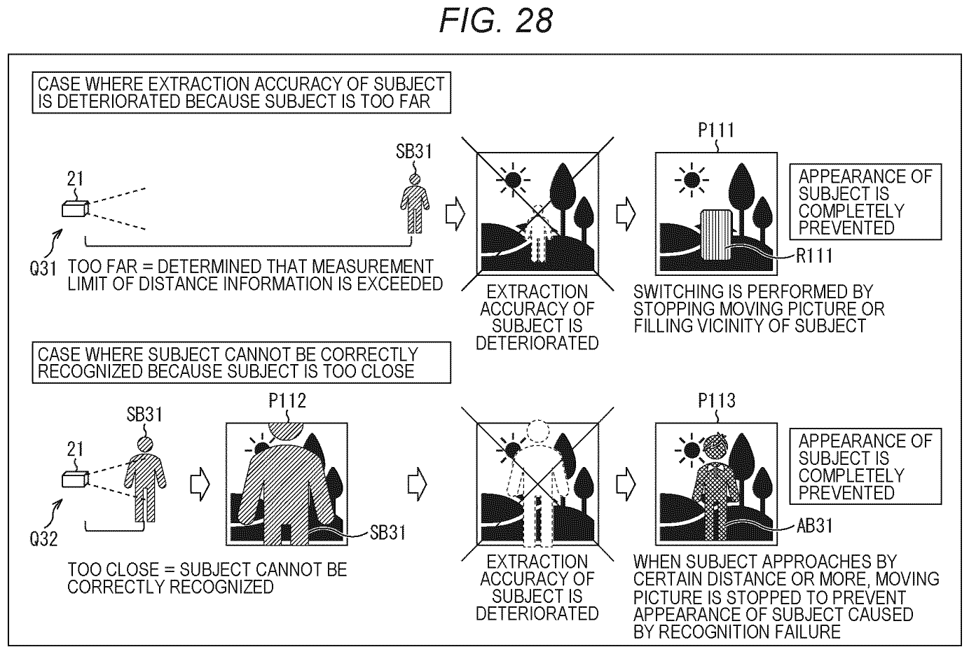

Specifically, for example, as indicated by an arrow Q31 in FIG. 28, in a case where the distance from the imaging unit 21 to the target subject SB31 is long, the extraction accuracy of the target subject SB31 from the captured video decreases.

Therefore, for example, in a case where the distance to the target subject SB31 is larger than a predetermined threshold value thmax, it is determined that the distance to the target subject SB31 is too far, that is, exceeds a measurement limit of the distance. Then, for example, a composite video P111 in which a region R111 including the target subject SB31 is replaced with a single-color video (filled video) based on the application data or the like is generated. In this example, the avatar AB31 is not displayed in the composite video P111.

In this way, when the region R111 including the target subject SB31 is replaced with a single-color video or the like, the target subject SB31 can be transparentized, and the appearance of target subject SB31 can be reliably prevented.

Note that, in addition to the replacement with a single-color video or the like, the composite video without the appearance of the target subject SB31 displayed at the present time may be kept displayed, that is, the playback of the composite video may be temporarily stopped. In this case, the appearance of the target subject SB31 can be also reliably prevented.

Furthermore, for example, as indicated by an arrow Q32, in a case where the distance from the imaging unit 21 to the target subject SB31 is too short, since only a part of the target subject SB31 appears on the captured video P112, there is a possibility that the region of the target subject SB31 cannot be correctly recognized on the captured video P112. That is, the extraction accuracy of the target subject SB31 from the captured video P112 decreases.

Therefore, for example, in a case where the distance to the target subject SB31 is less than a predetermined threshold value thmin, the composite video P113 without the appearance of the target subject SB31, which is displayed at the present time, is kept displayed. That is, the playback of the composite video P113 is temporarily stopped.

In this way, when the target subject SB31 approaches the imaging unit 21 by a certain distance or more, the playback of the composite video P113 is stopped, so that it is possible to reliably prevent the appearance of the target subject SB31 caused by a recognition failure of the target subject SB31, that is, a decrease in the recognition accuracy. In other words, the target subject SB31 can be kept transparent.

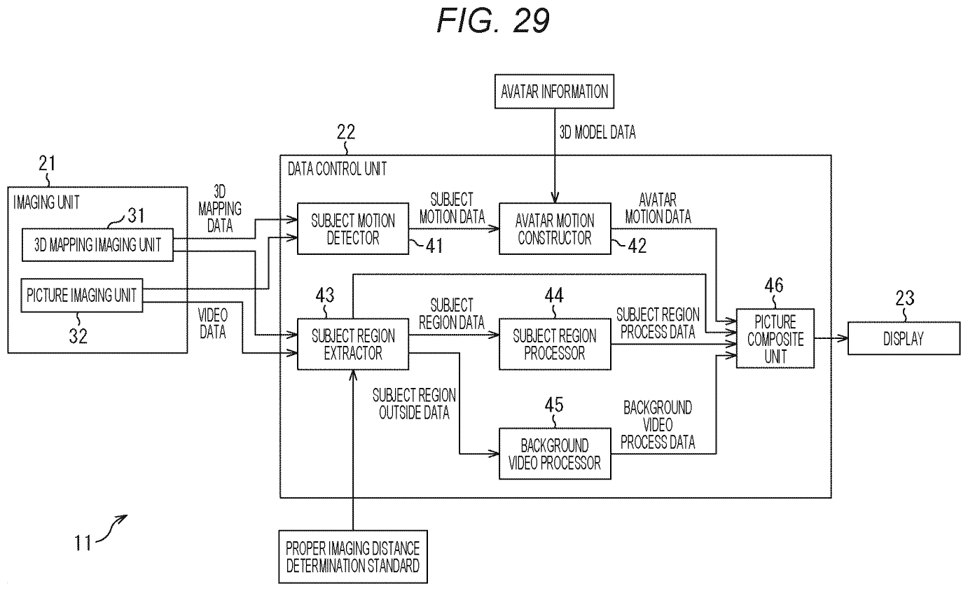

In a case where the processing is switched in accordance with the distance to the target subject, the imaging system 11 has a configuration illustrated in FIG. 29, for example.

The configuration of the imaging system 11 illustrated in FIG. 29 is the same as the configuration of the imaging system 11 illustrated in FIG. 3, but in the example in FIG. 29, a proper imaging distance determination standard is supplied from the outside to the subject region extractor 43.

The proper imaging distance determination standard is used to determine whether or not the distance from the imaging unit 21 to the target subject is within an appropriate range (hereinafter, also referred to as a proper range). Specifically, for example, the proper imaging distance determination standard is a distance indicating an upper limit and a lower limit of the proper range, that is, information indicating the threshold value thmax and the threshold value thmin described above, a subject recognition accuracy criterion, or the like.

The subject region extractor 43 determines whether or not the distance to the target subject is within the proper range on the basis of the proper imaging distance determination standard and the 3D mapping data, and causes each unit of the data control unit 22 to execute processing according to the determination result.

### <Description of Composite Video Generation Processing>

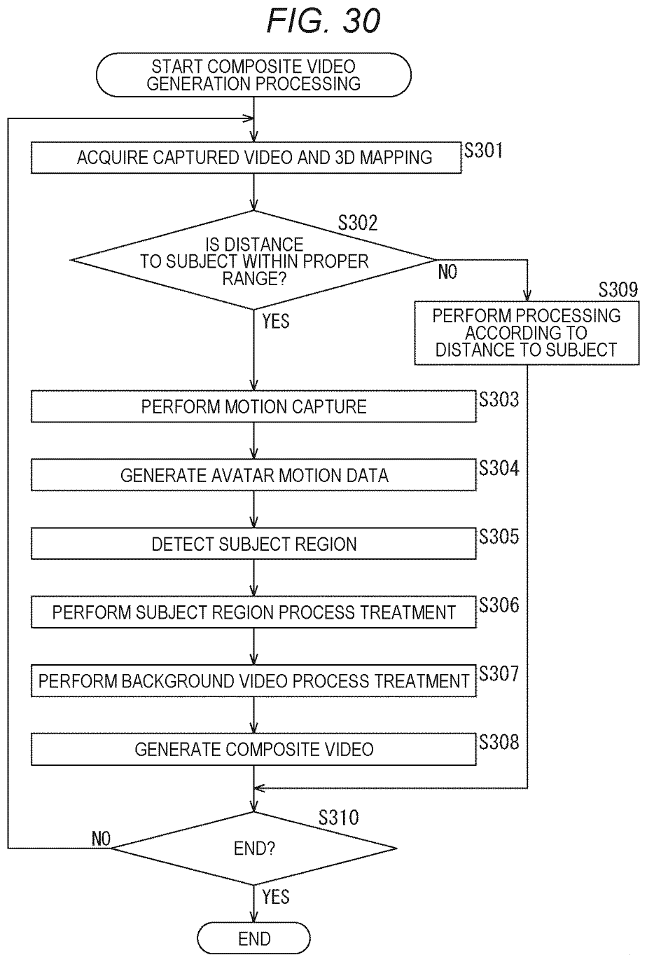

Next, the composite video generation processing performed by the imaging system 11 illustrated in FIG. 29 will be described with reference to a flowchart in FIG. 30.

Note that the processing of step S301 is similar to the thereof will be omitted.

In step S302, the subject region extractor 43 determines whether or not the distance from the imaging unit 21 to the target subject is within the proper range on the basis of the 3D mapping data supplied from the 3D mapping imaging unit 31 and the supplied proper imaging distance determination standard. That is, the subject region extractor 43 extracts the region of the target subject from the 3D mapping data by using the video data of the captured video as necessary, and obtains the distance from the imaging unit 21 to the target subject on the basis of the extraction result. Then, the subject region extractor 43 determines whether or not the obtained distance is a distance within the proper range indicated by the proper imaging distance determination standard.

In a case where it is determined in step S302 that the distance is within the proper range, thereafter, the processing of steps S303 to S308 is performed to generate the composite video, and then, the processing proceeds to step S310.

Note that the processing of steps S303 to S308 is similar to the processing of steps S12 to S17 in FIG. 5, and thus the description thereof will be omitted.

In this case, for example, in step S306, similarly to step S165 in FIG. 19, the subject region process data is generated on the basis of the subject region data and the application data supplied from the outside, and the target subject is transparentized. Note that, in this embodiment, the target subject may be transparentized by any method such as the method described in any embodiment described above or any method described later, not limited to the example of using the application data.

Furthermore, in a case where it is determined in step S302 that the distance is not within the proper range, the data control unit 22 performs processing according to the distance to the target subject in step S309.

Specifically, for example, in a case where the distance to the target subject is larger than the distance within the proper range, the subject region extractor 43 performs processing similar to the processing of step S305, and the background video processor 45 performs processing similar to the processing of step S307. In addition, the subject region processor 44 generates, as subject region process data, video data of a single-color region that covers (includes) the entire region of the target subject as the subject region process treatment.

Then, in response to an instruction from the subject region extractor 43, the picture composite unit 46 composites the background video process data and the subject region process data of the single-color region to obtain a composite video. In this case, for example, a composite video similar to the composite video P111 illustrated in FIG. 28 is obtained.

Furthermore, for example, in a case where the distance to the target subject is less than a distance within the proper range, the subject region extractor 43 instructs the picture composite unit 46 to temporarily stop the generation of a composite video, that is, temporarily stop the supply of a composite video to the display 23. Then, the picture composite unit 46 stops the supply (playback) of the composite video in response to the instruction of the subject region extractor 43. Therefore, for example, the display of the composite video is not updated, and the frame of the most recently displayed composite video remains displayed on the display 23.

Such processing of step S309 reliably suppresses the occurrence of appearance of the target subject.

When the processing of step S308 is performed or the processing of step S309 is performed, thereafter, the processing of step S310 is performed and the composite video generation processing ends, but since the processing of step S310 is similar to the processing of step S18 in FIG. 5, the description thereof will be omitted.

In this case, for example, after the processing of step S309 is performed once, when it is determined in step S302 that the distance to the target subject is within the proper range, thereafter, the composite video on which an avatar is displayed is appropriately updated.

As described above, the imaging system 11 generates the composite video while switching the processing to be executed in accordance with the distance to the target subject. In this case, it is also possible to suppress the occurrence of appearance of the target subject more easily and reliably regardless of the imaging place.

### Ninth Embodiment

### <Configuration Example of Imaging System>

An example of imaging a captured video, that is, generating (recording) a composite video or transmitting (broadcasting) a composite video will be described only in a case where both the motion capture processing and the transparency processing are successful for the target subject on the captured video.

For example, in a case where the composite video is broadcasted (relayed) as a content in real time or the composite video is recorded as a content, the imaging system 11 may have a function of recognizing the target subject and broadcasting and recording the content only in a state where both the motion capture processing and the transparency processing are successful. In other words, the imaging system 11 may have a function of changing whether or not to image the composite video in accordance with whether or not to perform picture processing on the target subject, such as motion capture or transparency processing.

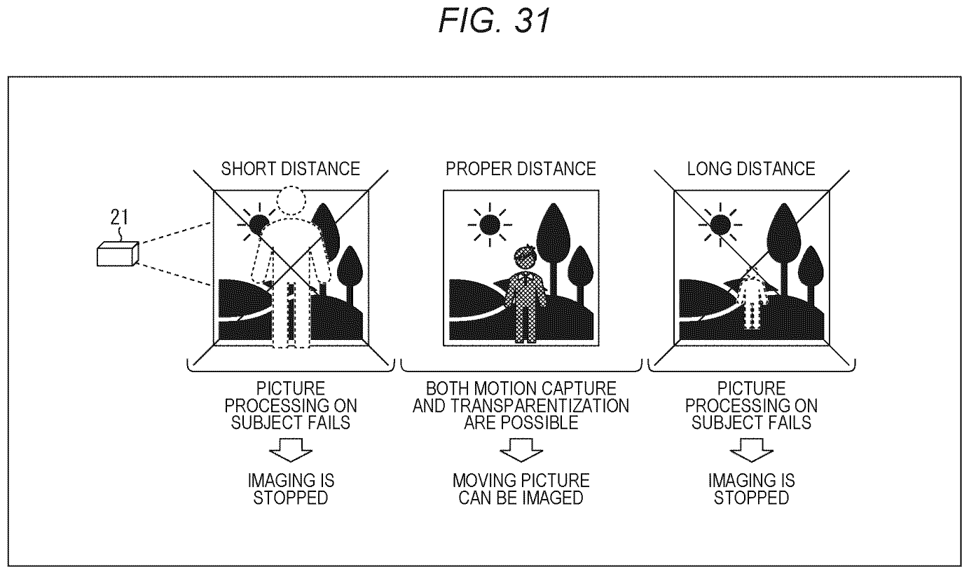

In such a case, for example, as illustrated on the left side in the drawing of FIG. 31, since the distance from the imaging unit 21 to the target subject is short, when any of the picture processing on the target subject, that is, the motion capture or the transparency processing fails, the imaging is temporarily stopped. That is, broadcasting (transmission) and recording (video recording) of the composite video are temporarily stopped.

Similarly, as illustrated on the right side in the drawing, since the distance from the imaging unit 21 to the target subject is long, when picture processing on the target subject fails, imaging is temporarily stopped.

On the other hand, as illustrated in the center of the drawing, since the distance from the imaging unit 21 to the target subject is a proper distance, when picture processing on the target subject, that is, both motion capture and transparency processing can be correctly performed, imaging is continuously performed. That is, broadcasting (transmission) and recording (video recording) of the composite video are continuously performed.

As described above, when the motion capture or the transparency processing cannot be performed because the distance to the target subject is not appropriate, it is possible to more reliably suppress appearance of the target subject by temporarily stopping the imaging.

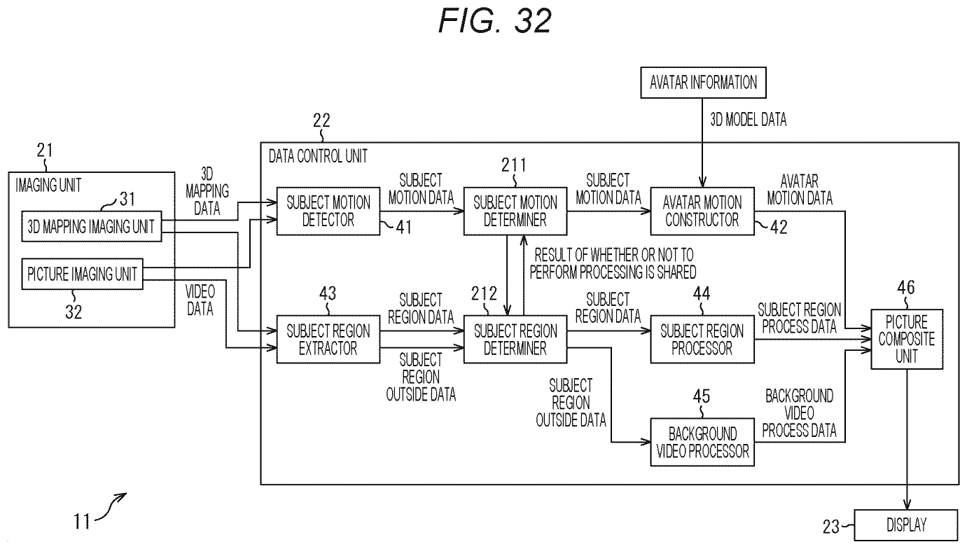

In a case where imaging is continued or stopped depending on whether or not the motion capture or transparency processing has succeeded, the imaging system 11 has a configuration illustrated in FIG. 32, for example.

The configuration of the imaging system 11 illustrated in FIG. 32 is a configuration in which a subject motion determiner 211 and a subject region determiner 212 are newly provided in the configuration of the imaging system 11 illustrated in FIG. 3.

The subject motion determiner 211 determines whether or not motion capture has succeeded on the basis of the subject motion data supplied from the subject motion detector 41, and supplies the determination result to the subject region determiner 212.

For example, the subject motion determiner 211 determines whether or not motion capture has been correctly performed in the current frame, that is, whether or not the motion capture has succeeded, on the basis of the subject motion data for the last several frames, the detection result of the target subject from the captured video or the 3D mapping data supplied from the subject motion detector 41 as appropriate, and the like.

The subject region determiner 212 determines whether or not transparentization of the target subject is successful on the basis of the subject region data and the subject region outside data supplied from the subject region extractor 43, and supplies the determination result to the subject motion determiner 211.

For example, the subject region determiner 212 determines whether or not the transparency processing has been correctly performed in the current frame, that is, whether or not the transparency processing has succeeded, on the basis of the subject region data and the subject region outside data for the last several frames, and the detection result of the target subject from the captured video and the 3D mapping data supplied from the subject region extractor 43 as appropriate. In this case, in a case where the target subject can be correctly extracted (detected) from the captured video or the like, it is determined that the transparency processing has succeeded, specifically, the transparency processing to be performed can be correctly performed.

The subject motion determiner 211 and the subject region determiner 212 share the determination results, and data is output to the subsequent stage in accordance with the determination results.

In other words, in a case where a determination result indicating that both the motion capture and the transparency processing are successful is obtained, the subject motion determiner 211 supplies the subject motion data to the avatar motion constructor 42. Similarly, in a case where a determination result indicating that both the motion capture and the transparency processing are successful is obtained, the subject region determiner 212 supplies the subject region data to the subject region processor 44 and supplies the subject region outside data to the background video processor 45.

### <Description of Determination Processing>

Next, the motion of the imaging system 11 illustrated in FIG. 32 will be described.

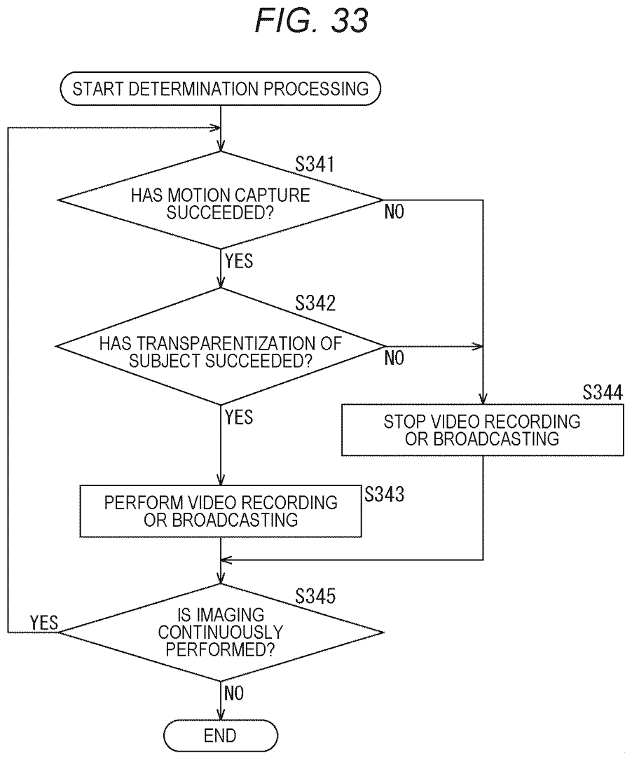

The imaging system 11 illustrated in FIG. 32 basically continues the composite video generation processing described with reference to FIG. 5 and also performs determination processing illustrated in FIG. 33. In particular, the imaging system 11 temporarily stops the composite video generation processing or restarts the composite video generation processing in accordance with the determination result in the determination processing.

Hereinafter, the determination processing performed by the imaging system 11 illustrated in FIG. 32 will be described with reference to a flowchart in FIG. 33.

In step S341, the subject motion determiner 211 determines whether or not motion capture has succeeded on the basis of the subject motion data supplied from the subject motion detector 41, and supplies the determination to the subject region determiner 212.

In a case where it is determined in step S341 that the motion capture has succeeded, thereafter, the processing proceeds to step S342.

In step S342, the subject region determiner 212 determines whether or not transparentization of the target subject is successful on the basis of the subject region data and the subject region outside data supplied from the subject region extractor 43, and supplies the determination to the subject motion determiner 211.

In a case where it is determined in step S342 that the transparentization of the target subject has succeeded, thereafter, the processing proceeds to step S343.

In step S343, the data control unit 22 performs video recording or broadcasting of the composite video.

That is, the subject motion determiner 211 supplies the subject motion data supplied from the subject motion detector 41 to the avatar motion constructor 42. In addition, the subject region determiner 212 supplies the subject region data to the subject region processor 44, and supplies the subject region outside data to the background video processor 45.

As a result, thereafter, the processing of step S13 and steps S15 to S18 of the composite video generation processing described with reference to FIG. 5 is performed. In this case, the picture composite unit 46 supplies the generated composite video to the display 23 to display the composite video, supplies the video data of the composite video to a recorder (not illustrated) to perform recording (video recording) of the composite video, and supplies the composite video to a communication unit (not illustrated) to transmit (broadcast) the composite video to an external device.

When the processing of step S343 is executed, thereafter, the processing proceeds to step S345.

Furthermore, in a case where it is determined in step S341 that the motion capture has not succeeded, that is, the motion capture has failed, or in a case where it is determined in step S342 that the transparentization of the target subject has not succeeded, that is, the transparentization has failed, the processing of step S344 is performed.

In step S344, the data control unit 22 temporarily stops video recording or broadcasting of the composite video.

That is, the subject motion determiner 211 temporarily stops the supply of the subject motion data supplied from the subject motion detector 41 to the avatar motion constructor 42. In addition, the subject region determiner 212 temporarily stops the supply of the subject region data to the subject region processor 44 and the supply of the subject region outside data to the background video processor 45.

As a result, the processing of step S13 and steps S15 to S18 of the composite video generation processing described with reference to FIG. 5 is temporarily not performed, and as a result, the update of the display of the composite video and the recording (video recording) and transmission (broadcasting) of the composite video are temporarily stopped.

Note that, in a case where at least one of motion capture or transparentization of the target subject fails, in step S344, generation and display of the composite video are performed, but video recording and broadcasting of the composite video may not be performed (may be temporarily stopped).

When the processing of step S343 is performed or the processing of step S344 is performed, in step S345, the data control unit 22 determines whether or not imaging is continuously performed. For example, in a case where it is determined in step S18 in FIG. 5 that the processing is to be ended, it is determined that the imaging is to be ended.

In a case where it is determined in step S345 to continuously perform imaging, thereafter, the processing then returns to step S341, and the processing described above is repeatedly performed.

Therefore, for example, when the processing of step S344 is performed immediately after imaging is started, video recording and broadcasting are disabled, and thus video recording and broadcasting of the composite video are not started. Thereafter, when it is determined in step S342 that transparentization has succeeded, video recording and broadcasting of the composite video are started. Similarly, for example, when the processing of step S344 is performed after the video recording and broadcasting of the composite video are started, the video recording and broadcasting are temporarily stopped in the middle of the video recording and broadcasting, and thereafter, when it is determined that the transparentization is successful in step S342, the video recording and broadcasting of the composite video is resumed.

Furthermore, in a case where it is determined in step S345 that imaging is not continuously performed, that is, imaging is to be ended, each unit of the data control unit 22 stops the ongoing processing, and the determination processing ends.

As described above, the imaging system 11 appropriately performs video recording and broadcasting of the composite video in accordance with whether or not the motion capture and the transparency processing have succeeded. In such a manner, the occurrence of appearance of the target subject can be further suppressed.

### Tenth Embodiment

### <Configuration Example of Imaging System>

An example will be described in which motion capture can be correctly performed even in a case where only a part of the target subject appears in the captured video.

For example, if 3D mapping imaging is performed for a range wider than the range (angle of view) at the time of imaging of the captured video, that is, at a wider angle, the region of the target subject can be accurately extracted even in a case of short-distance imaging in which the entire body of the target subject does not appear in the captured video, or in a case where the target subject moves back and forth inside and outside an imaging range of the captured video. As a result, it is possible to suppress a decrease in accuracy of the motion capture.

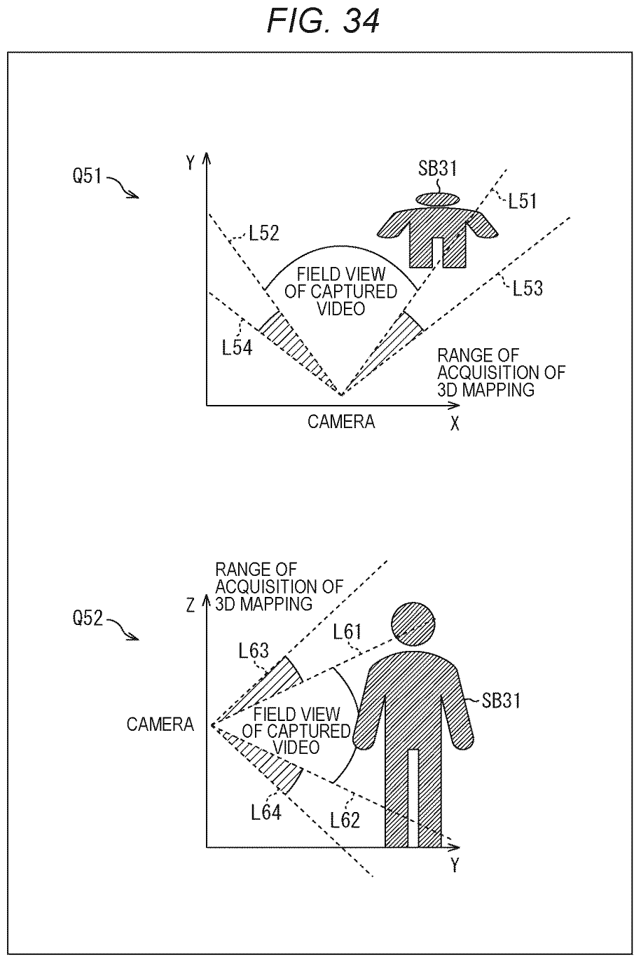

In such a case, for example, as illustrated in FIG. 34, imaging visual fields of the 3D mapping imaging unit 31 and the picture imaging unit 32, that is, the range of the region to be imaged is made different.

In FIG. 34, a portion indicated by an arrow Q51 illustrates a horizontal imaging visual field of the 3D mapping imaging unit 31 and the picture imaging unit 32, that is, a range of a region to be imaged. In particular, a transverse direction (X direction) and a lateral direction (Y direction) in the portion indicated by the arrow Q51 indicate the transverse direction (horizontal direction) and a depth direction when the direction of the target subject SB31 is viewed from the imaging unit 21.

Specifically, a region between a straight line L51 and a straight line L52 is the picture imaging unit 32, that is, the range of the imaging visual field of the captured video, and a region between a straight line L53 and a straight line L54 is the 3D mapping imaging unit 31, that is, the range of the imaging visual field of the 3D mapping. That is, the range of the imaging visual field of the 3D mapping includes the entire range of the imaging visual field of the captured video, and the 3D mapping imaging unit 31 can perform imaging at a wider angle in the horizontal direction than the picture imaging unit 32.

In this example, a part of the target subject SB31 is out of the range of the imaging visual field of the captured video. However, since the entire target subject SB31 is included in the range of the imaging visual field of the 3D mapping, the region of the target subject SB31 can be correctly specified (extracted) by using the 3D mapping data.

Therefore, for example, even at a moment when a part of the target subject SB31 is out of the range of the imaging visual field of the captured video, motion capture can be performed by using the 3D mapping data.

In addition, a portion indicated by an arrow Q52 illustrates an imaging visual field in a perpendicular direction of the 3D mapping imaging unit 31 and the picture imaging unit 32, that is, a range of a region to be imaged. In particular, a transverse direction (Y direction) and a lateral direction (Z direction) in the portion indicated by the arrow Q52 indicate a depth direction and the perpendicular direction (vertical direction) when the direction of the target subject SB31 is viewed from the imaging unit 21.

Specifically, a region between a straight line L61 and a straight line L62 is the range of the imaging visual field of the captured video, and a region between a straight line L63 and a straight line L64 is the range of the imaging visual field of the 3D mapping. That is, the range of the imaging visual field of the 3D mapping includes the entire range of the imaging visual field of the captured video, and the 3D mapping imaging unit 31 can perform imaging at a wider angle in the perpendicular direction than the picture imaging unit 32.

In this example, a part of the target subject SB31 is out of the range of the imaging visual field of the captured video. However, since the entire target subject SB31 is included in the range of the imaging visual field of the 3D mapping, the region of the target subject SB31 can be correctly specified (extracted) by using the 3D mapping data.

Therefore, for example, even in a case where the entire target subject SB31 does not appear in the captured video because the target subject SB31 is at a position too close to the imaging unit 21, motion capture can be performed by using the 3D mapping data.

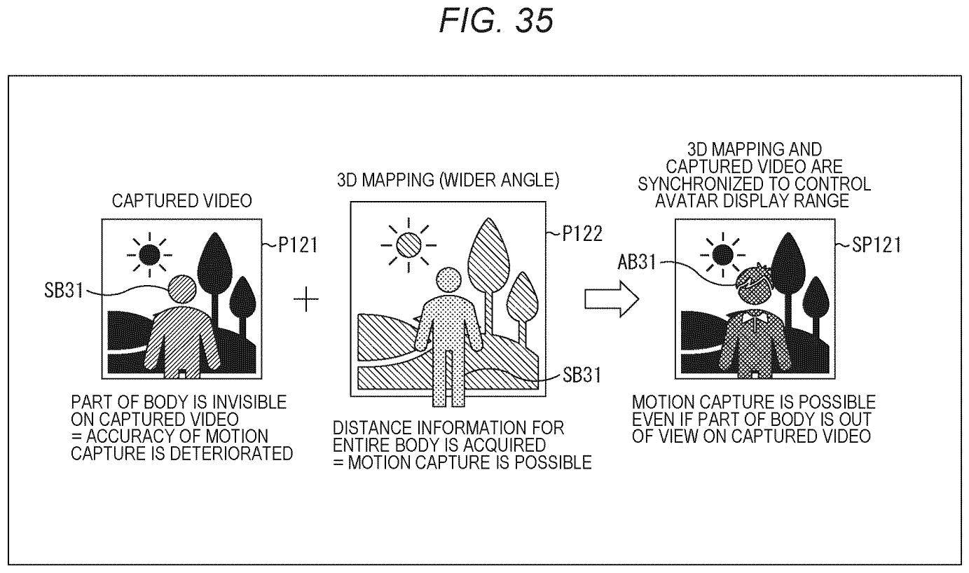

For example, as illustrated in FIG. 35, in a state where a part of the body of the target subject SB31 is out of view (not seen) on a captured video P121, the accuracy of motion capture decreases when only the captured video P121 is used.

However, even in such a case, if the entire body of the target subject SB31 appears on a 3D mapping P122, motion capture can be performed with high accuracy by using the 3D mapping P122. Therefore, a composite video SP121 in which the target subject SB31 does not appear can be obtained.

In this case, the captured video P121 and the 3D mapping P122 are synchronized with each other. That is, the correspondence relationship between the regions of the target subject SB31 on the captured video P121 and the 3D mapping P122 is specified. Then, a display range of the avatar AB31 on the composite video SP121 is determined (controlled) in accordance with the specification result. In this example, similarly to the target subject SB31 on the captured video P121, a part of the avatar AB31 is out of view on the composite video SP121.

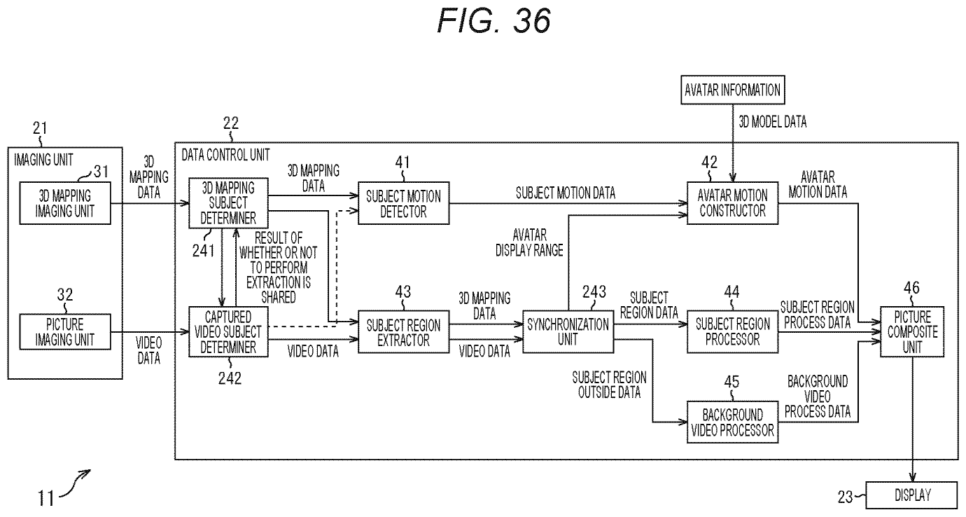

In a case where the 3D mapping is imaged at a wider angle than the captured video, the imaging system 11 has a configuration illustrated in FIG. 36, for example.

The configuration of an imaging system 11 illustrated in FIG. 36 is a configuration in which a 3D mapping subject determiner 241, a captured video subject determiner 242, and a synchronization unit 243 are newly provided in the configuration of the imaging system 11 illustrated in FIG. 3.

Furthermore, in this example, the range of the imaging visual field of the 3D mapping imaging unit 31 (3D mapping) is a wider range including the imaging visual field of the picture imaging unit 32 (captured video). In other words, a viewing angle of the 3D mapping imaging unit 31 is larger than a viewing angle of the picture imaging unit 32.

The 3D mapping subject determiner 241 determines whether or not the region of the target subject can be extracted from the 3D mapping data supplied from the 3D mapping imaging unit 31, that is, whether or not the region of the target subject can be extracted, and supplies the determination result to the captured video subject determiner 242.

Furthermore, the 3D mapping subject determiner 241 supplies the 3D mapping data supplied from the 3D mapping imaging unit 31 to the subject motion detector 41 and the subject region extractor 43 in accordance with the determination result of whether or not the region of the target subject can be extracted or the like.

The captured video subject determiner 242 determines whether or not the region of the target subject can be extracted from the video data of the captured video supplied from the picture imaging unit 32, that is, whether or not the region of the target subject can be extracted, and supplies the determination result to the 3D mapping subject determiner 241.

Furthermore, the captured video subject determiner 242 supplies the video data of the captured video supplied from the picture imaging unit 32 to the subject motion detector 41 and the subject region extractor 43 in accordance with the determination result of whether or not the region of the target subject can be extracted or the like.

The synchronization unit 243 generates avatar display range information, subject region data, and subject region outside data on the basis of the detection result (extraction result) of the target subject supplied from the subject region extractor 43, the video data of the captured video, and the 3D mapping data.

The synchronization unit 243 supplies the avatar display range information, the subject region data, and the subject region outside data to the avatar motion constructor 42, the subject region processor 44, and the background video processor 45, respectively. The avatar display range information is information indicating the display range of the avatar in a case where only a part of the entire body of the avatar is displayed in the composite video.

### <Description of Composite Video Generation Processing>

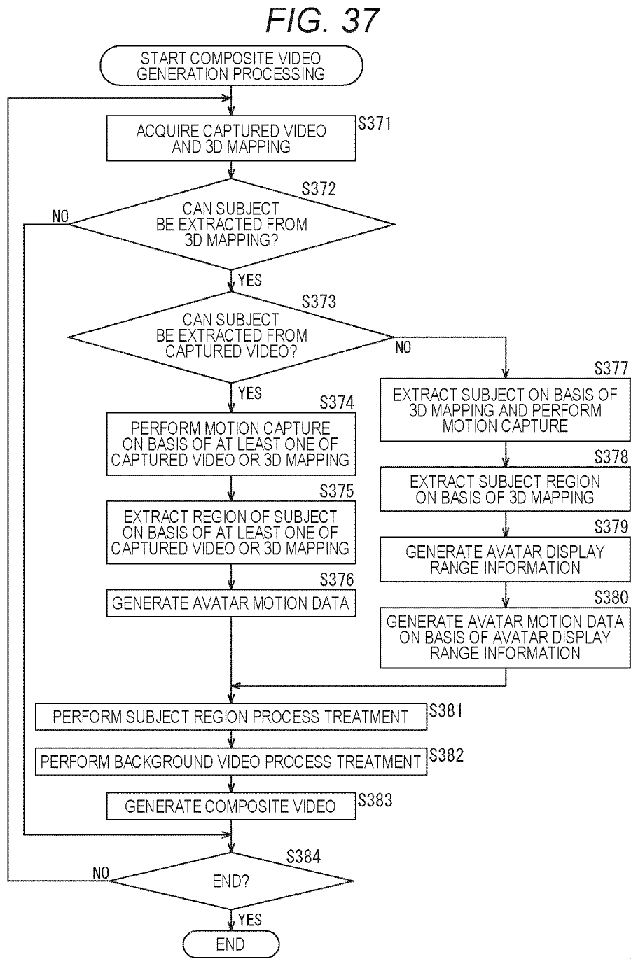

Next, the composite video generation processing performed by the imaging system 11 illustrated in FIG. 36 will be described with reference to a flowchart in FIG. 37.

Note that the processing in step S371 is similar to the thereof will be omitted. However, in this example, the 3D mapping imaging unit 31 supplies the 3D mapping data to the 3D mapping subject determiner 241, and the picture imaging unit 32 supplies the video data of the captured video to the captured video subject determiner 242.

In step S372, the 3D mapping subject determiner 241 determines whether or not the region of the target subject can be extracted from the 3D mapping on the basis of the 3D mapping data supplied from the 3D mapping imaging unit 31, and supplies the determination result to the captured video subject determiner 242.

For example, the 3D mapping subject determiner 241 detects the target subject from the 3D mapping to determine whether or not the region of the target subject can be extracted.

At this time, for example, in a case where the target subject is out of view on the 3D mapping, that is, in a case where a part of the target subject is outside the imaging visual field (3D mapping), or in a case where the target subject cannot be detected from the 3D mapping, it is determined that the region of the target subject cannot be extracted.

In a case where it is determined in step S372 that extraction is not possible, motion capture cannot be performed, and thereafter, the processing proceeds to step S384. In this case, for example, the display of the composite video is not updated, and the frame of the most recently displayed composite video remains displayed on the display 23.

On the other hand, in a case where it is determined in step S372 that the region of the target subject can be extracted, the processing of step S373 is performed.

In step S373, the captured video subject determiner 242 determines whether or not the region of the target subject can be extracted from the captured video on the basis of the video data of the captured video supplied from the picture imaging unit 32, and supplies the determination result to the 3D mapping subject determiner 241.

For example, the captured video subject determiner 242 detects the target subject from the captured video to determine whether or not the region of the target subject can be extracted.

At this time, for example, in a case where the target subject is out of view on the captured video, that is, in a case where a part of the target subject is outside the imaging visual field (captured video), or in a case where the target subject cannot be detected from the captured video, it is determined that the region of the target subject cannot be extracted.

In a case where it is determined in step S373 that the region of the target subject can be extracted, the processing proceeds to step S374.

At this time, the 3D mapping subject determiner 241 supplies the 3D mapping data supplied from the 3D mapping imaging unit 31 to the subject motion detector 41 and the subject region extractor 43. Furthermore, the captured video subject determiner 242 supplies the video data of the captured video supplied from the picture imaging unit 32 to the subject motion detector 41 and the subject region extractor 43.

In step S374, the subject motion detector 41 performs motion capture on the basis of at least one of the video data of the captured video supplied from the captured video subject determiner 242 or the 3D mapping data supplied from the 3D mapping subject determiner 241, and supplies the subject motion data obtained as a result to the avatar motion constructor 42.

In step S375, the subject region extractor 43 extracts the region of the target subject from the captured video on the basis of at least one of the video data of the captured video supplied from the captured video subject determiner 242 or the 3D mapping data supplied from the 3D mapping subject determiner 241. The subject region extractor 43 supplies the extraction result of the region of the target subject, the video data of the captured video, and the 3D mapping data to the synchronization unit 243.

The synchronization unit 243 generates subject region data, and subject region outside data on the basis of the extraction result supplied from the subject region extractor 43, the video data of the captured video, and the 3D mapping data similarly to step S14 in FIG. 5. In addition, the synchronization unit 243 supplies the subject region data to the subject region processor 44, and supplies the subject region outside data to the background video processor 45.

In step S376, the avatar motion constructor 42 generates avatar motion data on the basis of the subject motion data supplied from the subject motion detector 41 and the avatar information supplied from the outside, and supplies the avatar motion data to the picture composite unit 46. In this case, since the entire target subject is included in the captured video, the avatar display range information is unnecessary for generating the avatar motion data.

When the processing of step S376 is executed, thereafter, the processing proceeds to step S381.

In addition, in a case where it is determined in step S373 that the region of the target subject cannot be extracted, the processing proceeds to step S377.

At this time, the 3D mapping subject determiner 241 supplies the 3D mapping data supplied from the 3D mapping imaging unit 31 to the subject motion detector 41 and the subject region extractor 43. Furthermore, the captured video subject determiner 242 supplies the video data of the captured video supplied from the picture imaging unit 32 to only the subject region extractor 43.

In step S377, the subject motion detector 41 extracts the region of the target subject on the basis of only the 3D mapping data supplied from the 3D mapping subject determiner 241, performs motion capture on the extraction result, and supplies the subject motion data obtained as a result of the motion capture to the avatar motion constructor 42.

In step S378, the subject region extractor 43 extracts the region of the target subject on the basis of only the 3D mapping data supplied from the 3D mapping subject determiner 241, and supplies the extraction result, the video data of the captured video, and the 3D mapping data to the synchronization unit 243.

In step S379, the synchronization unit 243 generates avatar display range information on the basis of the extraction result supplied from the subject region extractor 43, the video data of the captured video, and the 3D mapping data, and supplies the avatar display range information to the avatar motion constructor 42.

For example, the synchronization unit 243 specifies a region of the target subject on the captured video from the extraction result of the target subject from the 3D mapping and the relationship between the known captured video and the range of the imaging visual field of the 3D mapping, and generates avatar display range information on the basis of the specification result.

At this time, for example, the display range of the avatar indicated by the avatar display range information is the range of the region of the target subject displayed on the captured video. Specifically, for example, when only an upper body of a person as the target subject appears on the captured video, the upper body of the avatar is set as the display range of the avatar.

In addition, the synchronization unit 243 generates subject region data and subject region outside data on the basis of the specification result of the target subject on the captured video, supplies the subject region data to the subject region processor 44, and supplies the subject region outside data to the background video processor 45.

In step S380, the avatar motion constructor 42 generates avatar motion data on the basis of the subject motion data supplied from the subject motion detector 41, the avatar information supplied from the outside, and the avatar display range information supplied from the synchronization unit 243, and supplies the avatar motion data to the picture composite unit 46. At this time, for example, the avatar motion data in which only a portion of the display range indicated by the avatar display range information of the entire avatar is displayed is generated.

When the processing of step S376 or step S380 is performed, thereafter, the processing of steps S381 to S384 is performed and the composite video generation processing ends, but since the processing of these steps is similar to the processing of steps S15 to S18 in FIG. 5, the description thereof will be omitted.

In this case, for example, in step S381, similarly to step S165 in FIG. 19, the subject region process data is generated on the basis of the subject region data and the application data supplied from the outside, and the target subject is transparentized. Note that, in this embodiment, the target subject may be transparentized by any method such as the method described in any embodiment described above, not limited to the example of using the application data.

As described above, the imaging system 11 determines whether or not the target subject can be extracted from the captured video and the 3D mapping, generates a composite video in accordance with the determination result. In particular, the imaging system 11 can perform motion capture with high accuracy by utilizing the 3D mapping data. Furthermore, it is also possible to suppress the occurrence of appearance of the target subject more easily and reliably regardless of the imaging place.

### Eleventh Embodiment

### <Configuration Example of Imaging System>

An example will be described in which, in a case where there is a portion overlapping the target subject in another object near the target subject, a front-back positional relationship between the target subject and the another object is reflected on an avatar or the like to be superimposed.

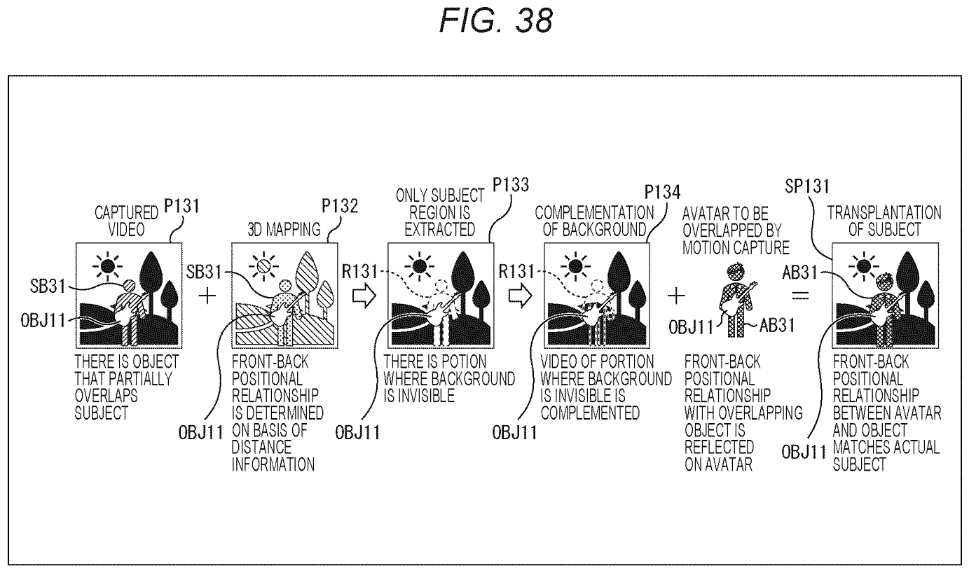

For example, as illustrated in FIG. 38, it is assumed that the imaging unit 21 images a captured video P131 including the target subject SB31. In this example, on the captured video P131, the guitar in which a partial region overlaps the target subject SB31 appears as another object OBJ11, that is, another subject. Note that, hereinafter, an object overlapping the target subject is also referred to as an overlapping object.

In addition, it is also assumed that 3D mapping imaging unit 31 images 3D mapping P132 including the target subject SB31 and the object OBJ11.

Since the 3D mapping P132 is distance information indicating a distance to each subject, it is possible to easily specify a front-back positional relationship between the target subject SB31 and the object OBJ11 by using the 3D mapping P132. In this example, in particular, it is specified that the object OBJ11 is located on a front side (imaging unit 21 side) of the target subject SB31.

In the present embodiment, a composite video SP131 is generated on the basis of the front-back positional relationship between the target subject SB31 and the object OBJ11. That is, the target subject SB31 is transparentized and the avatar AB31 is composited on the basis of the front-back positional relationship.

Specifically, the region R131 of the target subject SB31 is extracted and deleted (removed) from the captured video P131, and video data of a video P133 of the background obtained as a result is set as background video process data. In this example, only the target subject SB31 is removed on the video P133, and the object OBJ11 overlapping the front side of the target subject SB31 remains without being removed.

In addition, the video data such as the background corresponding to the region R131 is generated as the subject region process data by an arbitrary method such as the method using the application data described above, and the subject region process data and the background video process data are composited to obtain a video P134 in which the background is complemented. The video P134 is a captured video in which the target subject SB31 is transparentized.

Furthermore, avatar motion data for displaying the avatar AB31 is also generated on the basis of the front-back positional relationship between the target subject SB31 and the object OBJ11. In particular, in this example, the avatar motion data is generated in which the region of a portion corresponding to the object OBJ11 overlapping the front side of the target subject SB31 in the region of the entire avatar AB31 is not displayed. That is, the front-back positional relationship between the target subject SB31 and the object OBJ11 is also reflected on the avatar AB31.

Then, when the avatar motion data of the avatar AB31 is composited with the video P134 thus obtained, the composite video SP131 without appearance of the target subject SB31 can be obtained.

Furthermore, on the composite video SP131, the front-back positional relationship of the avatar AB31 and the object OBJ11 matches the actual front-back positional relationship between the target subject SB31 and the object OBJ11 corresponding to the avatar AB31. In this way, by using the 3D mapping P132, it is possible to obtain the high-quality composite video SP131 in which the front-back positional relationship between the subjects is consistent.

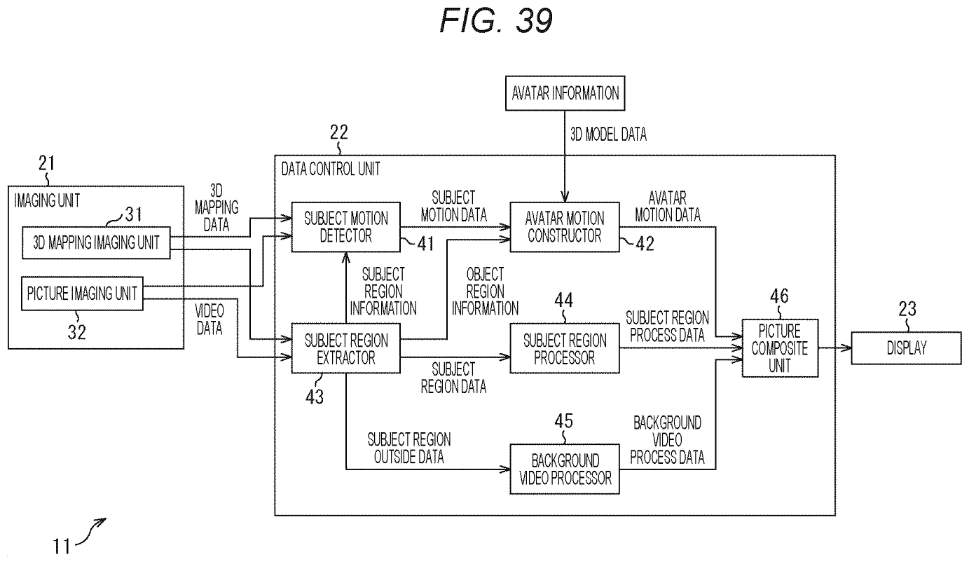

In a case where a composite video reflecting the front-back positional relationship between the target subject and the overlapping object is generated, the imaging system 11 has a configuration illustrated in FIG. 39, for example.

The configuration of the imaging system 11 illustrated in FIG. 39 is basically the same as the configuration of the imaging system 11 illustrated in FIG. 3, but is different from the example in FIG. 3 in that the subject region information and object region information are supplied from the subject region extractor 43 to the subject motion detector 41 and the avatar motion constructor 42.

That is, the subject region extractor 43 generates generation region information indicating the region of the target subject on the captured video, and supplies the subject region information to the subject motion detector 41. Furthermore, the subject region extractor 43 generates object region information indicating a region (position) in which the overlapping object is on the front side in the region in which the target subject and the overlapping object overlap each other on the captured video, and supplies the object region information to the avatar motion constructor 42.

### <Description of Composite Video Generation Processing>

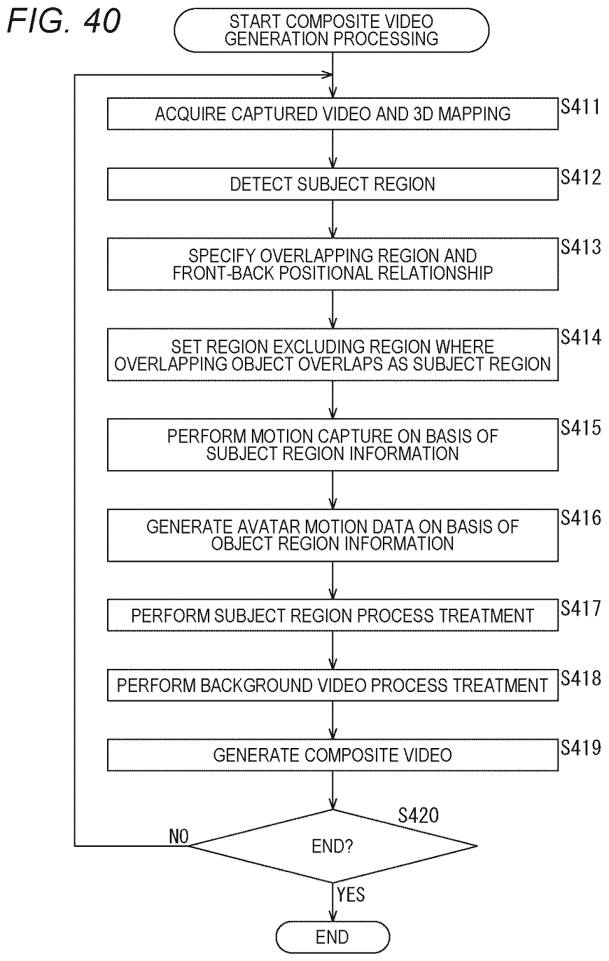

Next, the composite video generation processing performed by the imaging system 11 illustrated in FIG. 39 will be described with reference to a flowchart in FIG. 40.

Note that the processing in step S411 is similar to the processing of step S11 in FIG. 5, and thus the description thereof will be omitted.

In step S412, the subject region extractor 43 detects the subject region on the basis of the 3D mapping data supplied from the 3D mapping imaging unit 31 and the video data supplied from the picture imaging unit 32. Here, for example, a region inside the contour of the target subject on the captured video is detected as the region of the target subject. That is, a region surrounded by the target subject including a region where another subject overlaps on the front side is detected.

In step S413, on the basis of the detection result in step S412 and the 3D mapping data, the subject region extractor 43 specifies a region where the target subject and the overlapping object overlap and a front-back positional relationship between the target subject and the overlapping object in the region.

In step S414, the subject region extractor 43 sets, as a final region of the target subject (subject region), a region obtained by excluding a region where the overlapping object overlaps on the front side (imaging unit 21 side) from the region of the target subject detected in step S412.

The subject region extractor 43 generates generation region information indicating the final region of the target subject specified in this manner, and supplies the subject region information to the subject motion detector 41. In addition, the subject region extractor 43 generates the object region information on the basis of the specification result of the front-back positional relationship between the region of the overlapping object and the target subject, and supplies the object region information to the avatar motion constructor 42.

Furthermore, the subject region extractor 43 generates subject region data and subject region outside data on the basis of the specification result of the final region of the target subject, supplies the subject region data to the subject region processor 44, and supplies the subject region outside data to the background video processor 45.

In step S415, the subject motion detector 41 performs motion capture on the basis of the 3D mapping data supplied from the 3D mapping imaging unit 31, the video data supplied from the picture imaging unit 32, and the subject region information supplied from the subject region extractor 43.

At this time, the subject motion detector 41 detects the movement of the target subject not only in the subject region indicated by the subject region information, that is, the region seen on the front side of the target subject but also in the region where the overlapping object is not seen due to overlapping on the front side in the region of the target subject, by performing framework estimation or the like. It is therefore possible to detect more accurate movement of the target subject.

The subject motion detector 41 supplies subject motion data obtained by motion capture (detection of the movement of the target subject) to the avatar motion constructor 42.

In step S416, the avatar motion constructor 42 generates avatar motion data on the basis of the subject motion data supplied from the subject motion detector 41, the supplied avatar information, and the object region information supplied from the subject region extractor 43 and supplies the avatar motion data to the picture composite unit 46.

At this time, the avatar motion constructor 42 determines a front-back relationship (front-back positional relationship) of display between each region of the avatar corresponding to the target subject and the overlapping object on the basis of the object region information, and generates avatar motion data reflecting the front-back positional relationship between the avatar and the overlapping object.

When the processing of step S416 is performed, thereafter, the processing of steps S417 to S420 is performed and the composite video generation processing ends, but since the processing of these steps is similar to the processing of steps S15 to S18 in FIG. 5, the description thereof will be omitted.

In this case, for example, in step S417, similarly to step S165 in FIG. 19, the subject region process data is generated on the basis of the subject region data and the application data supplied from the outside, and the target subject is transparentized. Note that, in this embodiment, the target subject may be transparentized by any method such as the method described in any embodiment described above, not limited to the example of using the application data.

As described above, the imaging system 11 specifies the front-back positional relationship between the target subject and the object overlapping the target subject on the basis of the 3D mapping data, and generates the composite video reflecting the front-back positional relationship. In particular, in the imaging system 11, by utilizing the 3D mapping data, a more natural (high-quality) composite video in which the positional relationship between the avatar and the overlapping object is consistent can be obtained. In addition, in this case, it is also possible to suppress the occurrence of appearance of the target subject more easily and reliably regardless of the imaging place.

### Twelfth Embodiment

### <Configuration Example of Imaging System>

An example will be described in which, in a case where there is a plurality of target subjects and there is a portion where the plurality of target subjects overlaps each other on the captured video, the front-back positional relationship between the target subjects is reflected.

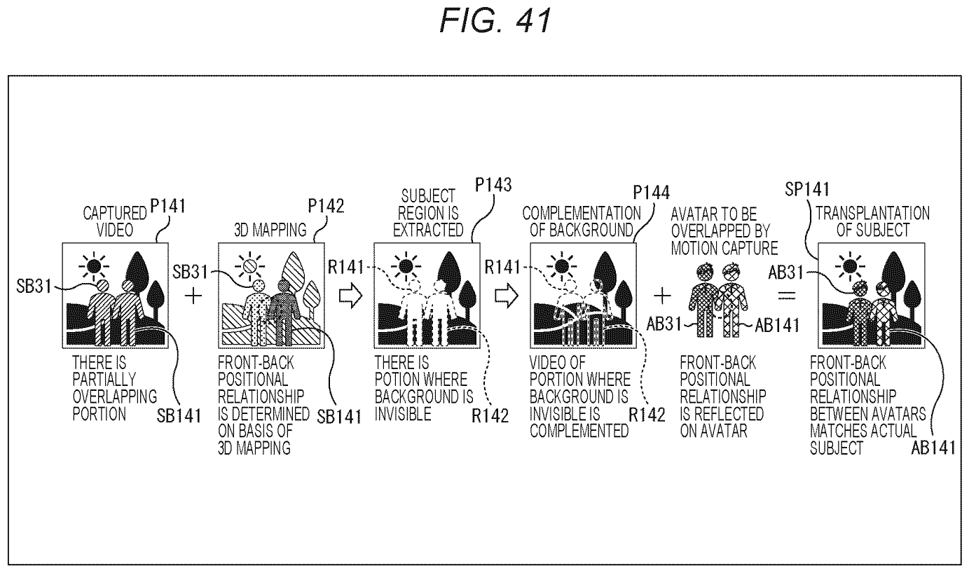

For example, as illustrated in FIG. 41, it is assumed that two target subjects SB31 and SB141 are included on a captured video P141. In this example, the target subject SB31 and a partial region of the target subject SB141 overlap each other.

In addition, the target subject SB31 and the target subject SB141 are also included on 3D mapping P142. Therefore, by using the 3D mapping P142, the front-back positional relationship between the target subject SB31 and the target subject SB141 in the portion where the target subject SB31 and the target subject SB141 overlap can be specified.

In this example, it is specified that the target subject SB141 is located on the front side (imaging unit 21 side) of the target subject SB31.

In the present embodiment, a composite video SP141 is generated on the basis of the front-back positional relationship between the target subject SB31 and the target subject SB141. That is, a region R141 of the target subject SB31 and a region R142 of the target subject SB141 are extracted and deleted (removed) from the captured video P141, and video data of a video P143 of the background obtained as a result is set as background video process data.

In addition, the video data such as the background corresponding to the region R141 and the region R142 is generated as the subject region process data by an arbitrary method such as the method using the application data described above, and the subject region process data and the background video process data are composited to obtain a video P144 in which the background is complemented. The video P144 is a captured video in which the target subject SB31 and the target subject SB141 are transparentized.

Furthermore, avatar motion data for displaying avatar AB31 corresponding to the target subject SB31 and avatar motion data for displaying an avatar AB141 corresponding to the target subject SB141 are also generated on the basis of the front-back positional relationship between the target subject SB31 and the target subject SB141.

In particular, in this example, the avatar motion data of the avatar AB31 is generated in which the region of a portion corresponding to the target subject SB141 overlapping the front side of the target subject SB31 in the region of the entire avatar AB31 is not displayed. That is, the front-back positional relationship between the target subject SB31 and the target subject SB141 is also reflected on the avatar AB31.

Then, when the avatar motion data of the avatar AB31 and the avatar AB141 is composited with the video P144, the composite video SP141 without appearance of the target subject SB31 and the target subject SB141 can be obtained. On the composite video SP141, the front-back positional relationship between the avatar AB31 and the avatar AB141 matches the actual front-back positional relationship between the target subject SB31 and the target subject SB141 corresponding to these avatars. In this way, by using the 3D mapping P142, it is possible to obtain the high-quality composite video SP141 in which the front-back positional relationship between the target subjects is consistent.

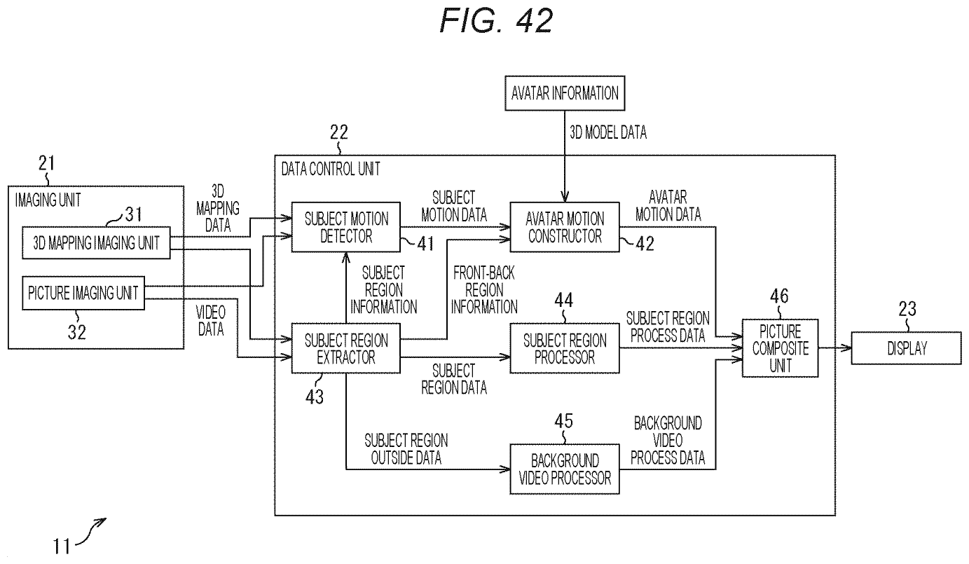

In a case where a composite video reflecting the front-back positional relationship between the portions where the target subjects overlap each other is generated, the imaging system 11 has a configuration illustrated in FIG. 42, for example.

The configuration of the imaging system 11 illustrated in FIG. 42 is basically the same as the configuration of the imaging system 11 illustrated in FIG. 3, but is different from the example in FIG. 3 in that the subject region information and front-back region information are supplied from the subject region extractor 43 to the subject motion detector 41 and the avatar motion constructor 42.

That is, the subject region extractor 43 generates generation region information indicating the region of the target subject on the captured video, and supplies the subject region information to the subject motion detector 41. In addition, the subject region extractor 43 generates a region in which a plurality of target subjects on the captured video overlaps each other and the front-back region information indicating the front-back positional relationship between the target subjects in the region, and supplies the front-back region information to the avatar motion constructor 42.

### <Description of Composite Video Generation Processing>

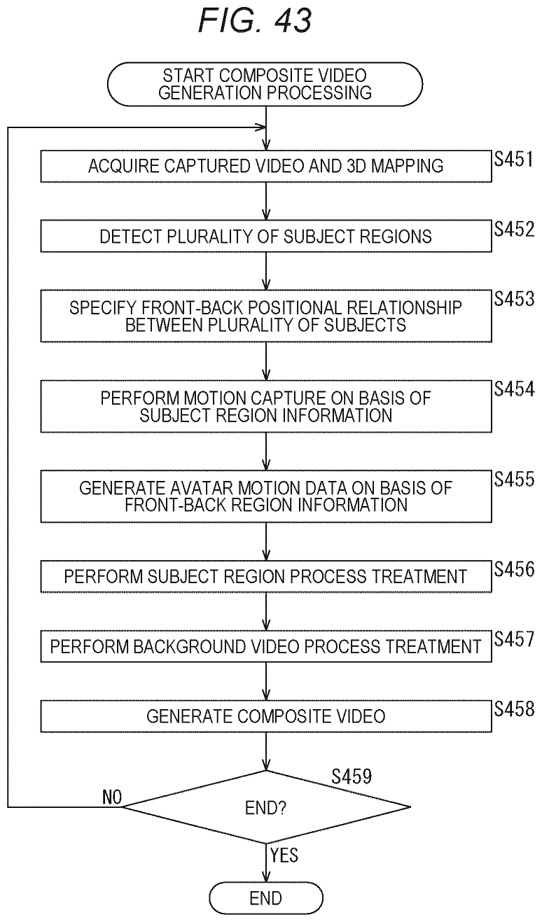

Next, the composite video generation processing performed by the imaging system 11 illustrated in FIG. 42 will be described with reference to a flowchart in FIG. 43.

Note that the processing in step S451 is similar to the thereof will be omitted.

In step S452, the subject region extractor 43 detects the subject region of the plurality of target subjects on the basis of the 3D mapping data supplied from the 3D mapping imaging unit 31 and the video data supplied from the picture imaging unit 32.

In step S453, on the basis of the detection result in step S452 and the 3D mapping data, the subject region extractor 43 specifies the front-back positional relationship in the region in which the plurality of target subjects overlaps each other, and generates the subject region information and the front-back region information. For example, the subject region information is generated for every target subject.

The subject region extractor 43 supplies the subject region information to the subject motion detector 41, and supplies the front-back region information to the avatar motion constructor 42. Furthermore, the subject region extractor 43 generates subject region data and subject region outside data on the basis of the specification result of the front-back positional relationship, supplies the subject region data to the subject region processor 44, and supplies the subject region outside data to the background video processor 45.

In step S454, the subject motion detector 41 performs motion capture on the basis of the 3D mapping data supplied from the 3D mapping imaging unit 31, the video data supplied from the picture imaging unit 32, and the subject region information supplied from the subject region extractor 43.

At this time, the subject motion detector 41 detects the movement of the target subject not only in the subject region indicated by the subject region information, that is, the region seen on the front side of the target subject but also in the region where another target subject is not seen due to overlapping on the front side in the region of the target subject, by performing framework estimation or the like. It is therefore possible to detect more accurate movement of the target subject.

The subject motion detector 41 supplies subject motion data for every target subject obtained by motion capture to the avatar motion constructor 42.

In step S455, the avatar motion constructor 42 generates avatar motion data on the basis of the subject motion data supplied from the subject motion detector 41, the supplied avatar information, and the front-back region information supplied from the subject region extractor 43 and supplies the avatar motion data to the picture composite unit 46.

At this time, the avatar motion constructor 42 determines a front-back relationship (front-back positional relationship) of display between the target subjects partially overlapping each other on the basis of the front-back region information, and generates avatar motion data reflecting the front-back positional relationship between the target subjects for every target subject.

When the processing of step S455 is performed, thereafter, the processing of steps S456 to S459 is performed and the composite video generation processing ends, but since the processing of these steps is similar to the processing of steps S15 to S18 in FIG. 5, the description thereof will be omitted.

In this case, for example, in step S456, similarly to step S165 in FIG. 19, the subject region process data is generated on the basis of the subject region data and the application data supplied from the outside, and the target subject is transparentized. Note that, in this embodiment, the target subject may be transparentized by any method such as the method described in any embodiment described above, not limited to the example of using the application data.

As described above, the imaging system 11 specifies the front-back positional relationship in the portion where the target subjects overlap each other on the basis of the 3D mapping data, and generates the composite video reflecting the front-back positional relationship. In particular, in the imaging system 11, by utilizing the 3D mapping data, a more natural (high-quality) composite video in which the positional relationship between the avatars corresponding to the plurality of target subjects is consistent can be obtained. In addition, in this case, it is also possible to suppress the occurrence of appearance of the target subject more easily and reliably regardless of the imaging place.

### Thirteenth Embodiment

### <Configuration Example of Imaging System>

An example will be described in which, in a case where there is a plurality of subjects to be candidates for the target subject and there is a portion overlapping the plurality of subjects on the captured video, only a specific subject among the plurality of subjects is transparentized as the target subject, and the front-back positional relationship between the overlapping subjects is reflected.

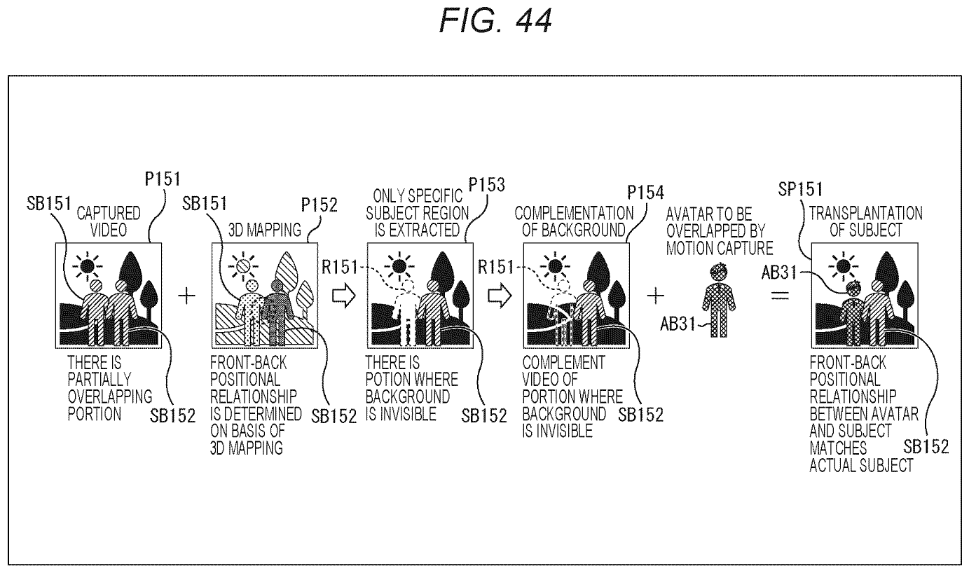

For example, as illustrated in FIG. 44, it is assumed that candidates for the target subject, that is, two subjects SB151 and SB152, which are candidates to be transparentized, are included on the captured video P151. In this example, the subject SB151 and a partial region of the subject SB152 overlap each other.

In addition, since the subject SB151 and the subject SB152 are also included on the 3D mapping P152, the front-back positional relationship between the portion where the subject SB151 and the subject SB152 overlap each other can be specified by using the 3D mapping P152.

In this example, it is specified that the subject SB152 is located on the front side (imaging unit 21 side) of the subject SB151.

In the present embodiment, only the subject SB151 out of the subject SB151 and the subject SB152 is set as the target subject to be transparentized, and a composite video SP151 is generated on the basis of the front-back positional relationship between the subject SB151 and the subject SB152.

That is, only the region R151 of the subject SB151 is extracted and deleted (removed) from the captured video P151, and video data of the video P153 of the background obtained as a result is set as background video process data. The subject SB152 that is not to be transparentized remains on the video P153.

In addition, the video data such as the background corresponding to the region R151 is generated as the subject region process data by an arbitrary method such as the method using the application data described above, and the subject region process data and the background video process data are composited to obtain a video P154 in which the background is complemented. The video P154 is a captured video in which only the subject SB151 is transparentized.

Furthermore, avatar motion data for displaying the avatar AB31 corresponding to the subject SB151 is generated on the basis of the front-back positional relationship between the target subject SB151 and the subject SB152.

Then, when the avatar motion data of the avatar AB31 is composited with the video P154, the composite video SP151 without appearance of the subject SB151 can be obtained. On the composite video SP151, the front-back positional relationship of the avatar AB31 and the subject SB152 matches the actual front-back positional relationship between the subject SB151 and the subject SB152 corresponding to the avatar AB31. In this way, by using the 3D mapping P152, it is possible to obtain the high-quality composite video SP151 in which the front-back positional relationship between the subjects is consistent.

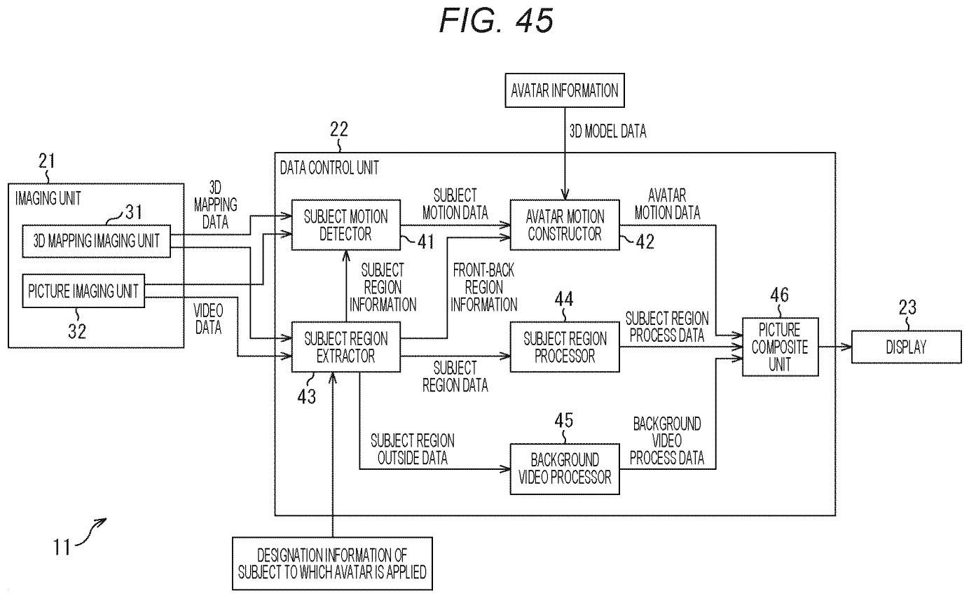

In a case where a composite video reflecting the front-back positional relationship between the portions where the subjects overlap each other is generated, the imaging system 11 has a configuration illustrated in FIG. 45, for example.

The configuration of the imaging system 11 illustrated in FIG. 45 is basically the same as the configuration of the imaging system 11 illustrated in FIG. 3, but is different from the example in FIG. 3 in that the subject region information and front-back region information are supplied from the subject region extractor 43 to the subject motion detector 41 and the avatar motion constructor 42.

That is, the subject region extractor 43 generates subject region information indicating a region of a target subject on the captured video on the basis of designation information that designates a subject to which an avatar is applied, that is, a subject (target subject) to be transparentized supplied from the outside, and supplies the subject region information to the subject motion detector 41. In addition, the subject region extractor 43 generates a region in which the subjects on the captured video overlap each other and the front-back region information indicating the front-back positional relationship between the subjects in the region, and supplies the front-back region information to the avatar motion constructor 42.

### <Description of Composite Video Generation Processing>

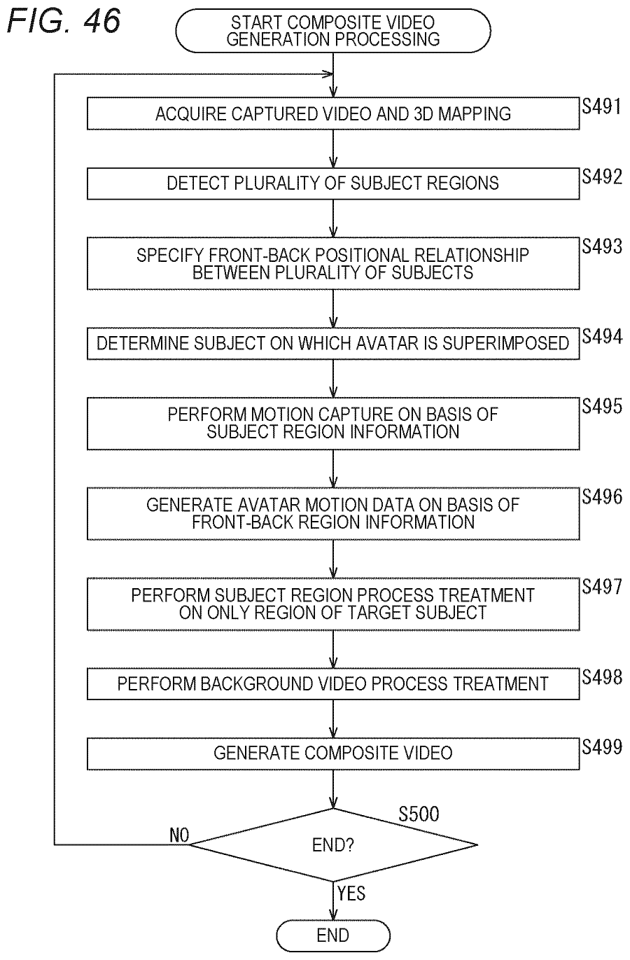

Next, the composite video generation processing performed by the imaging system 11 illustrated in FIG. 45 will be described with reference to a flowchart in FIG. 46.

Note that the processing of step S491 is similar to the processing of step S11 in FIG. 5, and thus the description thereof will be omitted.

In step S492, the subject region extractor 43 detects the subject region of the plurality of subjects to be candidates for the target subject on the basis of the 3D mapping data supplied from the 3D mapping imaging unit 31 and the video data supplied from the picture imaging unit 32.

In step S493, on the basis of the detection result in step S492 and the 3D mapping data, the subject region extractor 43 specifies the front-back positional relationship in the region in which the plurality of subjects overlaps each other.

In step S494, the subject region extractor 43 determines (selects) the subject on which the avatar is to be superimposed, that is, the target subject to be transparentized on the basis of the designation information supplied from the outside. For example, among the plurality of subjects of which the subject region is detected in step S492, the subject indicated by the designation information is set as the target subject. Note that the number of target subjects to be transparentized indicated by the designation information may be one or plural.

Furthermore, here, an example of superimposing an avatar (avatar motion data) on the portion of the transparentized target subject will be described. However, one or a plurality of subjects to be transparentized (hereinafter, also referred to as a transparentization target subject) and one or a plurality of subjects on which the avatar is to be superimposed (hereinafter, also referred to as an avatar superimposition target subject) may be able to be designated by designation information or the like. In this case, the subject designated as the avatar superimposition target subject is basically designated as the transparentization target subject, but is not required to be designated as the transparentization target subject. In this way, by making it possible to separately designate the subject to be transparentized and the subject to be superimposed on the avatar, for example, it is possible to designate another person who is not to be superimposed on the avatar and appears on the captured video as the transparentization target subject and to transparentize the another person.

The subject region extractor 43 generates subject region information and front-back region information on the basis of a determination result of the target subject and processing results of steps S492 and S493, supplies the subject region information to the subject motion detector 41, and supplies the front-back region information to the avatar motion constructor 42. In addition, the subject region extractor 43 generates subject region data and subject region outside data on the basis of the processing results in steps S492 and S493, supplies the subject region data to the subject region processor 44, and supplies the subject region outside data to the background video processor 45.

Note that, in a case where the transparentization target subject and the avatar superimposition target subject can be designated by the designation information, the subject region information is information indicating the region of the avatar superimposition target subject on the captured video. Furthermore, the subject region data is data of a picture (video) of the transparentization target subject extracted from the captured video, and the subject region outside data is data of a picture (video) obtained by removing the region of the transparentization target subject from the captured video.

In step S495, the subject motion detector 41 performs motion capture on the basis of the 3D mapping data supplied from the 3D mapping imaging unit 31, the video data supplied from the picture imaging unit 32, and the subject region information supplied from the subject region extractor 43.

At this time, the subject motion detector 41 detects the movement of the target subject not only in the subject region indicated by the subject region information, but also in the region where another subject is not seen due to overlapping on the front side in the region of the target subject, by performing framework estimation or the like. It is therefore possible to detect more accurate movement of the target subject.

The subject motion detector 41 supplies subject motion data obtained by motion capture to the avatar motion constructor 42.

In step S496, the avatar motion constructor 42 generates avatar motion data on the basis of the subject motion data supplied from the subject motion detector 41, the supplied avatar information, and the front-back region information supplied from the subject region extractor 43 and supplies the avatar motion data to the picture composite unit 46.

At this time, the avatar motion constructor 42 determines a front-back relationship (front-back positional relationship) of display between each region of the avatar corresponding to the target subject and another subject on the basis of the front-back region information, and generates avatar motion data reflecting the front-back positional relationship between the avatar and the another subject.

When the processing of step S496 is performed, thereafter, the processing of steps S497 to S500 is performed and the composite video generation processing ends, but since the processing of these steps is similar to the processing of steps S15 to S18 in FIG. 5, the description thereof will be omitted.

However, in step S497, the subject region process treatment, that is, the processing of transparentizing the target subject is performed only on the region of the target subject designated by the designation information among the plurality of subjects.

In this case, in the subject region process treatment, for example, similarly to step S165 in FIG. 19, the subject region process data is generated on the basis of the subject region data and the application data supplied from the outside, and the target subject is transparentized. Note that, in this embodiment, the target subject may be transparentized by any method such as the method described in any embodiment described above, not limited to the example of using the application data. Note that, from the viewpoint of preventing appearance of another person, processing of transparentizing the subject may also be performed on a region of the subject that is not designated by the designation information among the plurality of subjects and in which the subject is a person.

Furthermore, for example, in a case where the transparentization target subject and the avatar superimposition target subject can be designated by the designation information, different processing may be performed as the processing of transparentizing the subject between the region of the transparentization target subject that is also the avatar superimposition target subject and the region of the transparentization target subject that is not the avatar superimposition target subject. For example, the region of the transparentization target subject that is not the avatar superimposition target subject can be transparentized by a video of a background generated by estimation, and the region of the transparentization target subject that is also the avatar superimposition target subject can be transparentized by a single-color video or an effect video.

In addition, from the viewpoint of preventing appearance of another person, in a case where transparentization is also performed on a region of a person other than the target subject on the captured video, the following processing may be performed. That is, for example, in step S492, a person on the captured video is detected as a candidate for the target subject. Then, in step S494, among the plurality of subjects detected in step S492, that is, the candidates of the target subject, all the subjects (candidates) other than the avatar superimposition target subject are also selected as transparentization target subjects. At this time, the avatar superimposition target subject is basically selected as the transparentization target subject, but is not required to be selected as the transparentization target subject. In this way, the region of an unnecessary person on the captured video is transparentized, and appearance of another person can be prevented.

As described above, the imaging system 11 specifies the front-back positional relationship in the portion where the subjects overlap each other on the basis of the 3D mapping data, and generates the composite video reflecting the front-back positional relationship. In particular, in the imaging system 11, by utilizing the 3D mapping data, a more natural (high-quality) composite video in which the positional relationship between the avatar and the subject that is not transparentized is consistent can be obtained. In addition, in this case, it is also possible to suppress the occurrence of appearance of the target subject more easily and reliably regardless of the imaging place.

### Fourteenth Embodiment

### <Configuration Example of Imaging System>

An example will be described in which the size of the avatar to be displayed in the composite video can be arbitrarily changed.

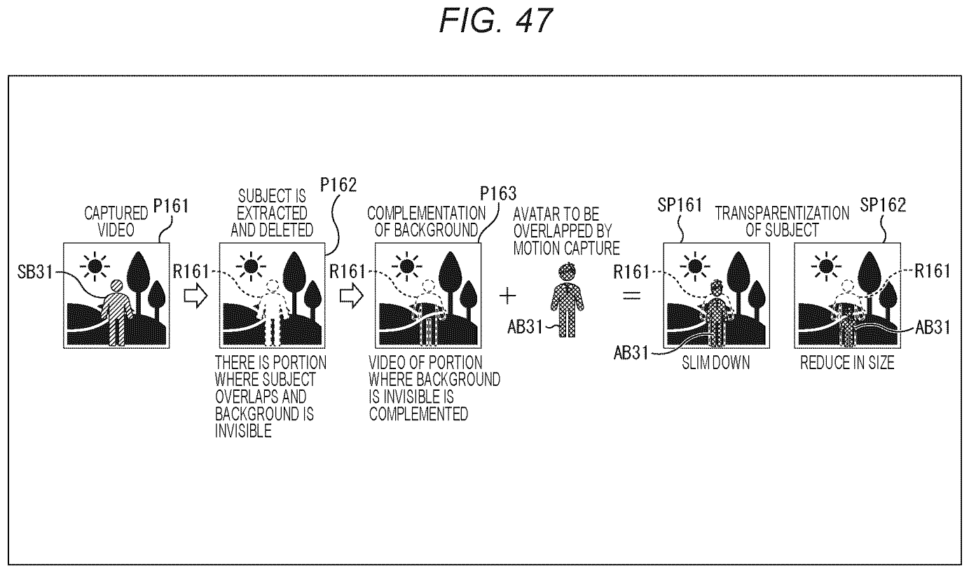

For example, as illustrated in FIG. 47, assuming that a captured video P161 including the target subject SB31 is obtained, a region R161 of the target subject SB31 is extracted and deleted (removed) from the captured video P161, and video data of a video P162 of the background obtained as a result is set as background video process data.

In addition, the video data such as the background corresponding to the region R161 is generated as the subject region process data by an arbitrary method such as the method using the application data described above, and the subject region process data and the background video process data are composited to obtain a video P163 in which the background is complemented. The video P163 is a captured video in which the target subject SB31 is transparentized.

Furthermore, avatar motion data for displaying the avatar AB31 corresponding to the target subject SB31 is generated. Then, by compositing the avatar motion data in which the size of the avatar AB31 is arbitrarily changed (adjusted) with the video P163, it is possible to obtain a composite video SP161 and the composite video SP162 in which the avatar AB31 having a desired size appears and the target subject SB31 does not appear.

For example, in the composite video SP161, the avatar AB31 is slimmer than the original avatar. That is, the size of the avatar AB31 is reduced in the transverse direction. Furthermore, in a composite video SP162, the avatar AB31 has a size smaller than the original size as a whole.

In the imaging system 11, since the avatar AB31 is superimposed (composited) on the video P163 in which the target subject SB31 is transparentized to obtain a composite video, the appearance of the target subject SB31 does not occur due to a change in size of the avatar AB31 to an arbitrary size.

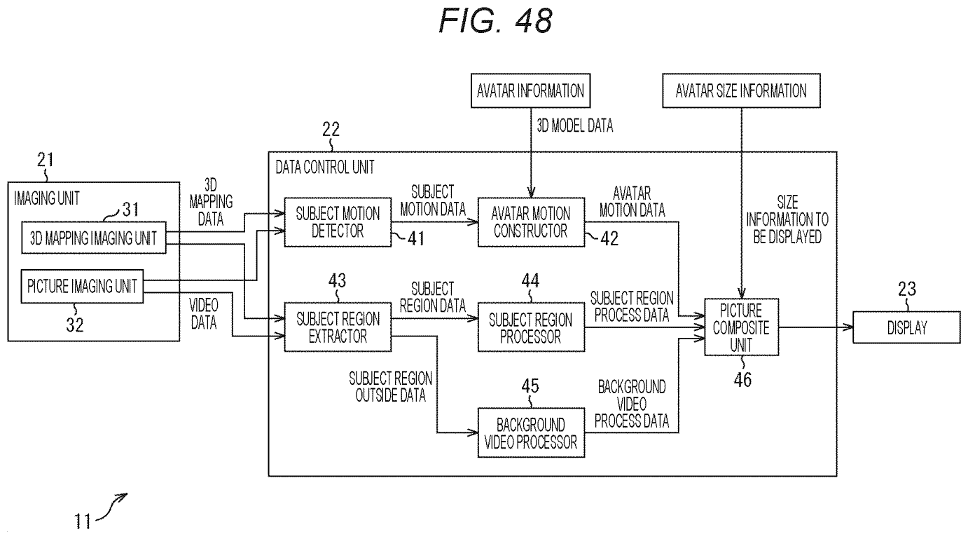

In a case where the size of the avatar is arbitrarily changed (adjusted), the imaging system 11 has a configuration illustrated in FIG. 48, for example.

The configuration of the imaging system 11 illustrated in FIG. 48 is basically the same as the configuration of the imaging system 11 illustrated in FIG. 3, but the picture composite unit 46 generates a composite video on the basis of the avatar size information indicating a display size of the avatar on the composite video and supplied from the outside. That is, the picture composite unit 46 adjusts the display size of the avatar to be composited on the composite video (captured video) to an arbitrary size.

### <Description of Composite Video Generation Processing>

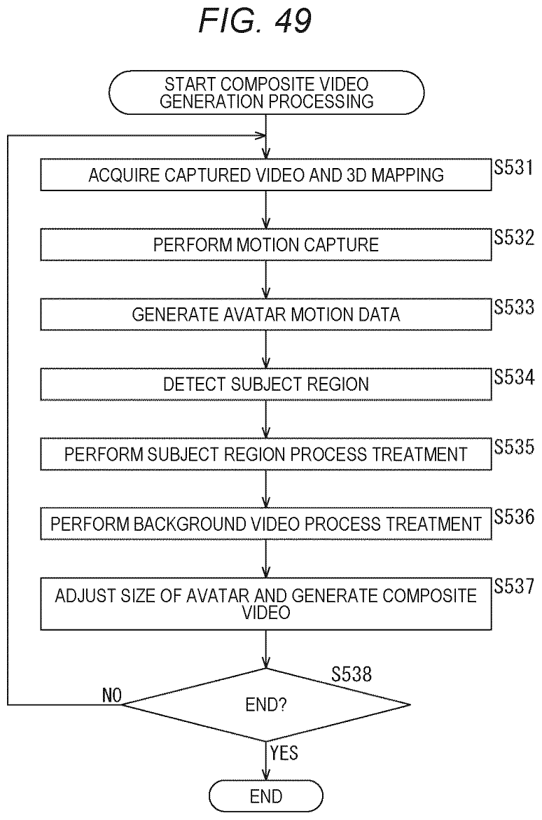

Next, the composite video generation processing performed by the imaging system 11 illustrated in FIG. 48 will be described with reference to a flowchart in FIG. 49.

Note that the processing of step S531 to step S536 is similar to the processing of step S11 to step S16 in FIG. 5, and thus the description thereof will be omitted.

In this case, in step S535, similarly to step S165 in FIG. 19, for example, the subject region process data is generated on the basis of the subject region data and the application data supplied from the outside, and the target subject is transparentized. Note that, in this embodiment, the target subject may be transparentized by any method such as the method described in any embodiment described above, not limited to the example of using the application data.

In step S537, the picture composite unit 46 adjusts size adjustment of the avatar on the basis of the avatar size information supplied from the outside, and generates the composite video.

That is, the picture composite unit 46 composites the avatar motion data supplied from the avatar motion constructor 42, the subject region process data supplied from the subject region processor 44, and the background video process data supplied from the background video processor 45.

At this time, the picture composite unit 46 composites the video based on the subject region process data with the portion of the subject region on the video based on the background video process data to generate the video of the background. Furthermore, the picture composite unit 46 adjusts the video of the avatar based on the avatar motion data to the display size indicated by the avatar size information, composites the adjusted video of the avatar with the video of the background, generates video data of the composite video, and supplies the video data to the display 23. In the composite video thus obtained, since the target subject is transparentized, the occurrence of appearance of the target subject is suppressed regardless of the display size of the avatar.

When the processing of step S537 is performed, thereafter, the processing of step S538 is performed, and the composite video generation processing ends. However, since the processing of step S538 is similar to the processing of step S18 in FIG. 5, description of the processing of step S538 will be omitted.

As described above, the imaging system 11 adjusts the display size of the avatar on the basis of the avatar size information, and generates the composite video. In this case, it is also possible to suppress the occurrence of appearance of the target subject more easily and reliably regardless of the imaging place.

### Fifteenth Embodiment

### <Configuration Example of Imaging System>

An example will be described in which the display size of the avatar on the composite video is changed in accordance with an imaging point (imaging position), that is, the distance from the position of the imaging unit 21 to the target subject, and more natural perspective can be expressed.

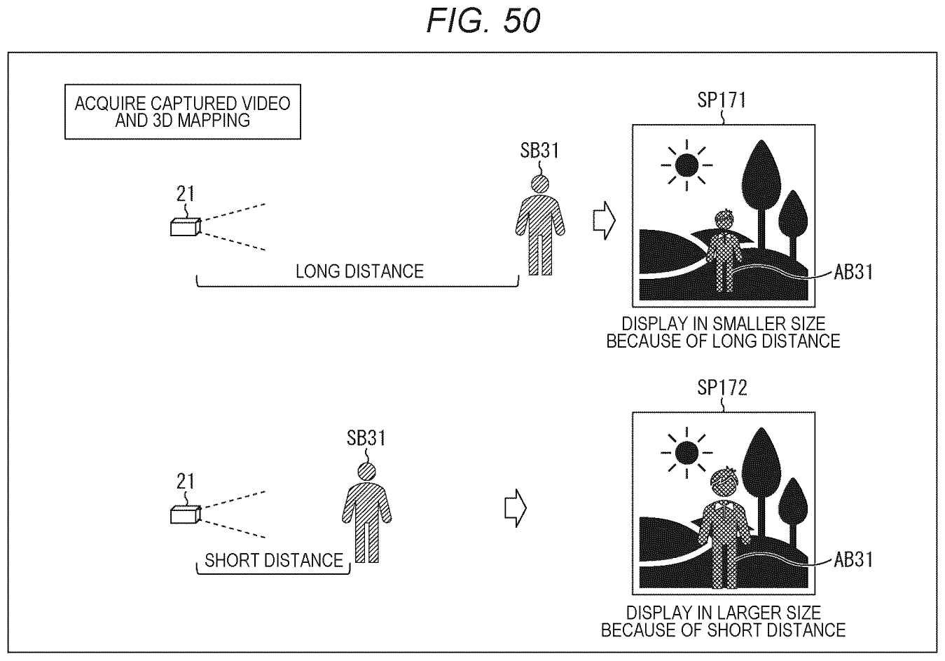

In the imaging system 11, since the 3D mapping is also acquired in addition to the captured video, the distance from the imaging unit 21 to the target subject can be calculated by utilizing the 3D mapping. Therefore, for example, as illustrated in FIG. 50, the display size of the avatar may be corrected to a size suitable for the distance to the target subject.

Specifically, for example, as illustrated in the upper side in FIG. 50, in a case where the distance from the imaging unit 21 to the target subject SB31 is long, a composite video SP171 in which the avatar AB31 corresponding to the target subject SB31 is displayed with a relatively small size is generated.

On the other hand, for example, as illustrated in the lower side in the drawing, in a case where the distance from the imaging unit 21 to the target subject SB31 is short, a composite video SP172 in which the avatar AB31 corresponding to the target subject SB31 is displayed with a relatively large size is generated.

In this way, by adjusting the display size of avatar AB31 in accordance with the distance to target subject SB31, it is possible to obtain a composite video in which the avatar AB31 exists in the real space without discomfort. That is, a higher-quality (more natural) composite video can be obtained. Moreover, also in this example, since the target subject SB31 is transparentized, appearance of target subject SB31 can be suppressed.

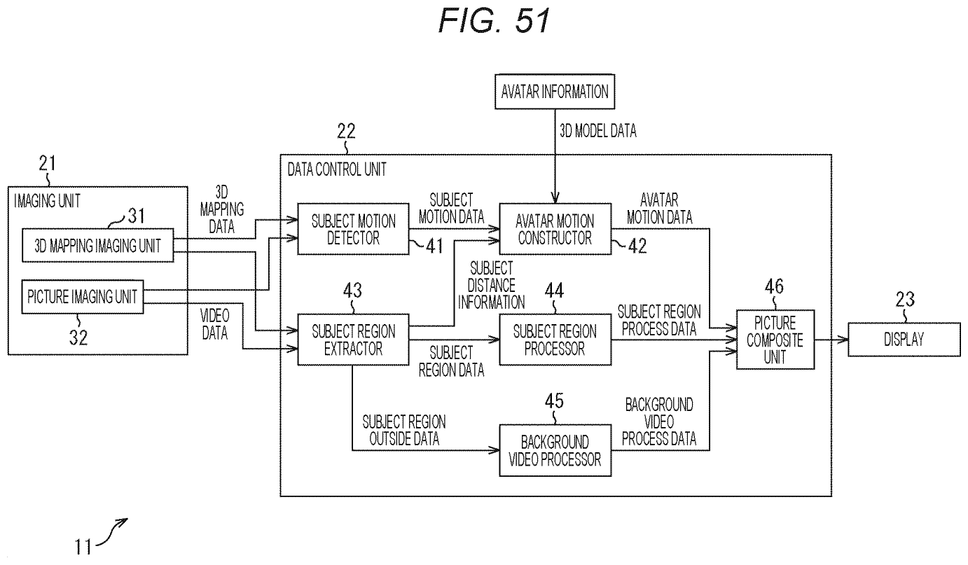

In a case where the display size of the avatar is adjusted in accordance with the distance to the target subject, the imaging system 11 has a configuration illustrated in FIG. 51, for example.

The configuration of the imaging system 11 illustrated in FIG. 51 is basically the same as the configuration of the imaging system 11 illustrated in FIG. 3, but the subject region extractor 43 supplies subject distance information indicating the distance from the imaging unit 21 (3D mapping imaging unit 31) to the target subject to the avatar motion constructor 42.

Furthermore, the avatar motion constructor 42 adjusts the display size of the avatar on the basis of the subject distance information supplied from the subject region extractor 43.

### <Description of Composite Video Generation Processing>

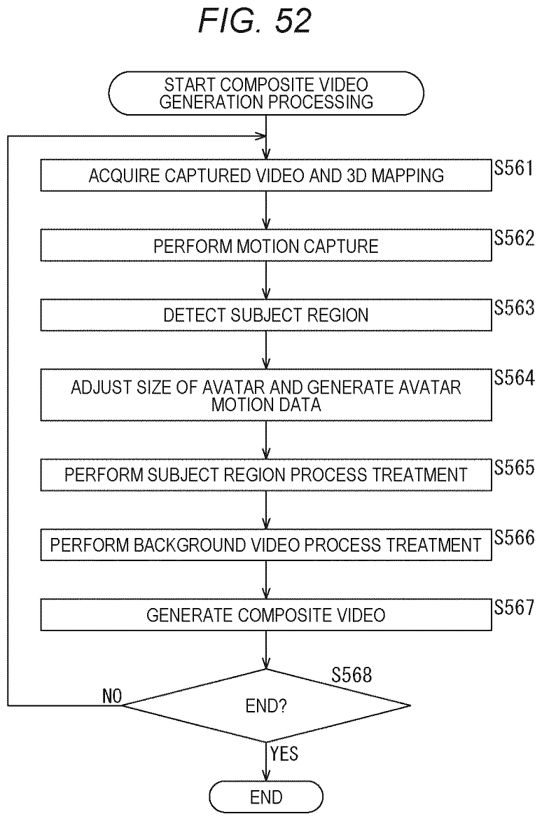

Next, the composite video generation processing performed by the imaging system 11 illustrated in FIG. 51 will be described with reference to a flowchart in FIG. 52.

Note that, since processing of steps S561 to S563 is similar to the processing of steps S11, S12, and S14 in FIG. 5, description thereof is omitted.

However, in step S563, the subject region extractor 43 generates subject region data and subject region outside data, and also generates subject distance information.

That is, the subject region extractor 43 calculates the distance from the imaging unit 21 (imaging position) to the target subject on the basis of the detection result of the target subject and the 3D mapping data, generates subject distance information, and supplies the subject distance information to the avatar motion constructor 42.

In step S564, the avatar motion constructor 42 adjusts the size of the avatar, generates avatar motion data, and supplies the avatar motion data to the picture composite unit 46.

That is, the avatar motion constructor 42 generates the avatar motion data on the basis of the subject motion data supplied from the subject motion detector 41 and the avatar information supplied from the outside. At this time, the avatar motion constructor 42 adjusts the display size of the avatar so as to have a size according to the distance indicated by the subject distance information supplied from the subject region extractor 43, and generates avatar motion data in which the avatar is displayed in the adjusted size.

Note that, here, an example will be described in which the display size of the avatar is adjusted in the avatar motion constructor 42. However, for example, as in the case of the above-described fourteenth embodiment, the display size of the avatar may be adjusted on the basis of the subject distance information in the picture composite unit 46.

When the processing of step S564 is performed, thereafter, the processing of steps S565 to S568 is performed and the composite video generation processing ends, but since the processing of these steps is similar to the processing of steps S15 to S18 in FIG. 5, the description thereof will be omitted.

In this case, in step S565, similarly to step S165 in FIG. 19, for example, the subject region process data is generated on the basis of the subject region data and the application data supplied from the outside, and the target subject is transparentized. Note that, in this embodiment, the target subject may be transparentized by any method such as the method described in any embodiment described above, not limited to the example of using the application data.

As described above, the imaging system 11 adjusts the display size of the avatar on the basis of the subject distance information, and generates the composite video. In this case, it is also possible to suppress the occurrence of appearance of the target subject more easily and reliably regardless of the imaging place.

### Sixteenth Embodiment

### <Configuration Example of Imaging System>

An example will be described in which the avatar is displayed with a grounding point between the target subject and a ground or the like as a starting point.

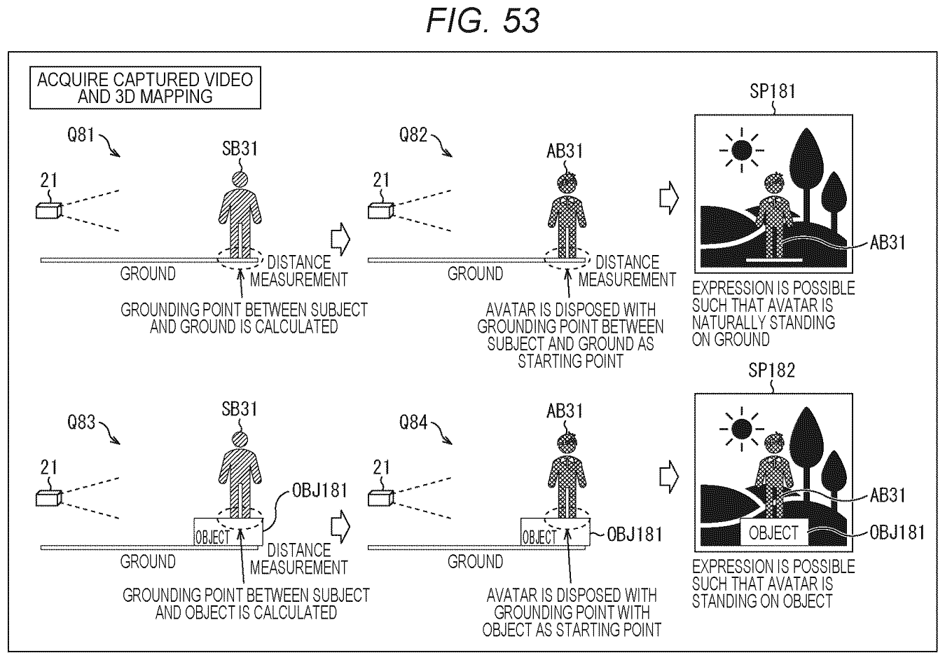

In the imaging system 11, since the 3D mapping is also acquired in addition to the captured video, the distance from the imaging unit 21 to each subject can be calculated by using the 3D mapping, and the position of a contact point (grounding point) between the target subject and the ground or the like can be specified. Therefore, for example, as illustrated in FIG. 53, the avatar corresponding to the target subject may be displayed with the grounding point of the target subject as a starting point.

Specifically, for example, as indicated by an arrow Q81 in FIG. 53, it is assumed that the target subject SB31 stands on the ground, and the position of the grounding point between the target subject SB31 and the ground is obtained from the 3D mapping.

In such a case, as indicated by an arrow Q82, the avatar AB31 corresponding to the target subject SB31 is disposed with the obtained grounding point as a starting point, and a composite video SP181 is generated. That is, a display position of the avatar AB31 is determined such that the position of the grounding point and an end of a foot of the avatar AB31 are in contact with each other. Therefore, on the composite video SP181, the avatar AB31 stands at the position of the obtained grounding point, that is, on the ground, and more natural video expression is achieved.

Similarly, for example, as indicated by an arrow Q83, it is assumed that the target subject SB31 stands on an object OBJ181 disposed on the ground, and the position of the grounding point between the target subject SB31 and the object OBJ181 is obtained from 3D mapping.

In such a case, as indicated by an arrow Q84, the avatar AB31 corresponding to the target subject SB31 is disposed with the obtained grounding point as a starting point, and a composite video SP182 is generated. Therefore, in this example, in the composite video SP182, the avatar AB31 also stands at the position of the obtained grounding point, that is, on the object OBJ181, and more natural video expression is achieved.

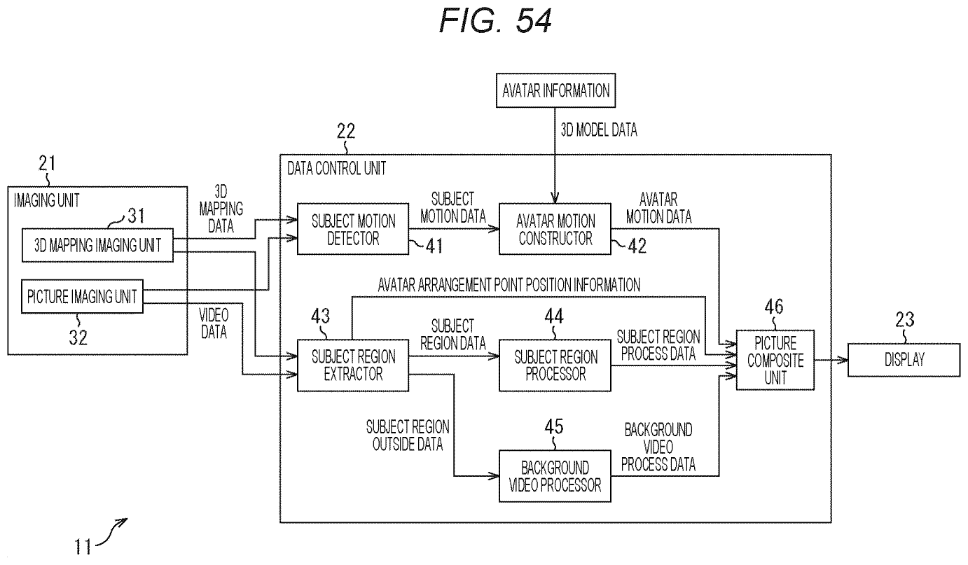

In a case where the avatar is displayed with the grounding point as a starting point, the imaging system 11 has a configuration illustrated in FIG. 54, for example.

The configuration of the imaging system 11 illustrated in FIG. 54 is basically the same as the configuration of the imaging system 11 illustrated in FIG. 3, but the subject region extractor 43 also generates avatar arrangement point position information and supplies the avatar arrangement point position information to the picture composite unit 46.

That is, the subject region extractor 43 generates avatar arrangement point position information indicating the position of the grounding point of the target subject on the captured video, in other words, an arrangement position (display position) of the avatar corresponding to the target subject on the basis of the extraction result of the target subject and the 3D mapping data.

The picture composite unit 46 generates a composite video on the basis of the avatar arrangement point position information supplied from the subject region extractor 43.

### <Description of Composite Video Generation Processing>

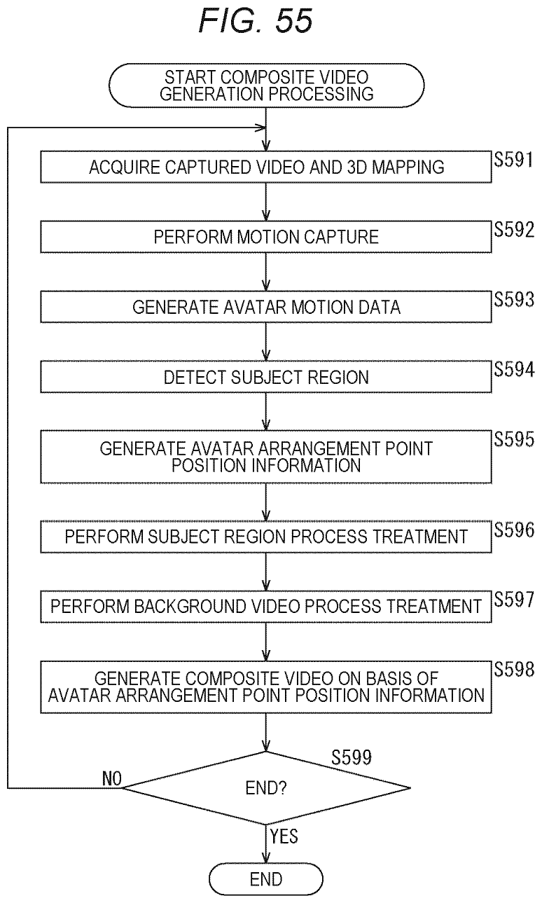

Next, the composite video generation processing performed by the imaging system 11 illustrated in FIG. 54 will be described with reference to a flowchart in FIG. 55.

Note that the processing of step S591 to step S594 is similar to the processing of step S11 to step S14 in FIG. 5, and thus the description thereof will be omitted.

In step S595, the subject region extractor 43 specifies the position of the grounding point of the target subject on the captured video on the basis of the extraction result of the target subject in step S594 and the 3D mapping data, and generates avatar arrangement point position information on the basis of the specification result. The subject region extractor 43 supplies the generated avatar arrangement point position information to the picture composite unit 46.

When the processing of step S595 is performed, thereafter, the processing of steps S596 and S597 is performed, but since the processing of these steps is similar to the processing of steps S15 and S16 in FIG. 5, the description thereof will be omitted.

In this case, in step S596, similarly to step S165 in FIG. 19, for example, the subject region process data is generated on the basis of the subject region data and the application data supplied from the outside, and the target subject is transparentized. Note that, in this embodiment, the target subject may be transparentized by any method such as the method described in any embodiment described above, not limited to the example of using the application data.

In step S598, the picture composite unit 46 generates a composite video on the basis of the avatar arrangement point position information supplied from the subject region extractor 43, and supplies video data of the obtained composite video to the display 23.

That is, the picture composite unit 46 composites the avatar motion data supplied from the avatar motion constructor 42, the subject region process data supplied from the subject region processor 44, and the background video process data supplied from the background video processor 45.

At this time, the picture composite unit 46 composites the video based on the subject region process data with the portion of the subject region on the video based on the background video process data to generate the video of the background. Furthermore, the picture composite unit 46 generates video data of the composite video by compositing the video of the avatar based on the avatar motion data on the video of the background with the position of the grounding point indicated by the avatar arrangement point position information as a starting point. On the composite video thus obtained, a lower end of the avatar is disposed at the position of the grounding point indicated by the avatar arrangement point position information. That is, the avatar is displayed with the position of the grounding point on the composite video as a starting point.

Note that, although an example has been described in which the arrangement position of the avatar is adjusted by the picture composite unit 46 on the basis of the avatar arrangement point position information, the arrangement position of the avatar may be adjusted by the avatar motion constructor 42. In such a case, the avatar motion constructor 42 generates, on the basis of the avatar arrangement point position information, avatar motion data in which the avatar disposed with the arrangement position (the position of the grounding point) indicated by the avatar arrangement point position information with a starting point is displayed.

When the processing of step S598 is performed, thereafter, the processing of step S599 is performed, and the composite video generation processing ends. However, since the processing of step S599 is similar to the processing of step S18 in FIG. 5, description of the processing of step S599 will be omitted.

As described above, the imaging system 11 adjusts the display position of the avatar on the basis of the avatar arrangement point position information, and generates the composite video. In this case, it is also possible to suppress the occurrence of appearance of the target subject more easily and reliably regardless of the imaging place.

### Seventeenth Embodiment

### <Configuration Example of Imaging System>

An example of compositing by replacing a video of a portion other than the target subject extracted from the captured video with an arbitrary separate video will be described.

For example, it is possible to express a desired world view and provide an experience of entering the world of an avatar by additionally compositing an arbitrary separate video with a part or a whole of a background video or changing a video of an object around the target subject to a video of an arbitrary another object.

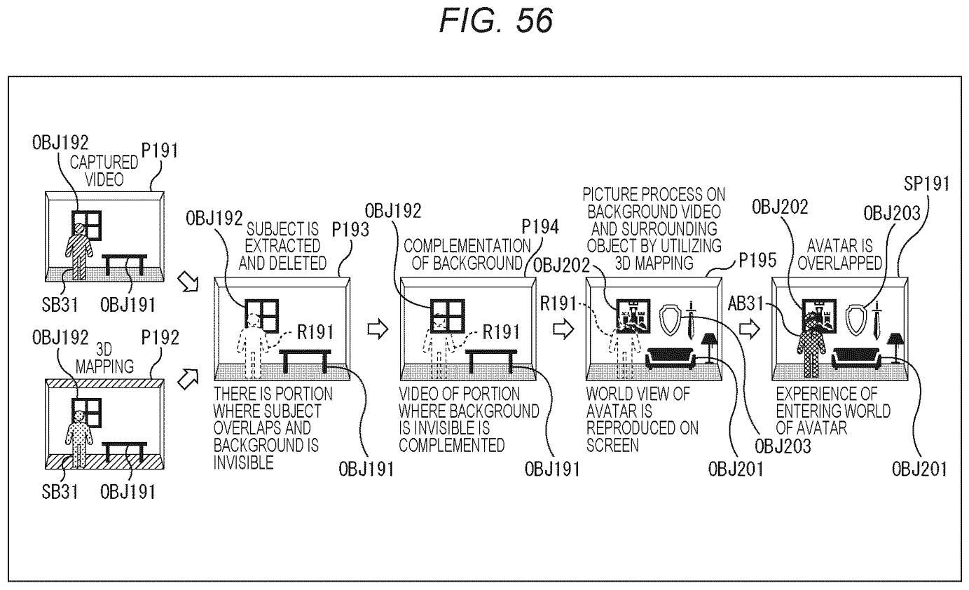

For example, as illustrated in FIG. 56, it is assumed that a captured video P191 including the target subject SB31 and a desk OBJ191 and a window OBJ192 as other objects in the real space is obtained. In this case, 3D mapping P192 acquired at the same time also includes the target subject SB31, the desk OBJ191, and a window OBJ192.

On the basis of the captured video P191 and the 3D mapping P192, a region R191 of the target subject SB31 is extracted and deleted (removed) from the captured video P191, and the video data of a video P193 of a background obtained as a result is set as the background video process data.

In addition, the video data such as the background corresponding to the region R191 is generated as the subject region process data by an arbitrary method such as the method using the application data described above, and the subject region process data and the background video process data are composited to obtain a video P194 in which the background is complemented.

The video P194 is a captured video in which the target subject SB31 is transparentized, and the desk OBJ191 and the window OBJ192 that are not to be transparentized, that is, not the target subject remain displayed on the video P194.

Here, by using the 3D mapping P192, it is possible to accurately specify a distance and a position (region) to the desk OBJ191 or the window OBJ192 on the video P194, that is, on the captured video P191, a position (region) of a wall or a floor existing as a background of the real space, and the like.

Therefore, for example, in order to reproduce (express) the world view of the avatar on a screen, picture process is performed on the background and surrounding objects on the video P194 to generate a video P195.

In this example, on the video P195, picture process is performed in which the original desk OBJ191 and the window OBJ192 are replaced with a sofa OBJ201 which is a virtual object (separate video) and separate window OBJ202 from which an outside view can be seen. In addition, in the video P195, a virtual object such as a shield OBJ203 is newly disposed on a wall as a background, and a lamp as a virtual object is also disposed on a floor.

Furthermore, the avatar AB31 corresponding to the target subject SB31 based on the avatar motion data is composited with the video P195 obtained in this manner, and the video data of the composite video SP191 without appearance of the target subject SB31 is generated. By presenting the composite video SP191 in which the world view of the avatar is expressed in this manner, it is possible to provide an experience as if entering the world of the avatar.

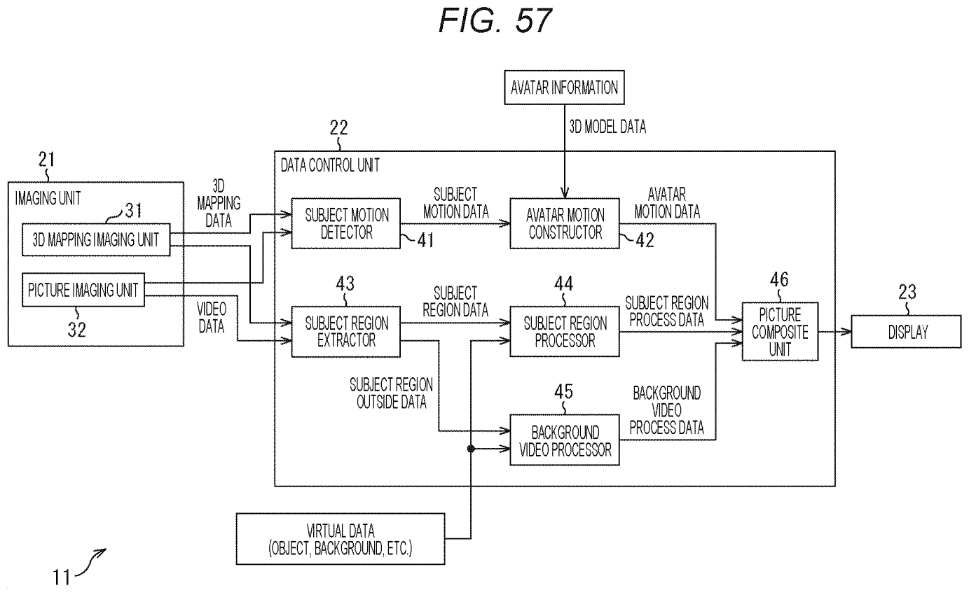

In a case where an arbitrary background, virtual object, or the like different from the avatar is disposed (composited) on the composite video, the imaging system 11 has a configuration illustrated in FIG. 57, for example.

The configuration of the imaging system 11 illustrated in FIG. 57 is basically the same as the configuration of the imaging system 11 illustrated in FIG. 3, but virtual data is supplied from the outside to the subject region processor 44 and the background video processor 45.

The virtual data is video data for displaying a video of a virtual object and a background different from the avatar to be composited with the captured video, that is, superimposed on the composite video.

The subject region processor 44 and the background video processor 45 also use the supplied virtual data to generate subject region process data and background video process data.

### <Description of Composite Video Generation Processing>

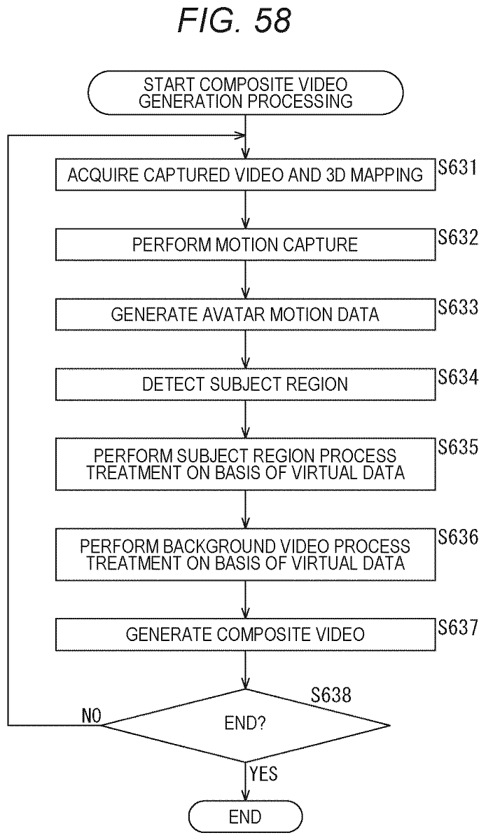

Next, the composite video generation processing performed by the imaging system 11 illustrated in FIG. 57 will be described with reference to a flowchart in FIG. 58.

Note that the processing of step S631 to step S634 is similar to the processing of step S11 to step S14 in FIG. 5, and thus the description thereof will be omitted.

However, in step S634, for example, the subject region extractor 43 also detects the region of the subject at the position where the video based on the virtual data on the captured video is composited, and the detection result and the 3D mapping data are also supplied to the subject region processor 44 and the background video processor 45 as necessary.

In step S635, the subject region processor 44 performs processing of performing a subject region process treatment on the basis of the subject region data supplied from the subject region extractor 43 and the virtual data supplied from the outside, and supplies subject region process data obtained as a result to the picture composite unit 46. At this time, the subject region processor 44 generates the subject region process data by using the detection result of the subject and the 3D mapping data supplied from the subject region extractor 43 as necessary.

Specifically, for example, as illustrated in FIG. 56, in a case where a part of the window OBJ202 as a virtual object is disposed in a part of the region R191 as a subject region, the subject region processor 44 generates a video of a portion included in the region R191 of the window OBJ202 on the basis of virtual data of the window OBJ202. In this case, the region of the window OBJ202 to be replaced with the window OBJ192 is specified from, for example, the detection result and the 3D mapping data supplied from the subject region extractor 43.

Furthermore, for a region in the subject region where the virtual object based on the virtual data and the background are not disposed, the subject region processor 44 generates a video of a portion corresponding to the subject region on the basis of the application data, and the like, to transparentize the target subject similarly to step S165 in FIG. 19, for example.

The subject region processor 44 generates subject region process data by arranging and compositing the videos generated for every region in the subject region in this manner. As a result, it is possible to obtain subject region process data in which a virtual object and a background based on the virtual data, a video based on the application data, and the like are displayed.

Note that, in this embodiment, the target subject in the region where the virtual object and the background are not disposed may be transparentized by any method such as the method described in any embodiment described above, not limited to the example of using the application data.

In step S636, the background video processor 45 performs processing of performing a background video process treatment on the basis of the subject region outside data supplied from the subject region extractor 43 and the virtual data supplied from the outside, and supplies background video process data obtained as a result to the picture composite unit 46. At this time, the background video processor 45 generates the background video process data by using the detection result of the subject and the 3D mapping data supplied from the subject region extractor 43 as necessary.

Specifically, for example, as illustrated in FIG. 56, it is assumed that the desk OBJ191 on the captured video P191 is replaced with the sofa OBJ201 which is a virtual object. In this case, the background video processor 45 generates the background video process data by replacing a region including the desk OBJ191 on the video based on the subject region outside data with the video of the sofa OBJ201 based on the virtual data. At this time, the region of the desk OBJ191 to be replaced with the sofa OBJ201 is specified from, for example, the detection result and the 3D mapping data supplied from the subject region extractor 43.

In this way, it is possible to obtain the background video process data in which the virtual object, the background, and the like based on the virtual data are composited and displayed in addition to the background of the real space.

When the processing of step S636 is performed, thereafter, the processing of steps S637 and S638 is performed and the composite video generation processing ends, but since the processing of these steps is similar to the processing of steps S17 and S18 in FIG. 5, the description thereof will be omitted. As described above, the imaging system 11 generates the subject region process data and the background video process data on the basis of the virtual data, and generates the composite video. In particular, in the imaging system 11, by utilizing the 3D mapping data, it is possible to accurately composite a virtual object and a background and to present a composite video in which the world view of the avatar is expressed. It is therefore possible to provide an experience as if entering the world of the avatar.

In addition, the imaging system 11 can suppress the occurrence of appearance of the target subject more easily and reliably regardless of the imaging place.

### <Configuration Example of Computer>

Note that, the series of processing described above may be executed by hardware or software. In a case where the series of processing is executed by software, a program constituting the software is installed on a computer. Here, examples of the computer include a computer incorporated in dedicated hardware, and for example, a general-purpose personal computer capable of executing various functions by installing various programs or the like.

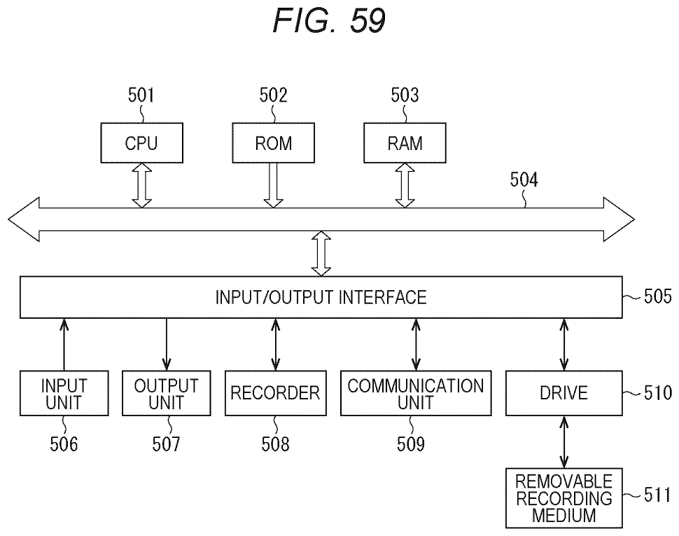

FIG. 59 is a block diagram illustrating a configuration example of the hardware of the computer that executes the above-described series of processes by the program.

In the computer, a central processing unit (CPU) 501, a read only memory (ROM) 502, and a random access memory (RAM) 503 are mutually connected by a bus 504.

Furthermore, an input/output interface 505 is connected to the bus 504. An input unit 506, an output unit 507, a recorder 508, a communication unit 509, and a drive 510 are connected to the input/output interface 505.

The input unit 506 includes a keyboard, a mouse, a microphone, an imaging element, and the like. The output unit 507 includes a head-mounted display, a display, a speaker, and the like. The recorder 508 includes a hard disk, a non-volatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recorder 508 into the RAM 503 via the input/output interface 505 and the bus 504, and executes the program to perform the series of processing described above.

The program executed by the computer (CPU 501) can be provided by being recorded on the removable recording medium 511 as a package medium and the like, for example. Furthermore, the program can be provided via a wired or wireless transmission medium such as a local area network, the Internet, or digital satellite broadcasting.

In the computer, the program can be installed in the recorder 508 via the input/output interface 505 by mounting the removable recording medium 511 on the drive 510. Furthermore, the program can be received by the communication unit 509 via the wired or wireless transmission medium to be installed on the recorder 508. In addition, the program can be installed in the ROM 502 or the recorder 508 in advance.

Note that the program executed by the computer may be a program in which processing is performed in time series in the order described in the present specification or may be a program in which processing is performed in parallel or at necessary timing such as when a call is made.

Furthermore, the embodiments of the present technology are not limited to the above-described embodiments, and various modifications are possible without departing from the scope of the present technology.

For example, the present technology may be embodied in cloud computing in which a function is shared and executed by a plurality of devices via a network.

In addition, each step described in the flowchart described above can be performed by one device or can be shared and performed by a plurality of devices.

Furthermore, in a case where a plurality of pieces of processing is included in one step, the plurality of pieces of processing included in the one step can be executed by one device or executed by a plurality of devices in a shared manner.

Furthermore, the present technology may also have following configurations.

(1)

An imaging system including
a subject motion detector that performs motion capture of a subject predetermined on the basis of a captured video including the subject and distance information, and
a data control unit that performs transparency processing of making the subject on the captured video invisible, and generates a composite video by compositing an avatar corresponding to the subject that performs a movement detected by the motion capture on the video obtained by the transparency processing on the captured video or compositing the avatar obtained by the transparency processing on the captured video.
   (2)

The imaging system according to (1), in which
the data control unit extracts a subject region that is a region of the subject on the captured video on the basis of at least one of the captured video or the distance information, and composites a background video with the subject region extracted to make the subject invisible.
   (3)

The imaging system according to (2), in which
the data control unit generates the background video on the basis of the captured video imaged in advance, another captured video imaged by another imaging unit different from the imaging unit that images the captured video, a past frame of the captured video, or estimation processing based on the captured video.
   (4)

The imaging system according to (3), in which
the data control unit generates a video of a region corresponding to a predetermined region in the background video on the basis of the past frame in a case where the past frame includes a video of a background corresponding to the predetermined region in the subject region, and
the data control unit sets a predetermined separate video as a video of a region corresponding to the predetermined region in the background video in a case where the past frame does not include a video of a background corresponding to the predetermined region in the subject region.
   (5)

The imaging system according to (1), in which
the data control unit extracts a subject region that is a region of the subject on the captured video on the basis of at least one of the captured video or the distance information, and composites an arbitrary separate video with the subject region extracted to make the subject invisible.
   (6)

The imaging system according to (5), in which
the separate video includes a graphic video or an effect video.
   (7)

The imaging system according to (1), in which
the data control unit extracts a subject region that is a region of the subject on the captured video on the basis of at least one of the captured video or the distance information, and adjusts a size of the avatar to be composited with the subject region extracted or generates a video of the avatar with a background to be composited with the subject region extracted to make the subject invisible.
   (8)

The imaging system according to (1), in which
in a case where a region of the subject is not detected from the captured video and a region of the subject is detected from the distance information, the data control unit extracts a subject region that is a region of the subject on the captured video on the basis of only the distance information and performs the transparency processing.
   (9)

The imaging system according to any one of (1) to (8), in which
the data control unit performs different types of the transparency processing in accordance with a distance from an imaging position of the captured video to the subject.
   (10)

The imaging system according to any one of (1) to (9), in which
the data control unit temporarily stops recording or transmitting the composite video in a case where the motion capture or the transparency processing fails.
   (11)

The imaging system according to any one of (1) to (10), in which
a range of an imaging visual field of the distance information is wider than a range of an imaging visual field of the captured video.
   (12)

The imaging system according to any one of (1) to (11), in which
the data control unit specifies a front-back positional relationship between the subject and another subject in a portion where the subject and the another subject on the captured video overlap each other on the basis of the distance information, and performs the transparency processing on the basis of a specification result of the front-back positional relationship.
   (13)

The imaging system according to any one of (1) to (6), in which
the data control unit adjusts a display size of the avatar on the composite video to an arbitrary size.
   (14)

The imaging system according to any one of (1) to (6), in which
the data control unit adjusts a display size of the avatar on the composite video to a size according to the distance from the imaging position of the captured video to the subject.
   (15)

The imaging system according to any one of (1) to (14), in which
the data control unit specifies a position of a grounding point of the subject on the captured video on the basis of the distance information, and composites the avatar with the grounding point as a starting point.
   (16)

The imaging system according to any one of (1) to (15), in which
the data control unit generates the composite video in which an arbitrary separate video is composited at a position of another subject different from the subject on the captured video.
   (17)

A video processing method performed by an imaging system, the video processing method including
performing motion capture of a subject predetermined on the basis of a captured video including the subject and distance information, and
performing transparency processing of making the subject on the captured video invisible, and generating a composite video by compositing an avatar corresponding to the subject that performs a movement detected by the motion capture on the video obtained by the transparency processing on the captured video or compositing the avatar obtained by the transparency processing on the captured video.
   (18)

A program that causes a computer to execute processing including steps of
performing motion capture of a subject predetermined on the basis of a captured video including the subject and distance information, and
performing transparency processing of making the subject on the captured video invisible, and generating a composite video by compositing an avatar corresponding to the subject that performs a movement detected by the motion capture on the video obtained by the transparency processing on the captured video or compositing the avatar obtained by the transparency processing on the captured video.

### REFERENCE SIGNS LIST

11 Imaging system
21 Imaging unit
22 Data control unit
31 3D mapping imaging unit
32 Picture imaging unit
41 Subject motion detector
42 Avatar motion constructor
43 Subject region extractor
44 Subject region processor
45 Background video processor
46 Picture composite unit

1. An imaging system comprising:
a subject motion detector that performs motion capture of a subject predetermined on a basis of a captured video including the subject and distance information; and
a data control unit that performs transparency processing of making the subject on the captured video invisible, and generates a composite video by compositing an avatar corresponding to the subject that performs a movement detected by the motion capture on the video obtained by the transparency processing on the captured video or compositing the avatar obtained by the transparency processing on the captured video.

2. The imaging system according to claim 1, wherein
the data control unit extracts a subject region that is a region of the subject on the captured video on a basis of at least one of the captured video or the distance information, and composites a background video with the subject region extracted to make the subject invisible.

3. The imaging system according to claim 2, wherein
the data control unit generates the background video on a basis of the captured video imaged in advance, another captured video imaged by another imaging unit different from the imaging unit that images the captured video, a past frame of the captured video, or estimation processing based on the captured video.

4. The imaging system according to claim 3, wherein
the data control unit generates a video of a region corresponding to a predetermined region in the background video on a basis of the past frame in a case where the past frame includes a video of a background corresponding to the predetermined region in the subject region, and
the data control unit sets a predetermined separate video as a video of a region corresponding to the predetermined region in the background video in a case where the past frame does not include a video of a background corresponding to the predetermined region in the subject region.

5. The imaging system according to claim 1, wherein
the data control unit extracts a subject region that is a region of the subject on the captured video on a basis of at least one of the captured video or the distance information, and composites an arbitrary separate video with the subject region extracted to make the subject invisible.

6. The imaging system according to claim 5, wherein
the separate video includes a graphic video or an effect video.

7. The imaging system according to claim 1, wherein
the data control unit extracts a subject region that is a region of the subject on the captured video on a basis of at least one of the captured video or the distance information, and adjusts a size of the avatar to be composited with the subject region extracted or generates a video of the avatar with a background to be composited with the subject region extracted to make the subject invisible.

8. The imaging system according to claim 1, wherein
in a case where a region of the subject is not detected from the captured video and a region of the subject is detected from the distance information, the data control unit extracts a subject region that is a region of the subject on the captured video on a basis of only the distance information and performs the transparency processing.

9. The imaging system according to claim 1, wherein
the data control unit performs different types of the transparency processing in accordance with a distance from an imaging position of the captured video to the subject.

10. The imaging system according to claim 1, wherein
the data control unit temporarily stops recording or transmitting the composite video in a case where the motion capture or the transparency processing fails.

11. The imaging system according to claim 1, wherein
a range of an imaging visual field of the distance information is wider than a range of an imaging visual field of the captured video.

12. The imaging system according to claim 1, wherein
the data control unit specifies a front-back positional relationship between the subject and another subject in a portion where the subject and the another subject on the captured video overlap each other on a basis of the distance information, and performs the transparency processing on a basis of a specification result of the front-back positional relationship.

13. The imaging system according to claim 1, wherein
the data control unit adjusts a display size of the avatar on the composite video to an arbitrary size.

14. The imaging system according to claim 1, wherein
the data control unit adjusts a display size of the avatar on the composite video to a size according to the distance from the imaging position of the captured video to the subject.

15. The imaging system according to claim 1, wherein
the data control unit specifies a position of a grounding point of the subject on the captured video on a basis of the distance information, and composites the avatar with the grounding point as a starting point.

16. The imaging system according to claim 1, wherein
the data control unit generates the composite video in which an arbitrary separate video is composited at a position of another subject different from the subject on the captured video.

17. A video processing method performed by an imaging system, the video processing method comprising:
performing motion capture of a subject predetermined on a basis of a captured video including the subject and distance information; and
performing transparency processing of making the subject on the captured video invisible, and generating a composite video by compositing an avatar corresponding to the subject that performs a movement detected by the motion capture on the video obtained by the transparency processing on the captured video or compositing the avatar obtained by the transparency processing on the captured video.

18. A program that causes a computer to execute processing including steps of
performing motion capture of a subject predetermined on a basis of a captured video including the subject and distance information, and
performing transparency processing of making the subject on the captured video invisible, and generating a composite video by compositing an avatar corresponding to the subject that performs a movement detected by the motion capture on the video obtained by the transparency processing on the captured video or compositing the avatar obtained by the transparency processing on the captured video.
